(19) United States
(12) Patent Application Publication
(10) Pub. No.: US 2018/0290384 A1
(43) Pub. Date: Oct. 11, 2018

(54) PRINTING SYSTEMS AND RELATED METHODS

(71) Applicant: ELWHA LLC, BELLEVUE, WA (US)

(72) Inventors: Roderick A. Hyde, Redmond, WA (US); Jordin T. Kare, San Jose, CA (US); Elizabeth A. Sweeney, Seattle, WA (US)

(21) Appl. No.: 16/003,464

(22) Filed: Jun. 8, 2018

Related U.S. Application Data
(63) Continuation-in-part of application No. 14/664,405, filed on Mar. 20, 2015, now Pat. No. 10,046,091.
Application No. 14/664,405 is a continuation-in-part of application No. 14/700,743, filed on Apr. 30, 2015.
Application No. 14/700,743 is a continuation-in-part of application No. 14/744,825, filed on Jun. 19, 2015, now abandoned.

(51) Int. Cl. B29C 64/25; B29C 64/209; B29C 64/165; B29C 64/112; B29C 64/295

(52) U.S. Cl. CPC B29C 64/25; B29C 64/209; B29C 2947/92209; B29C 64/112; B29C 64/295; B29C 64/165

(57) ABSTRACT

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

For purposes of the USPTO extra-statutory requirements, the present application constitutes a continuation-in-part of:

U.S. patent application Ser. No. 14/664,405 filed on Mar. 20, 2015, which is currently co-pending or is an application of which a currently co-pending application is entitled to the benefit of the filing date;

U.S. patent application Ser. No. 14/700,743 filed on Apr. 30, 2015, which is currently co-pending or is an application of which a currently co-pending application is entitled to the benefit of the filing date; and

U.S. patent application Ser. No. 14/744,825 filed on Jun. 19, 2015, which is currently co-pending or is an application of which a currently co-pending application is entitled to the benefit of the filing date.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

In an embodiment, a printing system is disclosed. The printing system includes one or more dispense elements each of which can include at least one dispense aperture. The one or more dispense elements are configured to controllably dispense one or more materials through the at least one dispense aperture. The printing system further includes a barrier including an inner wall at least partially defining an internal region, an outer wall at least partially defining an external region, and a base contact surface extending between the inner wall and the outer wall. The barrier is positioned or positionable so that the one or more dispense elements are positioned in or adjacent to the internal region of the barrier. The printing system also includes a controller including control electrical circuitry that is operably coupled to the one or more dispense elements. The control electrical circuitry is configured to direct dispensing of the one or more materials from the one or more dispense elements.

In an embodiment, a method of three-dimensional printing is disclosed. The method includes positioning one or more dispense elements at least proximate to a region of interest. The method includes at least partially laterally surrounding an internal region with a barrier. The internal region includes at least a portion of the region of interest therein. With the barrier positioned to at least partially laterally surrounding the internal region, responsive to direction from control electrical circuitry, the method further includes controllably dispensing one or more materials from the one or more dispense elements onto the region of interest.

Embodiments disclosed herein are directed to printing systems configured to print a three-dimensional object on a region of interest using one or more elongated members that steer one or more dispense elements from which one or more materials are dispensed, and methods of using such printing systems. In an embodiment, a printing system is disclosed. The printing system includes a printing head. The printing system further includes one or more elongated members operably coupled to and extending from the printing head. The printing system further includes one or more dispense elements, each of which includes at least one aperture. The one or more dispense elements are operably coupled to the one or more elongated members. The one or more elongated members are configured to controllably steer the one or more dispense elements. Additionally, the one or more dispense elements are configured to controllably dispense one or more materials through the at least one aperture onto a region of interest. The printing system further includes a controller. The controller includes control electrical circuitry that is operably coupled to at least one of the printing head, the one or more dispense elements, or the one or more elongated members. The control electrical circuitry is configured to direct actuation of the one or more elongated members and dispensing of the one or more materials from the one or more dispense elements.

In an embodiment, a printing system is disclosed. The printing system includes a body-insertable device configured to be inserted into a subject to access an internal region of interest therein. The printing system further includes one or more dispense elements, each of which includes at least one aperture. The one or more dispense elements are configured to controllably dispense one or more materials through the at least one aperture onto the internal region of interest. The one or more dispense elements are at least partially positioned within the body-insertable device. The printing system further includes one or more elongated members operably coupled to the one or more dispense elements. The one or more elongated members are configured to controllably steer the one or more dispensing elements. Additionally, the printing system includes a controller. The controller includes control electrical circuitry that is operably coupled to the one or more dispense elements and the one or more elongated members. The control electrical circuitry is configured to direct actuation of the one or more elongated members and dispensing of the one or more materials from the one or more dispense elements.

In an embodiment, a method of three-dimensional printing is disclosed. The method includes, responsive to direction from control electrical circuitry, actuating one or more elongated members to controllably steer one or more dispense elements. The method further includes, responsive to the one or more elongated members controllably steering the one or more dispense elements and the direction from the control electrical circuitry, controllably dispensing one or more materials from the one or more dispense elements onto a region of interest.

Embodiments disclosed therein are directed to printing systems configured to print a three-dimensional object on a region of interest. In an embodiment, the printing systems include one or more flushing elements that dispense one or more flushing agents towards the region of interest to prepare the region of interest to have the three-dimensional object printed thereon.

In an embodiment, a printing system is disclosed. In an embodiment, the printing system includes at least one material reservoir configured to store one or more materials. The printing system further optionally includes one or more dispense elements coupled to the at least one material reservoir. The one or more dispense elements can include at least one dispense aperture. In an embodiment, the one or more dispense elements are configured to controllably dispense the one or more materials onto a region of interest. In an embodiment, the printing system also includes at least one flushing agent reservoir configured to store one or more flushing agents. In an embodiment, the one or more flushing agents are configured to prepare the region of interest to have the one or more materials dispensed thereon. Additionally, the printing system optionally includes one or more flushing elements coupled to the at least one flushing agent reservoir. In an embodiment, the one or more flushing elements include at least one flushing aperture. In an embodiment, the one more flushing elements are also configured to dispense one or more flushing agents through the at least one flushing aperture towards the region of interest. The printing system further optionally includes a controller that is operably coupled to at least the one or more dispense elements. In an embodiment, the controller includes control electrical circuitry that is configured to at least direct dispensing of the one or more materials from the one or more dispense elements.

In an embodiment, a method of using a printing system is disclosed. The method optionally includes positioning one or more flushing elements adjacent to or proximate to a region of interest. The one or more flushing elements optionally include at least one flushing aperture. The method also optionally includes dispensing one or more flushing agents through the at least one flushing aperture to prepare the region of interest to have one or more materials printed thereon. The method further optionally includes positioning one or more dispense elements adjacent to or proximate to the region of interest. In an embodiment, the one or more dispense elements includes at least one dispense aperture. Finally, the method optionally includes, responsive to direction from the control electrical circuitry, controllably dispensing the one or more materials from the one or more dispense elements onto the region of interest.

In an embodiment, a printing system is disclosed. In an embodiment, the printing system includes a body-insertable device configured to be inserted into a subject to access an internal region of interest therein. The printing system also optionally includes at least one material reservoir configured to store one or more materials. The printing system further optionally includes one or more dispense elements coupled to the at least one material reservoir. The one or more dispense elements optionally includes at least one dispense aperture. In an embodiment, the one or more dispense elements are configured to controllably dispense the one or more materials onto a region of interest. Additionally, the one or more dispense elements are at least partially positioned within the body-insertable device. In an embodiment, the printing system also includes at least one flushing agent reservoir configured to store one or more flushing agents. In an embodiment, the one or more flushing agents are configured to prepare the region of interest to have the one or more materials dispensed thereon. Additionally, the printing system optionally includes one or more flushing elements coupled to the at least one flushing agent reservoir. In an embodiment, the one or more flushing elements include at least one flushing aperture. In an embodiment, the one more flushing elements are configured to dispense one or more flushing agents through the at least one flushing aperture toward the region of interest. In an embodiment, the one or more flushing elements are at least partially positioned within the body-insertable device. In an embodiment, the printing system further includes a controller that is operably coupled to at least the one or more dispense elements. In an embodiment, the controller includes control electrical circuitry that is configured to at least direct dispensing of the one or more materials from the one or more dispense elements.

In an embodiment, a reversibly attachable cartridge for a printing system is disclosed. The reversibly attachable cartridge optionally includes at least one flushing agent reservoir that is configured to store one or more flushing agents. In an embodiment, the one or more flushing agents are configured to prepare the region of interest to have the one or more materials dispensed thereon. In an embodiment, the reversibly attachable cartridge also includes one or more flushing elements that are coupled to the at least one flushing agent reservoir. In an embodiment, the one or more flushing elements include at least one flushing aperture. In an embodiment, the one or more flushing elements are configured to dispense one or more flushing agents through the at least one flushing aperture to prepare the region of interest to receive one or more materials dispensed from one or more dispense elements. Additionally, the reversibly attachable cartridge optionally includes one or more conduits fluidly coupling the at least one flushing agent reservoir with the one or more flushing elements. In an embodiment, the reversibly attachable cartridge further includes a housing that at least partially encloses the at least one flushing agent reservoir, the one or more flushing elements, and the one or more conduits. In an embodiment, the housing is further configured be communicably coupled to and reversibly attached to the printing system.

Features from any of the disclosed embodiments can be used in combination with one another, without limitation. In addition, other features and advantages of the present disclosure will become apparent to those of ordinary skill in the art through consideration of the following detailed description and the accompanying drawings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A and 1B are a schematic cross-sectional view and an isometric cutaway view, respectively, of a printing system, according to an embodiment.

FIG. 2 is a flow diagram of a method of using the printing system shown in FIGS. 1A and 1B, according to an embodiment.

FIG. 3 is a schematic cross-sectional view of a printing system, according to an embodiment.

FIG. 4 is a schematic cross-sectional view of a printing system, according to an embodiment.

FIG. 5 is a schematic cross-sectional view of a printing system, according to an embodiment.

FIGS. 6A and 6B are a schematic cross-sectional view and top view of a printing system, respectively, according to an embodiment.

FIG. 7 is a schematic cross-sectional view of a printing system configured to be inserted into an internal region of a body of a subject, according to an embodiment.

FIG. 8 is a schematic cross-sectional view of a printing system according to an embodiment.

FIG. 9 is a schematic cross-sectional view of a printing system including one or more sensors according to an embodiment.

FIG. 10A is a schematic cross-sectional view of a printing system including an elongated member having a hydraulic or pneumatic cylinder actuator according to an embodiment.

FIG. 10B is a schematic cross-sectional view of a printing system including an elongated member having an inflatable bubble according to an embodiment.

FIG. 10C is a schematic cross-sectional view of a printing system including an elongated member according to an embodiment.

FIG. 10D is a schematic cross-sectional view of a printing system including an elongated member having two actuators according to an embodiment.

FIG. 11A is a schematic cross-sectional view of a printing system that is configured to be partially inserted into an internal region of interest of a subject according to an embodiment.

FIG. 11B is a schematic cross-sectional view of a printing system that is configured to be substantially inserted into an internal region of interest of a subject according to an embodiment.

FIG. 12 is a schematic cross-sectional view of a printing system according to an embodiment.

FIG. 13 is a flow diagram of a method of using the printing system illustrated in FIG. 1 according to an embodiment.

FIG. 14 is a schematic cross-sectional view of a printing system according to an embodiment.

FIG. 15 is a flow diagram of a method of using the printing system illustrated in FIG. 1 according to an embodiment.

FIG. 16 is a schematic cross-sectional view of a printing system according to an embodiment.

FIG. 17 is a schematic cross-sectional view of a printing system configured to be inserted into an internal region of a body of a subject according to an embodiment.

FIG. 18 is schematic cross-sectional view of a printing system that includes at least one reversibly attachable cartridge according to an embodiment.

### DETAILED DESCRIPTION

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

Embodiments disclosed herein are directed to printing systems configured to print a three-dimensional object on a region of interest using one or more elongated members that steer one or more dispense elements from which one or more materials are dispensed, and methods of using such printing systems. The printing system can include one or more elongated members coupled to one or more dispense elements. The one or more elongated members can be configured to be controllably actuated to steer the one or more dispense elements so that the one or more dispense elements are selectively positioned adjacent to or proximate to a specific segment of a region of interest. The one or more dispense elements can controllably dispense one or more materials onto the region of interest, thereby at least partially forming the three-dimensional object. The one or more materials can include a biological material or a non-biological material. The one or more elongated members can be controllably steered and the one or more dispense elements can controllably dispense the one or more materials responsive to direction from control electrical circuitry of a controller. The printing system can further include a printing head configured to support at least the one or more elongated members.

Embodiments disclosed therein are directed to printing systems configured to print a three-dimensional object on a region of interest using one or more flushing elements dispense one or more flushing agents towards the region of interest. The one or more flushing agents prepare the region of interest to have the three-dimensional object printed thereon. The one or more flushing elements can be coupled to at least one flushing agent reservoir configured to store the one or more flushing agents. The one or more flushing agents can include one or more cleaning agents, one or more antimicrobial agents, one or more sterilizing agents, or one or more corrosive agents, etc. In some embodiments, the one or more flushing elements can be coupled to one or more elongated members, coupled to a printing head, partially enclosed by the printing head, or incorporated into the printing head. The printing system can also include one or more dispense elements configured to controllably dispense one or more materials onto the region of interest.

The region of interest can include a wound (e.g., a dermal wound or internal wound), and the printing system can in situ print a scaffold and a bioink, including cells and extracellular components, to form a tissue graft. For example, in an orthopedic surgical intervention, the printing system can print a polymer scaffold and a bioink including osteocytes to provide a bone graft. For example, when the region of interest is an internal anatomical site, the printing system can print a scaffold suitable for colonization of endogenous cells or tissues. For example, when the region of interest includes an intraabdominal site, the printing system can print all or part of an organ, (e.g., a liver), which can include vascular or microvascular structures. For example, when the internal site includes a solid tumor, the printing system can print a covering of a bioink including a hydrogel and a compound mixture including chemotherapeutics and vascular inhibitors. For example, in an intravascular procedure, the printing system can print a filler for an aneurysm. In an embodiment, the printing system is well suited for printing complex patterns. For example, in a cardiovascular procedure, the printing system can print a patterned cardiac patch directly onto heart tissue (e.g., to support or repair a damaged heart), with the patch including a material having a bioink of elastic hydrogel and a second bioink including cardiomyocytes. For example, the printing system can print onto a region of interest that includes a substrate, biocompatible structures having complex patterns from bioinks including one or multiple structural compounds forming a scaffold and additional bioinks having cells of interest with supportive compounds. These biocompatible structures can be incubated ex vivo, e.g., for cell growth, for use in in vivo procedures. For example, the printing system can print on a region of interest that is an external surface of a body of a living subject, such as the skin, an eye, or an open wound. For example, in a region of interest including a weakened site on a nonorganic surface, such as a joint in a plumbing line, the printing system can print a supportive patch including an adhesive. For example, in a region of interest including a plant tissue having an abrasion, a printing surface can print a plant graft to aid in healing or to introduce a heterogeneous plant to form a hybrid.

In an embodiment, the region of interest 102 can include a substrate, a subject, an anatomical site of a subject, a plant, a test tube, a flask, a petri dish, a tissue culture dish, a portion of a partially printed object, or any workspace that the object can be printed on. For example, a substrate can be a biocompatible substrate, e.g., a substrate on which a tissue is printed ex vivo for use in an in vivo environment (e.g., an organ including a vascularized organ, a tissue, a tissue graft, a delivery depot). Such substrates can include, but are not limited to, a rigid surface, a charged surface, an inorganic surface, an organic surface, a gel surface, a polymer surface, a plastic surface, a glass surface, a printed surface, and the like. For example, the region of interest 102 can include an anatomical site in or on a subject (e.g., a mammalian subject). A site on a subject can include, for example but without limitation, a dermal site, mucosal site, or an ocular site. For example, an anatomical site of a subject can include a wound such as an abrasion, laceration, or burn, e.g., one requiring a printed treatment. For example, an anatomical site of a subject can include, but is not limited to, a tissue site (e.g., a site in need of support, repair, addition, or replacement), a surgical site, a subcutaneous site, an endodermal site, an intraperitoneal site, an intra-abdominal site, an intra-organ site, an intracranial site, a skeletal site, a muscular site, a nervous site, a cardiac site, a visceral site, a parietal site, a lumenal site, an endolumenal site. Nonlimiting examples of tissues include bone tissue, muscle tissue, visceral tissue, parietal tissue, cardiac tissue, nerve tissue, vascular tissue, dermal tissue, ocular tissue, endogenous tissue and exogenously added tissue.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here.

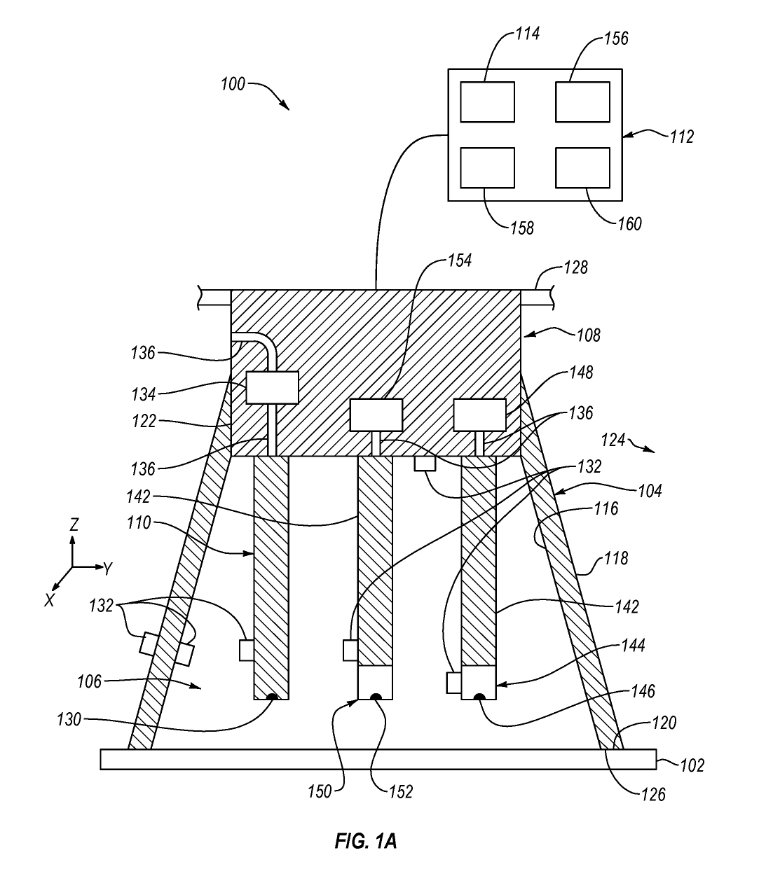

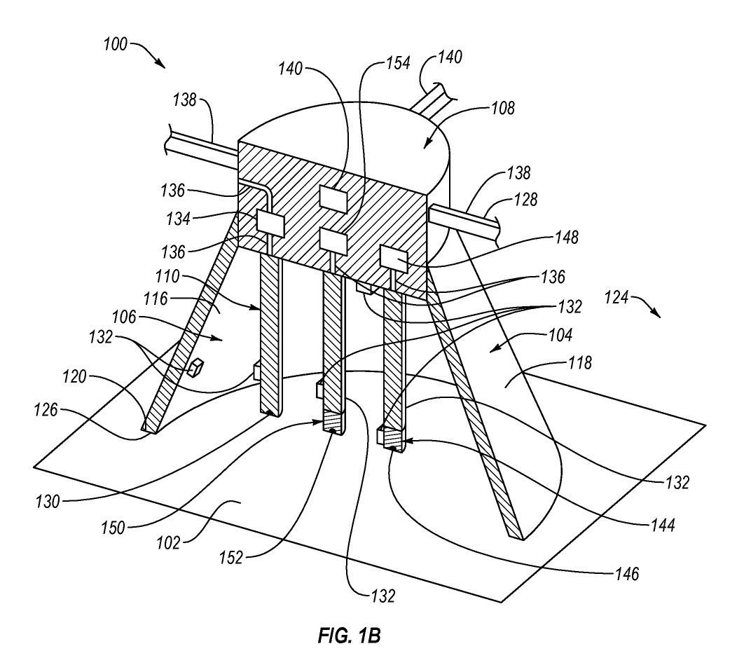

FIGS. 1A and 1B are a schematic cross-sectional view and an isometric cutaway view, respectively, of a printing system 100, according to an embodiment. The printing system 100 can be configured to print an object on a region of interest 102. To accomplish this, the printing system includes a barrier 104 configured to at least partially define an internal region 106. The printing system 100 can further include a printing head 108 configured to support one or more components of the printing system 100. The barrier 104 can be coupled to and extend from the printing head 108. As such, the printing system 100 further includes a printing device, which will be discussed in more detail hereinbelow, configured to dispense one or more materials onto the region of interest 102.

The printing system 100 can further include one or more removal devices 110 configured to remove at least one contaminant or substance from the internal region 106. The printing system 100 can further include a flushing device, which will be discussed in more detail hereinbelow, configured to prepare the region of interest 102 to have the one or more materials dispensed thereon. The at least one removal device 110, at least one component of the printing device, or at least one component of the flushing device can be at least partially positioned in or near the internal region 106. Additionally, the printing system 100 can include a controller 112 including control electrical circuitry 114 configured to control one or more components of the printing system 100.

The barrier 104 can include at least an inner wall 116, a generally opposing outer wall 118, and a base contact surface 120 extending between the inner wall 116 and the outer wall 118. The base contact surface 120 can be distinct or indistinct from the inner wall 116 and the outer wall 118. In an embodiment, the inner wall 116 and the outer wall 118 are merely surfaces of the barrier 104. For example, a portion of the barrier 104 can include a single piece that includes both the inner wall 116 as one surface and the outer wall 118 as an opposing surface. In an embodiment, the inner wall 116 and the outer wall 118 can form distinct pieces of the barrier 104. For example, the inner wall 116 can form a first piece and the outer wall 118 can form a second piece. In such an example, a space can exist between the inner wall 116 and the outer wall 118, the inner wall 116 can at least partially contact the outer wall 118, or a third piece can at least partially occupy the space between the inner wall 116 and the outer wall 118. Similarly, the base contact surface 120 can be a surface of the barrier 104 (e.g., a portion of the barrier 104 can be a single piece including the base contact surface 120, the inner wall 116, and the outer wall 118) or a distinct piece of the barrier 104. The barrier 104 can include additionally surfaces or components. For example, the barrier 104 can include an interfacial surface 122 configured to couple the barrier 104 to the printing head 108.

The barrier 104 can be formed from a single piece or from a plurality of pieces. In an embodiment, the barrier 104 can be formed from a single piece that includes the inner wall 116, the outer wall 118, and the base contact surface 120. In an embodiment, the barrier 104 can be formed from a plurality of interconnected pieces. For example, the barrier 104 can include seams (not shown) between each of the plurality of pieces. For example, the barrier 104 can be formed from a plurality of pieces in which each of the plurality of pieces extends between the inner wall 116, the outer wall 118, the base contact surface 120, and the interfacial surface 122. As such, the seams between the plurality of pieces extend vertically between the interfacial surface 122 and the base contact surface 120. In another example, each of the seams between the plurality of pieces can extend horizontally, (e.g., a first piece extends between the inner wall 116, the outer wall 118, the base contact and the seam while a second piece extends between the inner wall 116, the outer wall 118, the interfacial surface 122 and the seam). In another example, the seams between the plurality of pieces can extend horizontally and vertically, or in any suitable manner. In an embodiment, the seams between the plurality of pieces can be configured to prevent or limit the ability of at least one contaminant from moving through the seams. For example, each seam can include a sealant therein, define a relatively narrow gap, or form a path that is longer than the thickness between the inner wall 116 and the outer wall 118 (e.g., a zigzag path, a curved path, a stepped path, etc.).

The inner wall 116 can at least partially define the internal region 106. In an embodiment, the inner wall 116 can at least partially laterally enclose (e.g., completely enclose) the internal region 106. For example, the inner wall 116 can laterally surround a three-dimensional object, such as the curve of a leg, torso, breast, or blood vessel of a subject. In particular, the inner wall 116 can at least partially enclose a lateral periphery of the internal region 106. For example, the cross-sectional shape of the barrier 104 at the base contact surface 120 can exhibit a generally straight line cross-sectional geometry, a general V-shape cross-sectional geometry, and generally U-shape cross-sectional geometry, a generally semi-circular cross-sectional geometry, a general hollow circular cross-sectional geometry, a generally hollow rectangular cross-sectional geometry, etc. In an embodiment, the internal region 106 can also be partially defined by other structures. For example, the illustrated internal region 106 is defined by the barrier 104, a portion of the printing head 108, and a portion of the region of interest 102.

The outer wall 118 can at least partially define the external region 124. The external region 124 can be any region that is not included in the internal region 106 or occupied by another component of the printing system 100. For example, the external region 124 can at least partially extend from the outer wall 118 away from the internal region 106.

In an embodiment, the external region 124 can include at least one contaminant. The at least one contaminant can include any material, substance, chemical, or physical phenomenon that can decrease the printing system's 100 ability to print an object on the region of interest 102. In an embodiment, the at least one contaminant can include a contaminant that adversely affects the printing quality (e.g., precision) of the printing system 100. In an embodiment, the at least one contaminant can include a contaminant that adversely affects the integrity of the surface of the region of interest 102 For example, the at least one contaminant can be one or more dust mites when printing an integrated circuit. In another example, the at least one contaminant can be a liquid (e.g., water, a bodily fluid, etc.). In such an example, the barrier 104 can be configured to keep the surface of the region of interest 102 dry. In an embodiment, the at least one contaminant can include a contaminant that reacts with or damages the printed object or a component of the printing system 100. For example, the at least one contaminant can include an oxidizing agent, a reducing agent, or a corrosive agent. In an embodiment, the at least one contaminant can include a contaminant that can damage the region of interest 102. For example, the at least one contaminant can include bacteria, fungi, viruses, etc., e.g., if the region of interest 102 includes a biological region of interest or includes a nonorganic region of interest requiring a clean field.

The printing system 100 can be positioned such that the base contact surface 120 is positioned at least proximate to a surface 126. The surface 126 can be any surface to which the base contact surface 120 is positioned at least proximate. For example, the surface 126 can include at least a portion of the region of interest 102, a region proximate to the region of interest 102, or a region that at least partially encloses the region of interest 102. In an embodiment, the base contact surface 120 at least partially contacts the surface 126 (e.g., completely contacts the surface 126) when the base contact surface 120 is positioned at least proximate to the surface 126. In an embodiment, gaps or paths can exist between the base contact surface 120 and the surface 126 when the base contact surface 120 at least partially contacts the surface 126.

The printing system 100 can at least partially isolate the internal region 106 from the external region 124 when the base contact surface 120 is positioned at least proximate to the surface 126. At least partially isolating the internal region 106 from the external region 124 also isolates the portions of the region of interest 102 (e.g., entire region of interest 102) from the external region 124. The internal region 106 can be at least partially isolated from the external region 124 when the barrier 104 at least partially prevents the at least one contaminant from entering the internal region 106. For example, the barrier 104 can at least partially isolate the internal region 106 from the external region 124 with regards to only a single selected contaminant, a plurality of selected contaminants, or substantially all contaminants. The internal region 106 can be at least partially isolated from the external region 124 when the barrier 104 at least partially prevents one or more substances (e.g., one or more flushing agents, one or more materials) from leaving or entering the internal region 106. For example, the barrier 104 can at least partially isolate the internal region 106 from the external region 124 with regards to a single selected substance, a plurality of selected substances, or substantially all substances.

In an embodiment, the barrier 104 at least partially prevents at least one material (e.g., the at least one contaminant or the one or more substances) from entering or leaving the internal region 106 when the barrier 104 prevents at least about 50% of at least one material from entering or leaving the internal region 106 than if the barrier 104 was not present, given the same conditions (e.g., pressure or concentration gradient between the internal region 106 and the external region 124). For example, the barrier 104 can be configured to prevent at least about 75%, at least about 90%, at least about 95%, at least about 99%, or at least about 99.9% of the at least one material from entering or leaving the internal region 106 than if the barrier 104 was not there, given the same conditions. The amount of the at least one material that the barrier 104 prevents from entering or leaving the internal region 106 can be selected based on precision of the printing system 100, the size of the printed object, the effect the at least one material has on the printed object, etc. For example, if the printing system 100 is configured to print an integrated circuit, the barrier can prevent at least about 99% of the at least one material (e.g., dust) from entering the internal region 106. In another example, if the printing system 100 is configured to print a simple mechanical device, the barrier 104 may only need to prevent 50% or less of the at least one material from entering the internal region 106.

In an embodiment, the barrier 104 at least partially prevents the at least one contaminant from entering the internal region 106 when the rate at which the at least one contaminant enters the internal region 106 is equal to or less than the rate at which the printing system 100 can remove the at least one contaminant from the internal region 106. For example, the printing system 100 can include one or more removal devices 110. The barrier 104 at least partially prevents at least one contaminant from entering the internal region 106 when a rate at which the at least one contaminant enters the internal region 106 is equal to or less than the rate at which the one or more removal devices 110 removes the at least one contaminant.

In an embodiment, the barrier 104 can be configured to substantially prevent the at least one contaminant entering the internal region 106 from the external region 124. As such, the barrier 104 can be at least semi-impermeable (e.g., substantially impermeable or impermeable) to the at least one contaminant. In an embodiment, the at least one contaminant can include a gas. For example, the at least one contaminant can include oxygen or another oxidizing gas. As such, the barrier 104 can at least partially include or be formed from a material that is at least semi-impermeable to a gas. Materials that are at least semi-impermeable to gases include steel, titanium, rubber, a polymer membrane, or any suitable material. In an embodiment, the at least one contaminant can include a liquid. For example, the at least one contaminant can be a blood or interstitial fluids in an organic environment. As such, the barrier 104 can at least partially include or be formed from a material that is at least semi-impermeable to a liquid. Materials that are at least semi-impermeable to a liquid include a polyaminde, a thin film composite membrane, gore-tex, a polymer membrane, steel, titanium, a silanized aluminum membrane, a ceramic, or any other suitable material. In an embodiment, the at least one contaminant can include a solid, such as dust or organic tissue. As such, the barrier 104 can be formed of a material that is at least semi-impermeable to a solid. For example, the barrier 104 can at least partially include a porous ceramic, a filter, or any other suitable material. In an embodiment, the at least one contaminant can include energy (e.g., heat), electric fields, magnetic fields, electromagnetic radiation (e.g., visible light), or other physical phenomena. As such, the barrier 104 can include a thermally insulating material, an electrically insulating material, a faraday cage, or a material that is at least partially opaque to a certain wavelength, or other suitable materials.

In operation, the barrier 104 can be positioned such that the base contact surface 120 is positioned at least proximate to the surface 126 using various methods. In an embodiment, the barrier 104 can be attached to the printing head 108 and the printing head 108 can be moved to position the base contact surface 120 at least proximate to the surface 126. For example, after the printing head 108 is positioned above the region of interest 102, the printing head 108 can move in the z-direction to position the base contact surface 120 at least proximate to the surface 126. In an embodiment, the barrier 104 can include one or more actuators configured to extend portions of the barrier 104 such that the base contact surface 120 is positioned at least proximate to the surface 126. For example, the barrier 104 can include a hydraulic actuator, a pneumatic actuator, an electroactive actuator, a shape memory actuator, or any suitable actuator. For example, when the printing head 108 is positioned, the one or more actuators of the barrier 104 actuate (e.g., controllably actuate responsive to direction from control electrical circuitry 114) such that the base contact surface 120 is positioned at least proximate to the surface 126. In an embodiment, the printing head 108 can include one or more actuators configured to extend portions of the barrier 104 such that the base contact surface 120 is portioned at least proximate to the surface 126. In an embodiment, one or more components of the printing system (e.g., the barrier 104) can be manually positioned by a user such that the base contact surface 120 is positioned at least proximate to the surface.

In an embodiment, when the base contact surface 120 at least partially contacts the surface 126, the printing system 100 can be configured to increase the pressure between the base contact surface 120 and the surface 126 (e.g., pressure sealing). The increased pressure between the base contact surface 120 and the surface 126 can further prevent the at least one contaminant from entering the internal region 106 by decreasing gaps between the base contact surface 120 and the surface 126. For example, the base contact surface 120 or the surface 126 can deform under the pressure to decrease the gaps therebetween. In an embodiment, the pressure between the base contact surface 120 and the surface 126 can be increased by having the barrier 104 support at least a portion of the weight of the printing system 100 (e.g., the entire weight of the printing system 100). In an embodiment, the support structure 128 can apply a force in the z-direction on the printing head 108 that increases the pressure between the base contact surface 120 and the surface. In an embodiment, the barrier 104 can include one or more actuators that increase the pressure between the base contact surface 120 and the surface.

In an embodiment, the printing system 100 and, in particular, the barrier 104, can be configured to operate in various environments. As such, the barrier 104 can be configured to operate in an environment without losing its ability to isolate the internal region 106 from the external region 124 (e.g., remain at least semi-impermeable to the at least one contaminant). In an embodiment, the printing system 100 can print one or more objects in a biological environment. The biological environment can include an in vivo environment, an ex vivo environment, or an in vitro environment. As such, the barrier 104 can include a biocompatible material (e.g., a biocompatible coating applied thereto). In an embodiment, the printing system 100 can be configured to operate in an oxidizing environment. As such, the barrier 104 can include an oxidation-resistant material or remain at least semi-impermeable to the at least one contaminant when oxidized. In an embodiment, the printing system 100 can be configured to print one or more objects in an environment that includes particles flowing therein. In such an embodiment, the barrier 104 can include a material that is not substantially damaged by the particles flowing thereby.

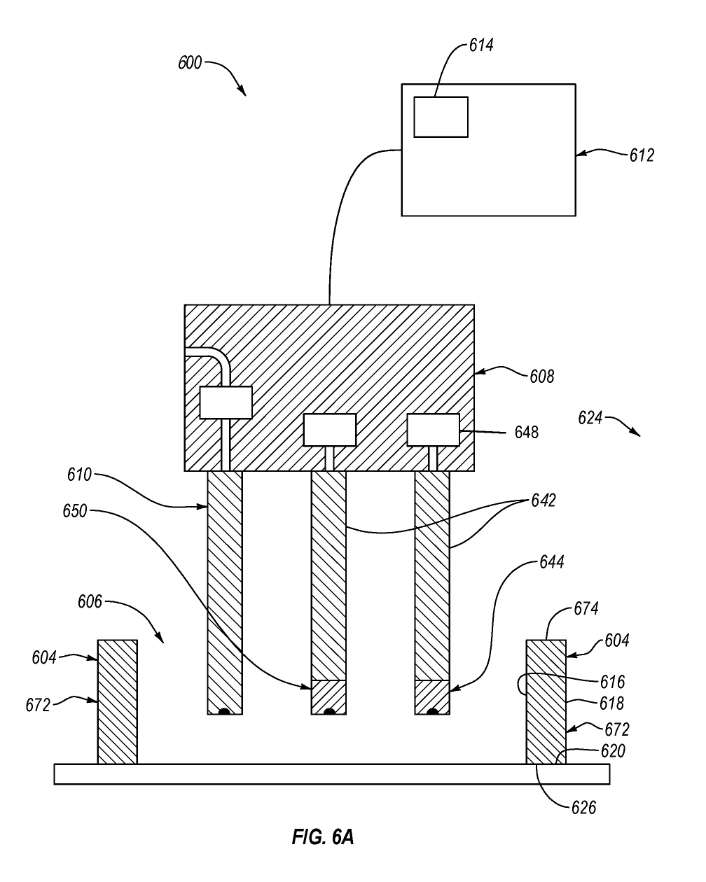

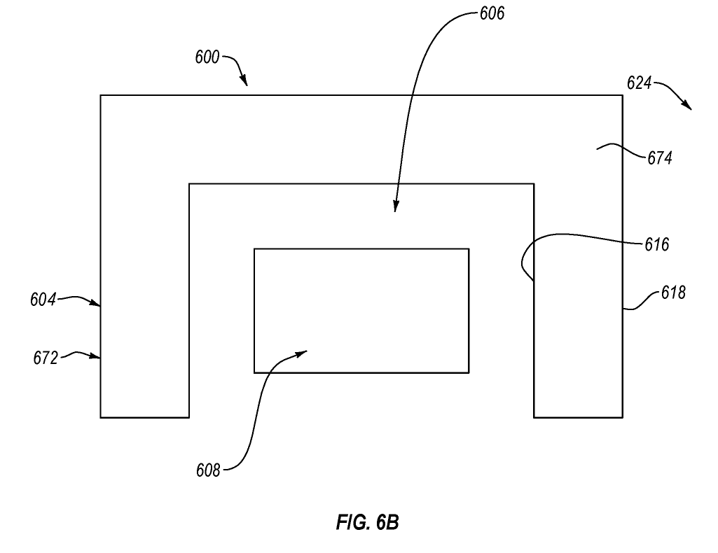

In an embodiment, the printing system 100 can include a second barrier (not shown) that is used in conjunction with the barrier 104. For example, the second barrier can at least partially enclose or be at least partially enclosed by the barrier 104. In an embodiment, the second barrier can be substantially similar to the barrier 104. For example, the second barrier can be coupled to and extend from the printing head 108. Alternatively, the second barrier can be freestanding and not coupled to the printing head 108 (e.g., the cofferdam 672 shown in FIG. 6A). Using a second barrier can further isolate the internal region 106 from the external region 124 compared to when only the barrier 104 is used.

In an embodiment, when the internal region 106 is first isolated from the external region 124, the internal region 106 can initially include at least one contaminant therein. In other embodiments, the barrier 104 is not completely impermeable to at least one contaminant, and at least one contaminant can enter the internal region 106. Therefore, the printing system 100 can include one or more removal devices 110 at least partially positioned within or near the internal region 106 configure to remove at least one contaminant.

The one or more removal devices 110 can be any device configured to remove at least one contaminant or substance (e.g., excess flushing agent) from the internal region 106. The one or more removal devices 110 can be at least partially positioned in or near the internal region 106. In the illustrated embodiment, the one or more removal devices 110 are coupled to and extend from the printing head 108. Alternatively, in an embodiment, the one or more removal devices 110 can be attached to, at least partially housed in or integral with the barrier 104. In an embodiment, the one or more removal devices 110 can include at least one removal aperture 130. The at least one removal aperture 130 can be configured to receive at least one contaminant or substance. As such, the at least one removal aperture 130 can be configured to receive a gas, a liquid, or a solid. For example, the at least one removal aperture 130 can include a screen if the at least one removal aperture 130 is configured to only receive a gas or a liquid. In an embodiment, the one or more removal devices 110 can controllably remove at least one contaminant or substance responsive to directions from the control electrical circuitry 114. In an embodiment, the one or more removal devices 110 can remove at least one contaminant or substance without requiring directions from the control electrical circuitry 114. For example, the one or more removal devices 110 can substantially continuously remove at least one contaminant or substance.

In an embodiment, the one or more removal devices 110 can remove one or more substances (e.g., excess flushing agent) from the internal region 106. Removing the one or more substances from the internal region 106 can improve the printing system's 100 control over the printing process or improve the one or more removal devices' 110 ability to remove at least one contaminant from the internal region 106. In an embodiment, the one or more removal devices 110 can be configured to remove selected substances or selected contaminants.

In an embodiment, the one or more removal devices 110 can include one or more sensors 132 coupled thereto (e.g., physically coupled, communicably coupled). In an embodiment, the one or more sensors 132 can detect a presence of at least one contaminant or substance when the internal region 106 is at least partially isolated from the external region 124. The one or more removal devices 110 can be configured to remove the at least one contaminant or substance responsive to a signal from the one or more sensors 132 indicating the presence of the at least one contaminant in the internal region 106. For example, the one or more removal devices 110 can be configured to remove at least a portion of the at least one contaminant or substance from at least a portion of the internal region 106 responsive to a signal from the one or more sensors 132 indicating that a threshold level of the at least one contaminant or substance has been reached in the internal region 106. For example, when a flushing agent is used, the one or more sensors 132 can detect if the flushing agent is present and responsive to a signal from the one or more sensors indicating the presence of the flushing agent, the one or more removal devices 110 can remove the flushing agent (e.g., as it is dispensed) from at least a portion of the internal region 106 to thereby cleanse at least a portion of the region of interest 102. In an embodiment, the one or more sensors 132 can detect when the level of the flushing agent has reached a threshold and, responsive to a signal from the one or more sensors 132 indicating that a threshold level has been reached, the one or more removal devices 110 can remove at least a portion of the flushing agent from at least a portion of the internal region 106. In an embodiment, the one or more sensors 132 can be coupled to the control electrical circuitry 114. The control electrical circuitry 114 can direct the one or more removal devices 110 to remove the at least one contaminant or substance from at least a portions of the internal region 106 responsive to a signal from the one or more sensors 132.

The one or more removal devices 110 and the at least one removal aperture 130 can be positioned at various locations within the internal region 106. In an embodiment, the at least one removal aperture 130 can be positioned near the region of interest 102. In an embodiment, the at least one removal aperture 130 can be positioned near the printing head 108. In an embodiment, the at least one removal aperture 130 can be positioned near one or more weaknesses in the barrier 104. For example, the at least one removal aperture 130 can be positioned near the base contact surface 120. In an embodiment, the at least one removal aperture 130 can be positioned near a seam formed between one or more pieces of the barrier 104.

In an embodiment, the removal device 110 includes one or more microconduits, one or more nozzles, or one or more tubes that are coupled to the at least one removal aperture 130. The one or more microconduits, one or more nozzles, or one or more tubes, can extend from the at least one removal aperture 130 towards the printing head 108. The one or more microconduits, one or more nozzles, or one or more tubes can be configured to have at least one contaminant or substance flow therethrough.

In an embodiment, the one or more removal devices 110 can be configured to remain substantially stationary. For example, the one or more removal devices 110 can include a rigid, semi-rigid, or flexible material. In an embodiment, the one or more removal devices 110 can include one or more actuators that can controllably steer the at least one removal aperture 130. For example, the one or more removal devices 110 can include a rigid material and an actuator attached to the rigid material. The one or more actuators can include a pneumatic actuator, a hydraulic actuator, a piezoelectric actuator, a shape memory material actuator, or an electroactive polymer actuator. For example, each of the one or more removal devices 110 can include a single actuator, an actuator coupled to another actuator, any combinations of actuators, any number of actuators, or an actuator coupled to a portion of the removal device 110 that is not configured to move (e.g., a rigid material). For example, the one or more removal devices 110 can be the same as, substantially similar to, or include any of the elongated members discussed herein that include or are operably coupled to actuators (e.g., elongated members 142). The one or more removal devices 110 can be steerable in one or more directions.

In an embodiment, the one or more removal devices 110 can be configured to be substantially stationary while the printing system 100 is printing an object on the region of interest 102. Maintaining the one or more removal devices 110 substantially stationary can minimize the likelihood that the one or more removal devices 110 shake the printing system 100 during the printing operation, thereby increasing precision of the printing system 100. Alternatively, in an embodiment, the one or more removal devices 110 can be controllably moved while the printing system 100 prints the object.

In an embodiment, the one or more removal devices 110 can controllably steer the at least one removal aperture 130 responsive to direction from the control electrical circuitry 114 (discussed later herein). For example, in an embodiment, the one or more removal devices 110 can include an electroactive polymer actuator. The electroactive polymer can include at least one capacitor applied to a surface thereof. Direction from the control electrical circuitry 114 can cause the capacitor to apply an electric field to the electroactive polymer, thereby causing the electroactive polymer to be controllably actuated. In an embodiment, the one or more removal devices 110 can include a shape memory material actuator. The printing system 100 can include a device configured to apply heat to the shape memory actuator. The device can heat the shape memory material actuator responsive to direction from the control electrical circuitry 114.

In an embodiment, the one or more removal devices 110 can be configured to be controllably steered independently of each other. As such, each of the one or more removal devices 110 can move independently of another removal device 110. For example, each of the one or more removal devices 110 can be configured to receive one or more directions from the control electrical circuitry 114 containing instructions. The instructions can direct each of the one or more removal devices 110 to actuate differently. However, in an embodiment, at least some of the one or more removal devices 110 cannot move independently. For example, two or more removal devices 110 can be rigidly or semi-rigidly attached together or each removal device 110 can receive the same direction from the control electrical circuitry 114.

Additional examples of actuators that can form at least a portion of the removal devices 110 are disclosed in more detail below.

The one or more removal devices 110 can be configured to operate in any of various environments. In an embodiment, the printing system 100 prints a biological material in an ex vivo, an in vivo, or an in vitro environment. As such, the one or more removal devices 110 can include a biocompatible material or be configured to operate in a fluid (e.g., blood, interstitial fluids). In an embodiment, the printing system 100 prints a material in an oxidizing environment. As such, the one or more removal devices 110 can include an oxidation-resistant material.

In an embodiment, the one or more removal devices 110 can be coupled to a removal pump 134 configured to controllably remove the at least one contaminant or substance from at least one removal aperture 130. The removal pump 134 can include a least one of a generic pump, a vacuum pump, a compressor, a centrifugal fan, or any device configured to remove at least one contaminant or substance from within or near the internal region 106. For example, a vacuum pump can evacuate or suction a liquid or gas contaminant from a location proximate to the at least one removal aperture 130. In an embodiment, the removal pump 134 can include at least one micropump. A micropump can be a mechanical or non-mechanical micropump. For example, a micropump can be driven by piezoelectric; electrostatic; thermo-pneumatic; pneumatic or magnetic forces; or can utilize electro-hydrodynamic, electro-osmotic, electrochemical or ultrasonic flow generation. In an embodiment, the removal pump 134 can be coupled to a single removal device 110, a plurality of the removal devices 110, or all of the removal devices 110. In an embodiment, the printing system 100 can include a single removal pump 134 or a plurality of removal pumps 134.

In an embodiment, the removal pump 134 can be at least partially positioned within or directly attached to the one or more removal devices 110. In an embodiment, the removal pump 134 can be spaced from the one or more removal devices 110. For example, the removal pump 134 can be at least partially positioned in the printing head 108. In such an embodiment, the one or more removal devices 110 can be coupled to the removal pump 134 via one or more conduits 136. For example, the one or more conduits 136 can extend from the one or more removal devices 110 to the removal pump 134. In an embodiment, the one or more conduits 136 can extend from the removal pump 134 to a location where the removed contaminants are sent or stored. For example, the one or more conduits 136 can extend from the removal pump 134 to an exterior surface of the printing head 108. The exterior surface can include an outlet that is coupled to the one or more conduits 136. In another example, the printing system 100 can include one or more compartments (not shown) configured to store the removed at least one contaminant. As such, the one or more conduits 136 can extend from the removal pump 134 to the one or more compartments.

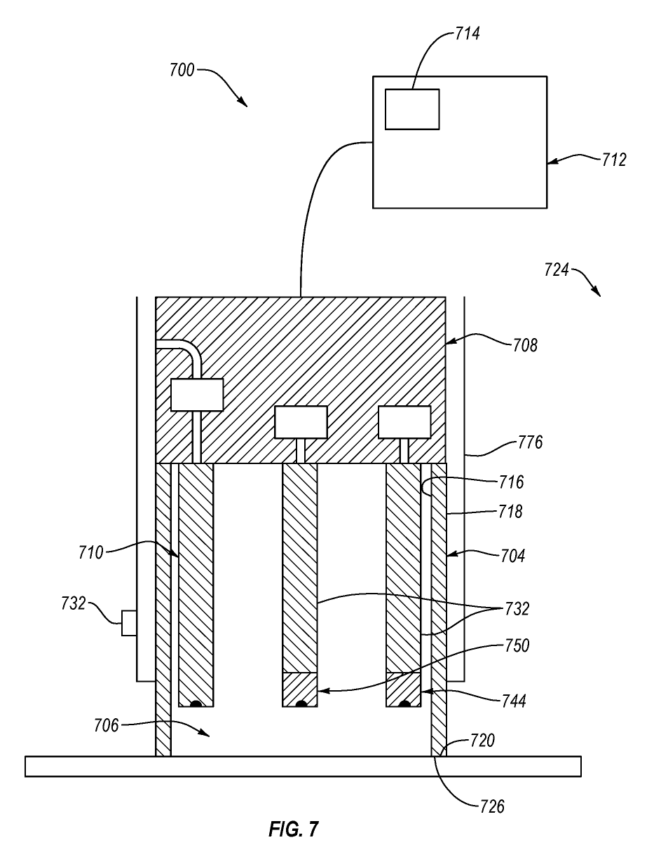

In an embodiment, at least one of the one or more removal devices 110 can be positioned in the external region 124. The at least one removal device 110 positioned in the external region 124 can be configured to remove at least one contaminant from a portion of the external region 124 that is proximate to the barrier 104. Such a configuration can decrease the amount of the at least one contaminant that contacts the barrier 104 and enters the internal region 106. Similarly, the at least one removal device 110 can cause a negative pressure in the external region 124 relative to the internal region 106. The negative pressure in the external region 124 can cause at least one contaminant or substance in the internal region 106 to flow from the internal region 106 to the external region 124. In an embodiment, the printing device can be positioned in a body-insertable device (e.g., the body-insertable device 776 shown in FIG. 7). In such an embodiment, the at least one removal device 110 positioned in the external region 124 can be a portion of the body-insertable device configured to suck up fluids from an internal region of a body of a subject.

As discussed above, the printing system 100 can include the printing head 108, which is configured to support one or more components of the printing system 100. For example, the barrier 104 and the one or more removal devices 110 can be coupled to the printing head 108. The printing head 108 can support the one or more removal devices 110 above, proximate to, adjacent to, or remote from the region of interest 102. The printing head 108 can further include additional components mounted to, supported by, or at least partially enclosed by the printing head 108. For example, the removal pump 134 can be at least partially enclosed by the printing head 108.

The printing system 100 can further include a support structure 128 configured to support the printing head 108 a selected distance from the region of interest 102. For example, the support structure 128 can include one or more beams, columns, stretchers, or other structures coupled to the printing head 108 that maintain the printing head 108 above the region of interest 102. The support structure 128 can be further configured to maintain the printing head 108 substantially stable (i.e. does not uncontrollably tilt or shift) above the region of interest 102. In an embodiment, the support structure 128 can include two or more beams to which the printing head 108 can be attached to or rest on. For example, the support structure 128 can include a first beam 138 that generally extends in the y-direction and a second beam 140 that generally extends in the x-direction. In an embodiment, the support structure 128 can include a single beam to which the printing head 108 can be rigidly attached. In such an embodiment, the printing head 108 can include a clamp, pin, bracket, or other suitable attachment that rigidly attaches the printing head 108 to the support structure 128.

In an embodiment, the printing system 100 can be configured to enable the printing head 108 to move in at least one, at least two, or three dimensions. For example, portions of the support structure 128 can include means for movement, while additional portions of the support structure 128 can include a track on which the portions of the support structure 128 move. Means for movement can include, for example, a motor, gears, gravity, one or more pneumatic actuators, one or more hydraulic actuators, or other means for movement. The means for movement can move the printing head 108 from a first location remote from the region of interest 102 to a second location proximate to the region of interest 102. In an embodiment, the base contact surface 120 can be at least proximate to a surface when the printing head 108 is in the second location. The support structure 128 can move the printing head 108 from the first position to the second position responsive to a signal or direction from the control electrical circuitry 114. The support structure 128 can be configured to move from the first location to the second location without contacting the printing head 108, the barrier 104, or another component of the printing system 100 against an object. For example, the support structure 128 can include one or more sensors 132 that can detect an object and the control electrical circuitry 114 can use the data from the at least one sensor to move the printing head 108 around the object.

The support structure 128 can be configured to move the printing head 108 using a variety of techniques. In an embodiment, portions of the support structure 128 can be configured to rotate about an axis to thereby controllably tilt the printing head 108. For example, when the support structure 128 includes one shaft, the one shaft can rotate or twist, thereby tilting the printing head 108. In an embodiment, when the support structure 128 includes two shafts, one or more of the two shafts can rotate about an axis, thereby tilting the printing head 108. In an embodiment, portions of the support structure 128 can be configured to shift in at least one direction (e.g., at least one of the x-direction, y-direction, or z-direction), thereby displacing the printing head 108. For example, the support structure 128 can include a first beam 138 and a second beam 140 that are generally perpendicular to each other, where the first beam 138 extends in the y-direction and the second beam 140 extends in the x-direction. The first beam 138 can be configured to move in the x-direction and the second beam 140 can be configured to move in the y-direction. The support structure 128 can include tracks that enable the two beams to move in their respective directions. In such an embodiment, the printing head 108 can be attached to the two shafts using two or more bearings (not shown). Such a configuration can permit the printing head 108 to be displaced along the first beam 138 (i.e., the y-direction) when the second beam 140 is moved in the y-direction, and vice-versa. Additionally, the support structure 128 can include an actuator configured to move the tracks in the z-direction, such as a hydraulic actuator. As such, the support structure 128 can move the printing head 108 in the x-direction, y-direction, and z-direction.

In an embodiment, the printing head 108 can be configured to move from the first position to the second position. For example, the printing head 108 can be attached to the support structure 128 using a bearing or other suitable attachment that enables the printing head 108 to move along the support structure 128. Additionally, the printing head 108 can include a motor attached to a wheel, a gear or a drive shaft that controllably moves the printing head 108 along the support structure 128. In an embodiment, both the support structure 128 and the printing head 108 can be configured to move the printing head 108 from the first position to the second position. For example, the support structure 128 can include one or more beams extending in the y-direction that are movable in the x-direction. The printing head 108 can configured to move along the beam in the y-direction.

In an embodiment, the printing system 100 can be configured to maintain the printing head 108 substantially stationary while the printing system 100 prints an object on the region of interest 102. Such an embodiment can improve the stability of the printing system 100. In an embodiment, the printing head 108 can be maintained substantially stationary by the controller 112 by not intentionally directing the printing head 108 or the support structure 128 to move. For example, the printing head 108 can include a motor that is powered off to maintain the printing head 108 substantially stationary. In an embodiment, the printing system 100 can include a device that prevents the printing head 108 from substantially moving during the printing process. The device can include a clamp, pin, or brake that is configured to substantially prevent the printing head 108 or the support structure 128 from moving. The device can be activated by the controller 112 prior to or when the printing system 100 dispenses the one or more materials. In an embodiment, the printing head 108 is configured to move while the printing system 100 prints an object.

In an embodiment, the printing system 100 can include a plurality of printing heads 108. At least some of the plurality of printing heads 108 can be rigidly or semi-rigidly coupled together. For example, the barrier 104 can be attached to each of the plurality of printing heads 108. In an embodiment, at least some of the plurality of printing heads 108 can move independently from each other 106. For example, each of the plurality of printing heads 108 can include a corresponding motor configured to move a corresponding printing head 108. In an embodiment, different portions of the support structure 128 can be attached to each of the plurality of printing heads 108. As such, when each of the different portions of the support structure 128 shifts, twists, or otherwise moves, the attached printing head 108 correspondingly moves. At least some of the plurality of printing heads 108 can be substantially similar or substantially different from each other. Some of the one or more printing heads 108 can be configured to dispense different materials, print different objects substantially simultaneously, print different portions of the object substantially simultaneously, or include different barriers 104 coupled thereto.

In an embodiment, the printing system 100 can further include one or more components that form a printing device configured to print an object on the region of interest 102. The printing device can be configured to print the object in situ. The printing device can be incorporated into the printing head 108, coupled to the printing head 108, or can operate in conjunction with the printing head 108. At least a portion of the printing device can be positioned within the internal region 106. In an embodiment, the printing device can be a specialized device as described herein or other suitable three-dimensional printing device.

In the illustrated embodiment, the printing device includes one or more elongated members 142 coupled to and extending from the printing head 108 towards the region of interest 102. The printing device further includes one or more dispense elements 144 coupled to the one or more elongated members 142. In an embodiment, at least one of one or more elongated members 142 or the one or more dispense elements 144 are at least partially positioned in the internal region 106. The one or more elongated members 142 can include one or more actuators that controllably steer the one or more dispense elements 144. The one or more elongated members 142 can controllably steer the one or more dispense elements 144 proximate to or adjacent to the region of interest 102 and, in particular, a specific segment of the region of interest 102. The one or more dispense elements 144 can include at least one dispense aperture 146 configured to dispense one or more materials onto the region of interest 102. In an embodiment, the base contact surface 120 of the barrier 104 is configured to extend further from the printing head 108 in the z-direction than the at least one dispense aperture 146. The one or more elongated members 142 can be controllably steered and the one or more dispense elements 144 can controllable dispense responsive to direction from the control electrical circuitry 114.

The one or more dispense elements 144 can be coupled to at least one material reservoir 148. The at least one material reservoir 148 can be configured to store the one or more materials that are used to print an object on the region of interest 102. The at least one material reservoir 148 can be located in the one or more dispense elements 144 or located remotely from the one or more dispense elements 144. For example, the at least one material reservoir 148 can be at least partially enclosed by the printing head 108. The at least one material reservoir 148 can be coupled to the one or more dispense elements 144 using one or more conduits 136.

The at least one material reservoir 148 can store any of a variety of or combinations of materials. The at least one material reservoir 148 can store natural or synthetic materials. The at least one material reservoir 148 can store non-organic materials, such as metallic materials, ceramic materials, polymeric materials, other non-organic materials. The at least one material reservoir 148 can store materials for use in forming biocompatible structures, microstructures, nanostructures, scaffolds, nanoscaffolds, or the like. For example, such materials include natural or synthetic polymers, polymer fibers, microfibers, nanofibers, hydrogels, thermo-responsive polymers, Matrigel™ or the like. Non-limiting examples of materials used as scaffolds in tissue engineering are described by Bajaj et al., in Annu Rev Biomed Eng. 2014 Jul. 11; 16: 247-276 (3D Biofabrication Strategies for Tissue Engineering and Regenerative Medicine), which is incorporated herein, in its entirety, by this reference. The at least one material reservoir 148 can store organic or biological materials, such as bioinks, cells, transfected cells, cell products, peptides, proteins, carbohydrates, lipids or tissue. The biological materials can include a biomimetic. The at least one material reservoir 148 can store materials including encapsulation materials in which materials are encapsulated, such as natural or synthetic polymers, phase change polymers, polymersomes, liposomes, or the like. The encapsulating materials can include materials stored or encapsulated therein, such as organic or nonorganic materials, compounds (e.g. medicament), or any biological material. Other materials that can be stored in the material reservoir 148 and dispensed from the dispense elements 144 are discussed below.

Further examples of a printing device including one or more elongated members and one or more dispense elements coupled to the one or more elongated members are in more detail below.

In an embodiment, the printing system 100 can include one or more components that form a flushing device configured to dispense one or more flushing agents towards the region of interest 102. The one or more flushing agents configured to prepare the region of interest 102 to have an object printed thereon. The flushing device can be incorporated into the printing head 108, coupled to the printing head 108, or can operate in conjunction with the printing head 108. In an embodiment, the flushing device can be attached to, incorporated into, or at least partially housed in the barrier 104. At least a portion of the flushing device is positioned within the internal region 106. The flushing device can include any known flushing device known in the art.

In the illustrated embodiment, flushing device includes one or more elongated members 142 coupled to and extending from the printing head 108 towards the region of interest 102. The flushing device includes one or more flushing elements 150 coupled to the one or more elongated members 142. In an embodiment, at least one of the one or more elongated members 142 or the one or more flushing elements 150 are at least partially positioned in the internal region 106. The one or more elongated members 142 can include one or more actuators that controllably steer the one or more flushing elements 150. The one or more actuators can include any actuator disclosed herein. The one or more flushing elements 150 can include at least one flushing aperture 152 configured to dispense one or more flushing agents towards the region of interest 102. In an embodiment, the base contact surface 120 of the barrier 104 is configured to extend further from the printing head 108 in the z-direction than the at least one flushing aperture 152. The one or more elongated members 142 can be controllably steered and the one or more flushing elements 150 can controllably dispense responsive to direction from the control electrical circuitry 114.

In an embodiment, the one or more flushing elements 150 can be coupled to at least one flushing agent reservoir 154. The at least one flushing agent reservoir 154 can be configured to store the one or more flushing agents dispensed by the one or more flushing elements 150. The at least one flushing agent reservoir 154 can be located in the one or more flushing elements 150 or located remotely from the one or more flushing elements 150. For example, the at least one flushing agent reservoir 154 can be at least partially enclosed by the printing head 108. The at least one flushing agent reservoir 154 can be coupled to the one or more flushing elements 150 using one or more conduits 136.

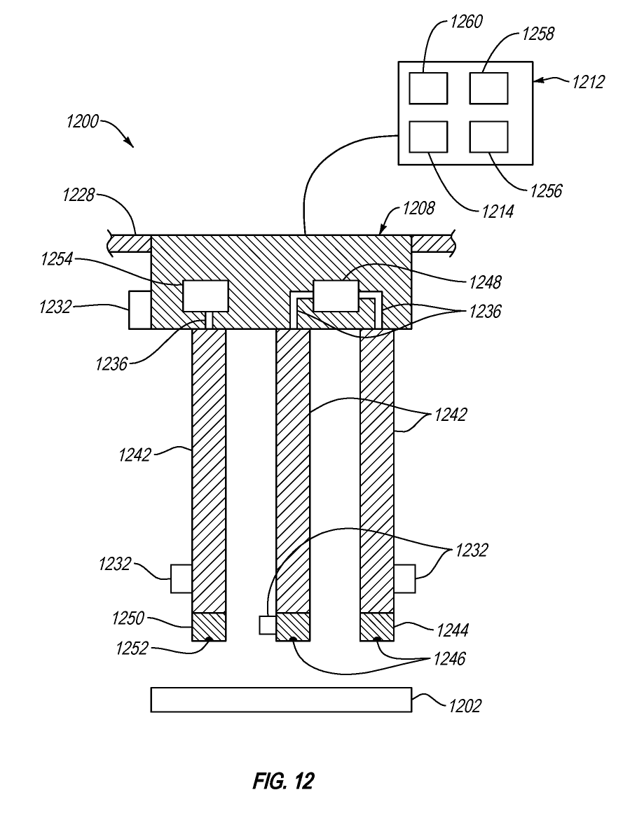

The at least one flushing agent reservoir 154 can store any of a variety of or combinations of flushing agents. The one or more flushing agents can include any physical, biological, or chemical agent that at least prepares the region of interest 102 to have an object printed thereon, as discussed in more detail with regards to FIG. 12. In an embodiment, the at least one flushing agent reservoir 154 can store one or more cleaning agents configured to remove one or more substances from the region of interest 102. In an embodiment, the at least one flushing agent reservoir 154 can store one or more antimicrobial agents configured to partially or completely destroy microorganisms that are living on the region of interest 102. The one or more antimicrobial agents can include one or more disinfectant agents configured to destroy microorganisms living on a non-living subject, one or more antibiotic agents configured to destroy microorganisms within a living subject, or one or more antiseptic agents configured to destroy microorganisms on living tissue. In an embodiment, the at least one flushing agent reservoir 154 can store one or more sterilizing agents configured to destroy substantially all living tissue on the region of interest 102. In an embodiment, the at least one flushing agent reservoir 154 can store one or more corrosive agents that damage or destroy one or more substances on the region of interest 102 (e.g., oxidizing agents). In an embodiment, the at least one flushing agent reservoir 154 can store one or more inert agents configured to provide an inert atmosphere in the internal region 106. In an embodiment, the at least one flushing agent reservoir 154 can include a flushing gas. The flushing gas can include air, oxygen, carbon dioxide, nitrogen, nitrogen dioxide, or a noble gas. In an embodiment, the at least one flushing agent reservoir 154 can include an external source of a flushing gas. In an embodiment, the flushing device delivers the flushing agent in a laminar flow, for example to maintain sterility of the region of interest 102. In an embodiment, the at least one flushing agent reservoir 154 can store one or more additional flushing agents configured to at least prepare the region of interest 102 to have an object printed thereon.

Further examples of flushing devices including one or more flushing elements are disclosed below.

In an embodiment, the printing system 100 can include one or more sensors 132 configured to detect at least one characteristic of the region of interest 102, the printing system 100, the internal region 106, or the external region 124. The at least one characteristic sensed by the one or more sensors 132 can include pressure, temperature, hydration, chemistry, surface contour, boundary conditions, or other features. The at least one characteristic that can be sensed by the one or more sensors 132 can include a position of a component of the printing system 100, such as the proximity of or contact quality between the base contact surface 120 and a surface 126, or the position or movement of the one or more removal devices 110, the rate at which the one or more removal devices 110 remove the at least one contaminant, or the rate at which the barrier 104 allows the at least one contaminant to enter the internal region 106. As such, the one or more sensors 132 can include a pressure sensor configured to sense pressure, a hydration sensor configured to sense moisture, a chemical sensor configured to sense one or more chemical elements or molecules (e.g., an oxygen sensor), a biosensor configured to sense biological matter, an optical sensor, an infrared sensor, other electromagnetic sensors (e.g., radar), a position sensor configured to sense position of one or more components of the printing system 100, an accelerometer configured to sense acceleration of the one or more components of the printing system 100, a flow gauge, an acoustic sensor, a tilt sensor configured to sense tilting of the printing head 108, or any other suitable sensor. Some sensors can require a stimulus source that emits a stimulus the sensor detects. For example, a chemical sensor mounted to the printing system 100 can include a light source that scatters or excites chemical elements or molecules present in the internal region 106 (e.g., on the region of interest 102) to identify at least one contaminant via spectroscopy.

In an embodiment, the one or more sensors 132 can be attached to different components of the printing system 100. For instance, a sensor 132 can be positioned on the barrier 104 (e.g., on the inner wall 116, the outer wall 118, or the base contact surface 120), the one or more removal devices 110, the printing head 108, the printing device, or the flushing device. The location of the one or more sensors 132 can be configured to not substantially interfere with or influence operation of the barrier 104, the one or more removal devices 110, the printing device, or the flushing device.

As previously discussed, the printing system 100 includes the controller 112, which is communicably coupled, either directly or indirectly, to at least one of the barrier 104, the one or more removal devices 110, the removal pump 134, the printing head 108, the support structure 128, the printing device, the flushing device, or the one or more sensors 132. For example, FIG. 1A illustrates that the controller 112 is communicably coupled directly to the printing head 108 and the components thereof. In an embodiment, the controller 112 can be communicably coupled indirectly to other components of the printing system 100 through the printing head 108. The controller 112 can be communicably coupled through a wired or wireless (e.g., Bluetooth, Wi-Fi) connection. In an embodiment, the controller 112 can be remote from at least one of the barrier 104, the one or more removal devices 110, the printing head 108, the flushing device, or the printing device. In an embodiment, the controller 112 can be at least partially positioned within the barrier 104, the one or more removal devices 110, the printing head 108, the flushing device, or the printing device.

In an embodiment, the controller 112 can include a user interface 156 that enables an individual to communicate with the printing system 100. The user interface 156 can include a display, mouse, keyboard, microphone, speaker, or any other device that enables an individual to communicate with the printing system 100. The user interface 156 can also include software that enables the user to communicate with the printing system 100 such as an operating system, operator controls or a process control. In an embodiment, the user interface 156 can enable an individual to input instructions or commands into the printing system 100. The commands can include instructions to position the base contact surface 120 to be at least proximate to a surface 126, instruction about at least one contaminant, instructions to use one or more removal devices 110 (e.g., the rate at which the one or more removal devices 110 remove the at least one contaminant), information about one or more components of the printing system 100, instructions to execute a program, instructions to cancel an operation, etc. In an embodiment, the printing system 100 can receive and accept the instructions or commands. In an embodiment, the printing system 100 can send data to the user interface 156. The data can include information about the current status of the printing operation, the current status of the printing system 100, an error, or additional information. The user interface 156 can display the data.

In an embodiment, the controller 112 can include memory 158 storing operational instructions for operating the printing system 100. The memory 158 can include random access memory (RAM), read only memory (ROM), a hard drive, a disc (e.g., blue-ray, DVD, or compact disc), flash memory, other types of memory electrical circuitry, or other suitable memory. The instructions stored on the memory 158 can include a CAD file representing the three-dimensional object to be printed, a program configured to operate the printing system 100, information about the printing system 100 and the components thereof, information gathered by the printing system 100, or additional information. The controller 112 can further include a processor 160 configured to direct certain operations of the printing system 100 according to the instructions contained in the memory.

As previously discussed, the controller 112 can include the control electrical circuitry 114. The control electrical circuitry 114 controls one or more components of the printing system 100. For example, the control electrical circuitry 114 can controllably operate the one or more actuators of the barrier 104, steer the one or more removal devices 110, remove the at least one contaminant using the one or more removal devices, move the printing head 108, operate of the printing device, or operate the flushing device. The control electrical circuitry 114 can control one or more components of the printing system 100 by sending directions to the one or more components. The controller 112 or the control electrical circuitry 114 can communicate the directions to the one or more components of the printing system 100. In an embodiment, the control electrical circuitry 114 can receive data from one or more sensors 132 and can control one or more components of the printing system 100 responsive to the data.

In an embodiment, the control electrical circuitry 114 can be integrally formed with the memory 158 and the processor 160 of the controller 112. Alternatively, the control electrical circuitry 114 can be separate from the memory 158 and the processor 160 of the controller 112. In such an embodiment, the control electrical circuitry 114 can include its own memory and a processor.

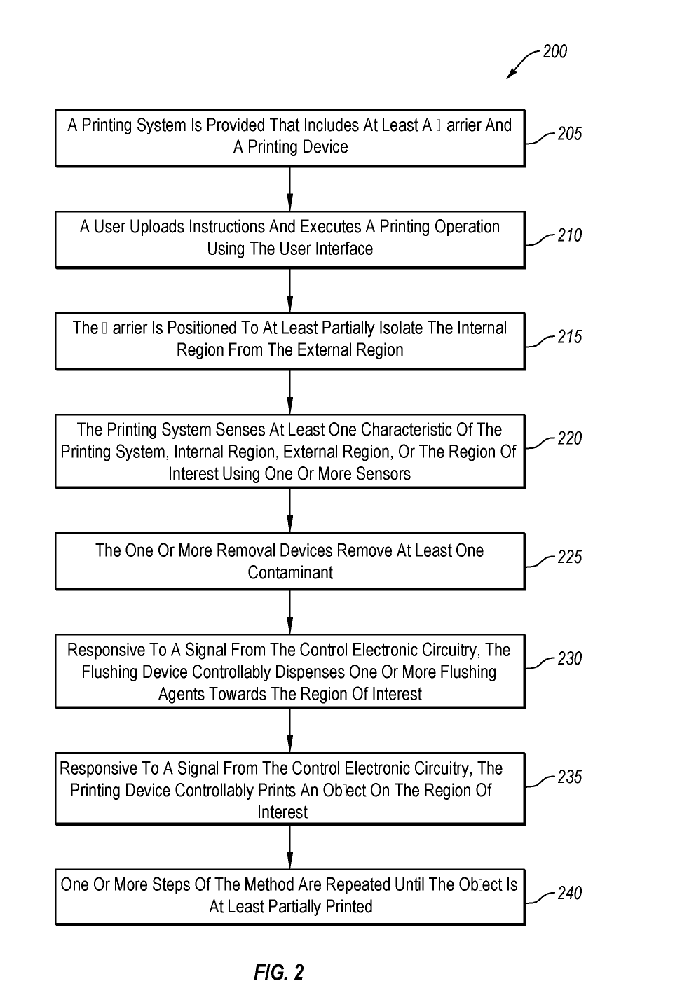

FIG. 2 is a flow diagram of a method 200 of using the printing system 100 shown in FIGS. 1A and 1B, according to an embodiment. The acts of the method 200 can be performed in any order. In some embodiments, some of the acts of the method 200 can be split into a plurality of acts, some of the acts can be combined into a single act, and some acts can be omitted. Also, it is understood that additional acts can be added to the method 200. For example, the additional acts can be required to operate other printing systems disclosed herein.

In act 205, the printing system 100 is provided, which includes at least the barrier 104 and the printing device. The barrier 104 includes the inner wall 116 that at least partially defines an internal region 106 and the outer wall 118 that at least partially defines the external region 124. The printing device can include any suitable printing device configured to print an object onto the region of interest 102. The printing system 100 can further include the one or more removal devices 110, the printing head 108, the support structure 128, the flushing device, the controller 112, or any other components described herein.

In act 210, a user can upload instructions and execute a printing operation using the user interface 156. For example, the user can load instructions into the memory 158 to have the one or more removal devices 110 remove at least one contaminant from the internal region 106. The user can also load, for example, a CAD file of the object to be printed on the region of interest 102. The instructions can be stored in the memory 158. Additionally, the user can instruct the printing system to execute a printing operation. Upon receiving the instructions from the user interface 156, the control electrical circuitry 114 can communicate directions to one or more components of the printing system 100.

In act 215, the barrier 104 is positioned to at least partially isolate the internal region 106 from the external region 124. For example, the base contact surface 120 can be positioned at least proximate to the surface 126. For example, the barrier 104 can be positioned such that at least a portion of the region of interest 102 is at least partially enclosed by the barrier 104. In an embodiment, the user can manually position barrier 104. In an embodiment, the printing system 100 can controllably position the barrier 104. In an embodiment, the barrier 104 can be positioned responsive to direction from the control electrical circuitry 114. In an embodiment, one or more components of the printing system 100 can be positioned in act 215. For example, the printing system 100 can position the one or more dispense elements 144 or the one or more flushing elements 150 proximate to the region of interest 102.

In an embodiment illustrated in act 220, the printing system 100 senses at least one characteristic of the printing system 100, internal region 106, external region 124, or the region of interest 102 using one or more sensors 132. In an embodiment, the one or more sensors 132 can detect the presence of at least one contaminant. For example, the one or more sensors 132 can detect hydration levels in the internal region 106 indicating moisture that needs to be removed therefrom. The one or more sensors 132 can transmit the detected characteristics to the controller 112.

In act 225, the one or more removal devices 110 remove at least one contaminant. For example, in an embodiment, the removal pump 134, coupled to the one or more removal devices 110, evacuates or suctions up at least one contaminant from the internal region 106 and expels the at least one contaminant into the external region 124. In an embodiment, the one or more removal devices 110 can remove at least one contaminant from the internal region 106 responsive to direction from the control electrical circuitry 114. For example, the control electrical circuitry 114 can receive detected characteristics of the internal region 106 from the one or more sensors 132 and can control the one or more removal devices 110 responsive to the received data. In an embodiment, the one or more removal devices 110 can also remove one or more substances from the internal region 106.

In act 230, responsive to a signal from the control electrical circuitry 114, the flushing device can controllably dispense one or more flushing agents towards the region of interest 102. In an embodiment, the control electrical circuitry 114 can controllably steer the one or more flushing elements 150 using the one or more elongated members 142. For example, the one or more elongated members 142 can position the one or more flushing elements 150 adjacent to or proximate to a specific segment of the region of interest 102 responsive to direction from the control electrical circuitry 114. Similarly, the control electrical circuitry 114 can controllably direct the flushing device to dispense one or more flushing agents through at least one flushing aperture 152 of the one or more flushing elements 150 towards the region of interest 102. For example, the control electrical circuitry 114 can communicate a direction instructing at least one of the one or more flushing elements 150, the at least one flushing agent reservoir 154, or the one or more conduits 136 to dispense the one or more flushing agents.

In act 235, responsive to a signal from the control electrical circuitry 114, the printing device can controllably print an object on the region of interest 102. Act 235 can be performed before act 230, substantially simultaneously with act 230, after act 230, or combinations thereof. In an embodiment, the control electrical circuitry 114 can controllably actuate the one or more dispense elements 144 using the one or more elongated members 142. The one or more elongated members 142 can position the one or more dispense elements 144 adjacent to or proximate to a specific segment of the region of interest 102. Similarly, the control electrical circuitry 114 can controllably direct the printing device to dispense one or more materials through at least one dispense aperture 146 of the one or more dispense elements 144 onto the region of interest 102. For example, the control electrical circuitry 114 can communicate the signal or direction instructing at least one of the one or more dispense elements 144, the at least one material reservoir 148, or the one or more conduits 136 to dispense the one or more materials.

In act 240, one or more acts of the method 200 are repeated until the object is at least partially printed. In an embodiment, merely act 235 is repeated until the object is completely printed. In an embodiment, two or more acts of the method 200 are repeated until the object is at least partially printed. For example, act 215 can be repeated if the object to be printed is larger than the internal region 106.

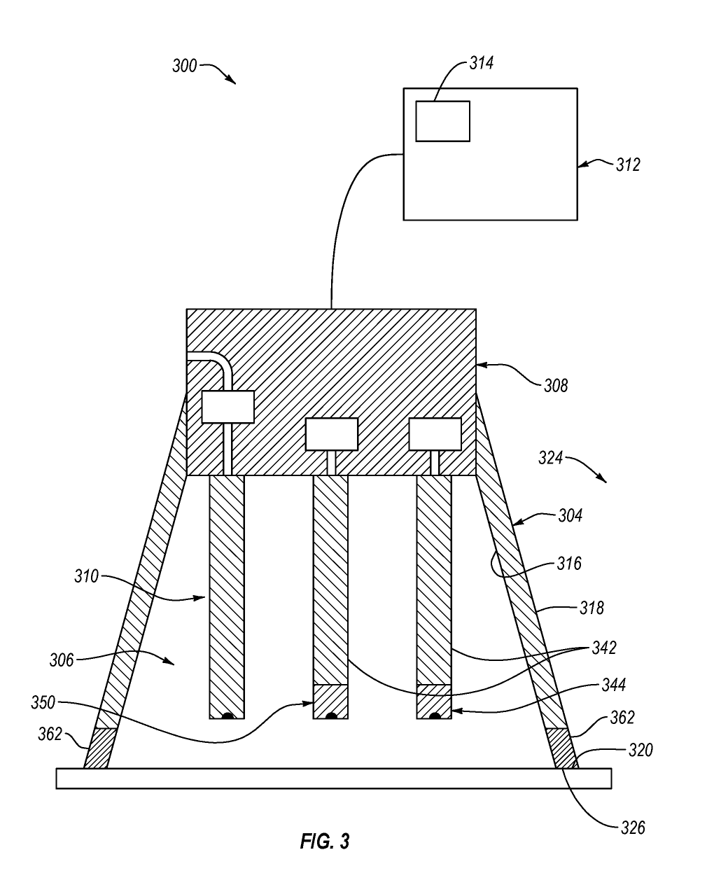

FIG. 3 is a schematic cross-sectional view of a printing system 300, according to an embodiment. The printing system 300 includes a barrier 304 having a seal 362. Except as otherwise disclosed herein, the printing system 300 can be the same or substantially similar to any of the printing systems disclosed herein. For example, the barrier 304 can be coupled to the printing head 308. The barrier 304 includes an inner wall 316 that at least partially defines an internal region 306, an outer wall 318 that at least partially defines an external region 324, and a base contact surface 320. The printing system 300 can include one or more removal devices 310 configured to remove at least one contaminant from the internal region 306. The printing system 300 can include a printing device (e.g., one or more elongated members 342 coupled to one or more dispense elements 344) or a flushing device (e.g., one or more elongated members 342 coupled to one or more flushing elements 350). Additionally, the printing system 300 can include a controller 312. The controller 312 can include control electrical circuitry 314 that controls one or more components of the printing system 300.

In an embodiment, the base contact surface 320 of the barrier 304 can include a seal 362 configured to contact a surface 326. The seal 362 can seal the barrier 304 to the surface 326, thereby at least partially preventing at least one contaminant from entering the internal region 106 from the external region 324 or at least one substance from exiting the internal region 106 to the external region 324. For example, the seal 362 can be configured to at least minimize (e.g., substantially eliminate, substantially fill) gaps between the base contact surface 320 and the surface 326 compared to a barrier 304 without the seal 362, when the same pressure exists between the base contact surface 320 and the surface 326. Minimizing gaps between the base contact surface 320 and the surface 326 can reduce or eliminate paths through which at least one contaminant or substance can flow. The seal 362 can be configured to be at least semi-impermeable (e.g., substantially impermeable) to that at least one contaminant or substance. As such, the seal 362 can enable the barrier 304 to at least partially isolate the internal region 106 from the external region 124. In an embodiment, the seal 362 defines the base contact surface 320 and can extend a distance from the base contact surface 320 towards the printing head 308. For example, the base contact surface 320 defined by the seal 362 can at least partially deform when pressed against the surface 326, thereby minimizing gaps between the base contact surface 320 and the surface 326. Alternatively, the seal 362 can include a coating or adhesive applied to a surface of the barrier 304 to form the base contact surface 320.

The seal 362 can include a variety of different types of seals and be formed from a variety of materials. In an embodiment, the base contact surface 320 can include a seal 362 that includes a compressible material that, when compressed, at least minimizes the gaps between the base contact surface 320 and the surface 326. The compressible material can include rubber, soft metals (e.g., gold), silicone, cork, or similar materials. In an embodiment, the base contact surface 320 can include a seal 362 that includes an adhesive sealant. An adhesive sealant can at least partially fill the gaps between the base contact surface 320 and a surface. Additionally, in some embodiments, the adhesive sealant can bond, attach, or adhere the base contact surface 320 to the surface 326. Examples of adhesive sealants include silicone, resins, rubber, epoxy, glue, foam, wax, polyurethane, tar, clay, grease, etc. In an embodiment, the base contact surface 320 can include a seal 362 that includes a gasket. The gasket can include a material that exhibits some degree of deformation when a pressure is applied thereto. In an embodiment, the base contact surface 320 can include a seal 362 that includes a ferrofluidic seal. The ferrofluidic seal includes a ferrofluid that at least minimizes the gaps between the base contact surface 320 and the surface 326. In such an embodiment, the barrier 304 can include a magnet or magnetic field-inducing system operated by the controller 312 that controls the ferrofluid. In an embodiment, the base contact surface 320 can include a plurality of seals 362. For example, the base contact surface 320 can include a gasket and a compressible material attached to the gasket. In an embodiment, the seal 362 can include any suitable material or device that can reduce the gap between the base contact surface 320 and the surface 326.

In an embodiment, the seal 362 can be configured to be weak (e.g., fail when certain stresses are applied thereto, such as shear stresses) or strong (e.g., resistant to failure when one or more stresses are applied thereto). In an embodiment, the seal 362 can be controllably reversibly weak or strong. In an embodiment, the seal 362 can cause the printing system 300 to permanently bond to or temporarily bond to the surface 326. In an embodiment, the seal 362 can provide thermal, electrical, magnetic, or acoustic insulation. In an embodiment, the seal 362 can be configured to operate in a variety of environments, while maintaining the seal's 362 properties. For example, the seal 362 can be configure to operate in a biological environment (e.g., an in vivo, an in vitro, or an ex vivo environment), an oxidizing environment, a heated environment, or other environments.

In an embodiment, the printing system 300 is configured to apply a force on the barrier 304 that increases the pressure between the base contact surface 320 and a surface 326. The increased pressure can cause the seal 362 to at least partially fill (e.g., substantially fill) the gaps between the base contact surface 320 and the surface 326. For example, the barrier 304 can include one or more actuators. Responsive to direction from the control electrical circuitry 314, the one or more actuators can actuate causing the base contact surface 320 to press against the surface 326.

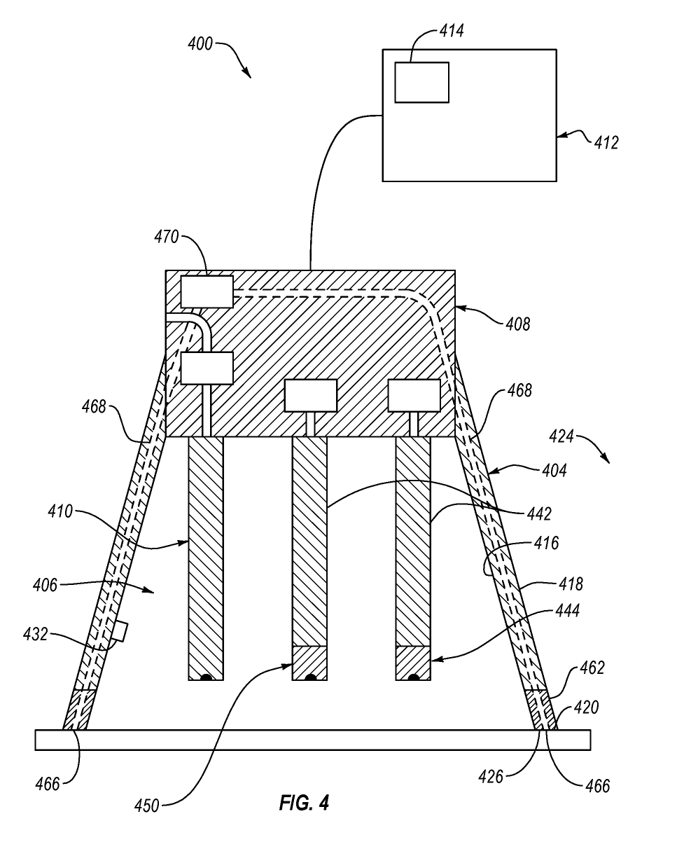

FIG. 4 is a schematic cross-sectional view of a printing system 400, according to an embodiment. The printing system 400 includes a vacuum device configured to suction a barrier 404 to a surface 426. Except as otherwise disclosed herein, the printing system 400 can be the same as or substantially similar to any of the printing systems disclosed herein. For example, the barrier 404 can be coupled to the printing head 408. The barrier 404 can include an inner wall 416 that at least partially defines an internal region 406, an outer wall 418 that at least partially defines an external region 424, and a base contact surface 420. The barrier 404 can also include a seal 462. The printing system 400 can include one or more removal devices 410 configured to at least remove at least one contaminant from the internal region 406. The printing system 400 can include a printing device (e.g., one or more elongated members 442 coupled to one or more dispense elements 444) or a flushing device (e.g., one or more elongated members 442 coupled to one or more flushing elements 450). Additionally, the printing system 400 can include a controller 412. The controller 412 can include control electrical circuitry 414 that can control one or more components of the printing system 400.

The printing system 400 includes a vacuum device configured to suction the barrier 404 to a surface 426. As such, the vacuum device can seal the barrier 404 to the surface 426, for example, using the seal 462. In an embodiment, the vacuum device includes one or more holes 466 formed in the base contact surface 420 of the barrier 404. The vacuum device also includes one or more tubes 468 (shown with phantom lines) extending from the one or more holes 466 through at least a portion of the barrier 404. The vacuum device further includes at least one vacuum 470 coupled to the one or more tubes 468 and configured to induce a negative pressure at a region proximate to the one or more holes 466. Providing negative pressure to a region proximate to the one or more holes 466 can cause the base contact surface 420 to press against the surface 426, thereby suctioning the barrier 404 to the surface 426. The vacuum device can operate responsive to direction from the control electrical circuitry 414.

The barrier 404 can include one or more holes 466 formed therein. One or more holes 466 can be formed in the base contact surface 420. In an embodiment, the one or more holes 466 can include a plurality of holes 466. Each of the plurality of holes 466 can be spaced from immediately adjacent holes 466. For example, each of the plurality of holes 466 can be radially spaced or circumferentially spaced from immediately adjacent holes 466. In an embodiment, the barrier 404 can include a single hole 466 formed therein. For example, the barrier 404 can include a hole 466 that extends through the entire length or path of the base contact surface 420.

In an embodiment, the one or more holes 466 can include a nozzle, an aperture, or other type of opening configured to receive a fluid. For example, at least one of the one or more holes 466 can be configured to at least receive at least one contaminant. In such an example, the one or more holes 466 can act as a removal device. Additionally, the one or more holes 466 can also receive one or more substances.

The one or more holes 466 can include one or more tubes 468 extending therefrom towards the at least one vacuum 470. As such, the one or more tubes 468 can communicably couple the one or more holes 466 to the at least one vacuum 470. In an embodiment, at least one tube 468 can be configured to merge with an adjacent tube 468 to form a single tube 468 at some point between the one or more holes 466 and the vacuum 470. In an embodiment, a single tube 468 can separate into two separate tubes 468. For example, the vacuum device can include a single hole 466 coupled to two or more vacuums 470. A single tube 468 can extend from the single hole 466. At some point between the single hole 466 and the two or more vacuums 470, the single tube 468 can separate into two or more tubes 468 thereby coupling the single hole 466 to the two or more vacuums 470.

In an embodiment, the at least one vacuum 470 can include any device configured to provide negative pressure at a location proximate to the one or more holes 466. In an embodiment, the at least one vacuum 470 can include any device configured to evacuate or suction a fluid or small solids from a location proximate to the one or more holes 466. For example, the at least one vacuum 470 can include a pump, a vacuum pump, a compressor, a centrifugal fan, or other suitable device. In an embodiment, the vacuum 470 can be configured to expel the fluid received from the one or more holes 466 into the external region 424. In an embodiment, the vacuum 470 can controllably suction the fluid from a location proximate to the one or more holes 466 responsive to direction from the control electrical circuitry 414. In an embodiment, the vacuum 470 can substantially continuously or intermittently provide negative pressure and/or evacuate or suction the fluid without direction from the control electrical circuitry 414. In an embodiment, the vacuum 470 can provide negative pressure or suction the fluid responsive to a characteristic detected by one or more sensors 432 (e.g., proximity of the base contact surface 420 to the surface 426).

The at least one vacuum 470 can be positioned in various locations of the printing system 400. In an embodiment, the at least one vacuum 470 can be positioned in the barrier 404. In such an embodiment, the one or more tubes 468 do not need to extend completely through the barrier 404. In an embodiment, the at least one vacuum 470 can be positioned in the printing head 408. In an embodiment, the at least one vacuum 470 can be only partially positioned in the printing head 408 (e.g., only partially enclosed by the printing head 408). In an embodiment, the at least one vacuum 470 can be located remote from the printing head 408 and the barrier 404. In such an embodiment, the one or more tubes 468 can extend from the barrier 404 or the printing head 408 to the location of the at least one vacuum 470.

In an embodiment, the vacuum 470 can be configured to induce positive pressure or to blow a fluid (e.g., air) towards the one or more holes 466. For example, evacuating or suctioning a fluid from a location proximate to the one or more holes 466 can temporarily bond the barrier 404 to the surface 426 via suction. Blowing a fluid towards or through the one or more holes 466 can break the bond between the barrier 404 and the surface 426. In another example, blowing a fluid towards or through the one or more holes 466 can cause a first portion of the fluid exiting the one or more holes 466 to flow from the one or more holes 466 towards the internal region 406 and a second portion of the fluid exiting the one or more holes 466 to flow from the one or more holes 466 towards the external region 424 or towards the one or more tubes 468. The second portion of the fluid can, in some embodiments, at least partially prevent at least one contaminant from entering the internal region 406 from the external region 424. In an embodiment, a fluid flow through the one or more holes 466 can form a laminar fluid flow.

In an embodiment, the one or more removal devices 410 positioned in the internal region 406 can cause the barrier 404 to be suctioned to a surface 426. For example, the one or more removal device 410 can remove at least one fluid from the internal region 406. Removing the at least one fluid from the internal region 406 can cause the pressure in the internal region 406 to be less than the pressure in the external region 424. The lower pressure in the internal region 406 can cause the barrier 404 to be suctioned to the surface 426 which can cause the base contact surface 420 to be pressed against the surface 426.

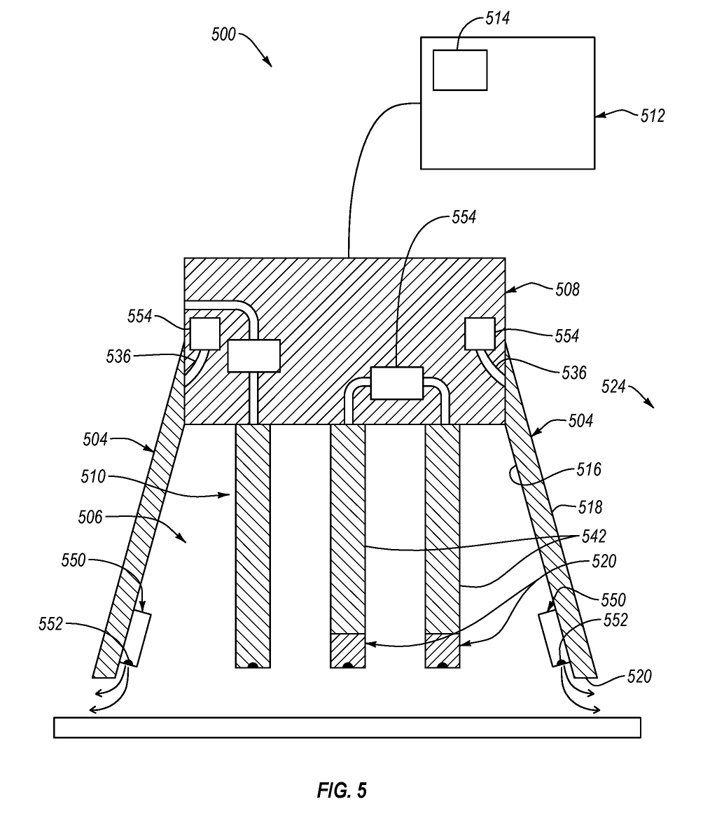

FIG. 5 is a schematic cross-sectional view of a printing system 500, according to an embodiment. The printing system 500 includes one or more flushing elements 550 configured to cause the pressure in the internal region 506 to be greater than the external region 524. Except as otherwise disclosed herein, the printing system 500 can be the same as or substantially similar to any of the printing systems disclosed herein. For example, the printing system 500 can include a barrier 504 coupled to the printing head 508. The barrier 504 can include an inner wall 516 that at least partially defines an internal region 506, an outer wall 518 that at least partially defines an external region 524, and a base contact surface 520. The printing system 500 can include one or more removal devices 510 configured to remove at least one contaminant from the internal region 506. The printing system 500 can include a printing device including one or more elongated members 542 coupled to one or more dispense elements 544. The printing device include a single material reservoir 548 fluidly coupled to each of the one or more dispense elements 544. The printing system 500 can include a controller 512. The controller 512 can include control electrical circuitry 514 that can control one or more components of the printing system 500.

The printing system 500 can include one or more flushing elements 550 configured to dispense one or more flushing agents into the internal region 506. The one or more flushing elements 550 include at least one flushing aperture 552. In an embodiment, the one or more flushing elements 550 can dispense the one or more flushing agents into the internal region 506 at a rate greater than the one or more removal devices 510 remove at least one fluid (e.g., at least one contaminant). As such, the one or more flushing elements 550 can generate a pressure in the internal region 506 to be higher than the pressure in the external region 524. The higher pressure in the internal region 506 can cause a fluid (e.g., the one or more flushing agents) to exit the internal region 506 and enter the external region 524. For example, the fluid can flow through gaps between the base contact surface 520 and a surface 526, seams in the barrier 504, etc. The fluid exiting the internal region 506 can at least partially occupy paths that at least one contaminant uses to enter the internal region 506. As such, the higher pressure in the internal region 506 caused by the one or more flushing elements 550 can at least partially prevent at least one contaminant from entering the internal region 506. In an embodiment, the one or more flushing elements 550 can controllably dispense the one or more flushing elements 550 responsive to direction from the control electrical circuitry 514.

In an embodiment, the one or more flushing elements 550 can dispense the one or more flushing agents into the internal region 506 at a rate substantially equal to the rate at which the one or more removal devices 510 remove at least the one or more flushing agents. For example, in such an embodiment, the printing system 500 can cleanse a region of interest. For example, in such an embodiment, the printing system 500 can maintain a sterile environment (e.g., by maintaining a laminar flow).

The one or more flushing elements 550 can be placed at various locations within the internal region 506. In an embodiment, the one or more flushing elements 550 can be coupled to one or more elongated members, with the one or more elongated members coupled to and extending from the printing head 508 (e.g., the flushing elements 150 illustrated in FIG. 1A). In the illustrated embodiment, the one or more flushing elements 550 are coupled to the barrier 504. In such an embodiment, the barrier 504 can be at least partially hollow and fluidly couple the one or more flushing elements 550 to one or more conduits 536. In an embodiment, the one or more conduits 536 can extend from the barrier 504 to at least one flushing agent reservoir 554 positioned in the printing head 508. Alternatively, In an embodiment, the at least one flushing agent reservoir 554 can be at least partially positioned in the barrier 504, at least partially positioned in the one or more flushing elements 550, or can be positioned in another location of the printing system 500. The one or more flushing elements 550 can be configured to dispense the one or more flushing agents towards the base contact surface 520. Positioning the one or more flushing elements 550 on the barrier 504 can reduce the amount of the one or more flushing agents flowing proximate to the one or more dispense elements 544, thereby improving the precision of the printing system 500. In an embodiment, the one or more flushing elements 550 can be at least partially enclosed by or incorporated into the barrier 504. For example, similar to the vacuum device shown in FIG. 4, the one or more flushing elements 550 can be at least partially incorporated into the barrier 504 and configured to dispense the one or more flushing agents from the base contact surface 520.

FIGS. 6A and 6B are a schematic cross-sectional view and top view of a printing system 600, respectively, according to an embodiment. The printing system 600 includes a barrier 604 that is configured as a cofferdam 672. Except as otherwise disclosed herein, the printing system 600 can be the same as or substantially similar to any of the printing systems disclosed herein. For example, the printing system 600 can include one or more removal devices 610 configured to remove at least one contaminant from the internal region 606. The printing system 600 can further include a printing device (e.g., one or more elongated members 642 coupled to one or more dispense elements 644) and a flushing device (e.g., one or more elongated members 642 coupled to one or more flushing elements 650). Additionally, the printing system 600 can include a controller 612. The controller 612 can include control electrical circuitry 614 that controls one or more components of the printing system 600.

As discussed above, in an embodiment, the barrier 604 can be in the form of a cofferdam 672. The cofferdam 672 includes an inner wall 616 and an outer wall 618 that is spaced from the inner wall 616. The inner wall 616 can at least partially define the internal region 606 and the outer wall 618 can at least partially define the external region 624. The cofferdam 672 can also include a base contact surface 620 that extends between the inner wall 616 and the outer wall 618. The base contact surface 620 is configured to be positioned at least proximate to a surface 626. The cofferdam 672 also includes an upper surface 674 that is spaced from the base contact surface 620. The upper surface 674 also extends between the inner wall 616 and the outer wall 618. In an embodiment, at least a portion of the upper surface 674 is not coupled to or does not extend from the printing head 608. As such, a gap exists between at least a portion of the upper surface 674 and the printing head 608.

In an embodiment, the cofferdam 672 does not include at least one of the base contact surface 620 or the upper surface 674. For example, the cofferdam 672 can include an inner wall 616 and an outer wall 618 that extend from the base contact surface 620 and intersect with each other. In an embodiment, the cofferdam 672 can only include an inner wall 616 and an outer wall 618 that form a generally circular cross-sectional geometry. In both examples, a gap can exist between the cofferdam 672 and the printing head 608.

In an embodiment, the cofferdam 672 can be configured to completely enclose a lateral periphery of the internal region 606. For example, the cofferdam 672 can exhibit a generally hollow triangular cross-sectional geometry, a generally hollow rectangular cross-sectional geometry, a generally hollow circular cross-sectional geometry, or any suitable cross-sectional geometry. However, in the embodiment illustrated in FIG. 6B, the cofferdam 672 can be configured to partially enclose the lateral periphery of the internal region 606. For example, the cofferdam 672 can have a cross-sectional geometry that exhibits a generally linear cross-sectional geometry, a generally v-shaped cross-sectional geometry, a generally u-shaped cross-sectional geometry, a generally semicircular cross-sectional geometry, or any suitable cross-sectional geometry. In an embodiment, the cofferdam 672 can exhibit geometry that substantially conforms to the geometry of another component of the printing system. For example, as illustrated in FIG. 6B, the cofferdam 672 exhibits a block u-shaped geometry that is similar to the rectangular geometry of the periphery of the printing head 608.

In an embodiment, the cofferdam 672 is configured to be manually positioned by a user or the printing system 600. For example, when the cofferdam 672 is freestanding (e.g. not attached to the printing head 608 or another component of the printing system 600), the printing system 600 can move the cofferdam 672 from a first location to a second location by pushing the cofferdam 672 using one or more components of the printing system 600. In an embodiment, the cofferdam 672 can include one or more structures (not shown) extending from the cofferdam 672 to at least one component of the printing system 600 (e.g., the printing head 608, the support structure, etc.). The one or more structures can physically couple the cofferdam 672 to a component of the printing system 600 and can enable the printing system 600 to move the cofferdam 672. However, the one or more structures may not completely eliminate the gap between the cofferdam 672 and the printing head 608.

In an embodiment, the cofferdam 672 can include one or more components of the printing system 600 attached thereto, incorporated therein, or at least partially housed therein. For example, the cofferdam 672 can include one or more components of the printing device, such as the one or more elongated members 642 coupled to the one or more dispense elements 644. In such an example, the printing system 600 can include one or more tubes (not shown) extending between the cofferdam 672 and the printing head 608 that fluidly couples the one or more dispense elements 644 to at least one material reservoir 648. Similarly, the cofferdam 672 and the one or more components of the printing device can be communicably coupled to the control electrical circuitry 614. In an embodiment, the cofferdam 672 can include the entire printing device such that the cofferdam 672 does not need to be coupled to the printing head 608. In an embodiment, the cofferdam 672 can include one or more components of the flushing device (e.g., the entire flushing device), one or more components of a removal device (e.g., the entire removal device, not shown), or one or more components of a vacuum device (e.g., the entire vacuum device, not shown). In another embodiment, the cofferdam 672 or the printing head 608 can include one or more actuators that enable the cofferdam 672 to be controllably steered relative to the printing head 608.

FIG. 7 is a schematic cross-sectional view of a printing system 700 configured to be inserted into an internal region of a body of a subject (e.g. during laparoscopic surgery), according to an embodiment. Except as otherwise disclosed herein, the printing system 700 can be the same as or substantially similar to any of the printing systems disclosed herein. For example, the printing system 700 includes a barrier 704 coupled to the printing head 708. The barrier 704 includes an inner wall 716 that at least partially defines an internal region 706, an outer wall 718 that at least partially defines an external region 724, and a base contact surface 720. The printing system 700 can include one or more removal devices 710 configured to remove at least one contaminant from the internal region 706. The printing system 700 can include a printing device (e.g., one or more elongated members 742 coupled to one or more dispense elements 744) or a flushing device (e.g., one or more elongated members 742 coupled to one or more flushing elements 750). Additionally, the printing system 700 can include a controller 712. The controller 712 can include control electrical circuitry 714 that controls one or more components of the printing system 700.

Referring to FIG. 7, the printing system 700 can be configured to be partially inserted into an internal region of interest 702 of a living subject (e.g. an animal, a person). The internal region of interest 702 of a living subject can include any region that is integral to a biological body. For example, the internal region of interest 702 of a human body can include a region that is epidermal, endodermal, subdermal, subcutaneous, intraperitoneal, intra-abdominal, intra-organ, intracranial, skeletal, muscular, nervous, cardiac, luminal, endoluminal, etc. In such an embodiment, the printing head 708 can remain outside the subject while the one or more elongated members 742 can be configured to be inserted into the internal region of interest 702 (e.g., an epidermal region, an endodermal region, a subdermal region, a subcutaneous region, an intraperitoneal region, an intra-abdominal region, an intra-organ region, an intracranial region, a skeletal region, a muscular region, a nervous region, a cardiac region, a visceral region, a parietal region, a lumenal region, an endolumenal region, etc.). For example, during laparoscopic surgery, the printing head 708 can be positioned adjacent to an opening of a trocar or a cannula. The trocar or cannula can be partially inserted into the living subject. The barrier 704, the one or more removal devices 710, or one or more components of the printing system 700 (e.g., the one or more removal devices 710, the one or more elongated members 742, the one or more dispense elements 744, the one or more flushing elements 750, etc.) can be at least partially inserted into the subject using the trocar or cannula.

The printing system 700 can include a body-insertable device 776 configured to insert the barrier 704, the one or more removal devices 710, or one or more components of the printing system 700 into the subject and access the internal region of interest 702. In an embodiment, the body-insertable device 776 can include a catheter, endoscope, or other suitable devices. For example, the body-insertable device 776 can include an endoscope that includes at least one channel configured to at least partially house at least one of the one or more removal devices 710, the one or more elongated members 742, the one or more flushing elements 750, or the one or more dispense elements 744. In an embodiment, the at least one channel can also be configured to at least partially house the barrier 704. In an embodiment, the barrier 704 can be at least partially housed in at least one additional channel where the at least one additional channel is adjacent to or remote from the at least one channel. In an embodiment, the barrier 704 can be positioned around at least one channel such that the barrier 704 at least partially encloses the at least one barrier 704.

In an embodiment, the body-insertable device 776 can be configured to protect or guide the barrier 704, the one or more removal devices 710, or one or more components of the printing system 700, while the barrier 704, the one or more removal devices 710, or one or more components of the printing system 700 are inserted into the subject. As such, the body-insertable device 776 can at least partially house the barrier 704, the one or more removal devices 710, or one or more components of the printing system 700. For example, in an embodiment, the portions of the barrier 704, the one or more removal devices 710, or one or more components of the printing system 700 can protrude from the body-insertable device 776. Alternatively, in an embodiment the barrier 704, the one or more removal devices 710, or one or more components of the printing system 700 can be configured to be completely housed in the body-insertable device 776 while being inserted into the subject. However, when the body-insertable device 776 is proximate to the internal region of interest 702, the one or more actuators (e.g., the one or more actuators of the barrier 704, the one or more removal devices 710, or the one or more elongated members 742) can actuate such that portions of the barrier 704, the one or more removal devices 710, or one or more components of the printing system 700 protrude from the body-insertable device 776. In an embodiment, the body-insertable device 776 can be attached to the printing head 708 or the barrier 704. Alternatively, in an embodiment, the body-insertable device 776 can only house a portion of the barrier 704, the one or more removal devices 710, or one or more components of the printing system 700.

In an embodiment, the printing system 700 can be configured to operate during laparoscopic surgery. For example, the body-insertable device 776 can at least partially house the barrier 704, the one or more removal devices 710, or one or more components of the printing system 700. In such an embodiment, a trocar can be inserted into the subject, and the body-insertable device 776 can be inserted into a subject via the trocar. An individual operating the printing system 700 can guide the body-insertable device 776 using one or more sensors 732 attached to the body-insertable device 776 or one or more components of the printing system 700. The one or more sensor 732 can include a video camera with a cold light source (e.g., halogen or xenon). When the body-insertable device 776 reaches the internal region of interest 702, the control electrical circuitry 714 controllably steers one or more components of the printing system 700. For example, the control electrical circuitry 714 can controllably steer one or more components of the printing system 700 (e.g., the barrier 704, the printing head 708, etc.) to position the base contact surface 720 at least proximate to a surface 726.

In an embodiment, the printing system 700 can be used during the laparoscopic surgery. For example, the barrier 704 can be positioned such that the base contact surface 720 is positioned at least proximate to the surface 726. As such, the barrier 704 can isolate the internal region 706 from the external region 724 and at least partially prevent at least one contaminant (e.g., one or more body fluids) from entering the internal region 706. The one or more removal devices 710 can at least remove at least one contaminant present in the internal region 706. After the laparoscopic surgery is complete, the printing system 700 can be used to speed the healing process. For example, the one or more dispense elements 744 of the printing system 700 can controllably dispense biological materials into the subject such as tissue, grafts, or cells, such as printing tissue, capillaries, or similar structures within the body. The barrier 704 can substantially prevent at least one contaminant from interfering with the printing of the biological materials. In an embodiment, the printing system 700 can be configured to only be used during or after the laparoscopic surgery.

In an embodiment, the printing system 700 can be configured to be substantially inserted into the subject. For example, the printing system 700 can include a body-insertable device 776 that can be configured to at least partially house the printing head 708 along with the barrier 704, the one or more removal devices 710, or one or more additional components of the printing system 700. As such, the printing head 708 can be inserted into the subject along with the barrier 704, the one or more removal devices 710, or one or more components of the printing system 700. However, the printing system 700 can be configured to be inserted into the subject without the use of the body-insertable device 776.

In the illustrated embodiment, the controller 712 is illustrated to be remote from the printing head 708 and configured to not be inserted into the subject. However, in other embodiments, the controller 712 can be configured to be inserted subcutaneously. For example, at least a portion of the controller 712 can be positioned within the printing head 708.

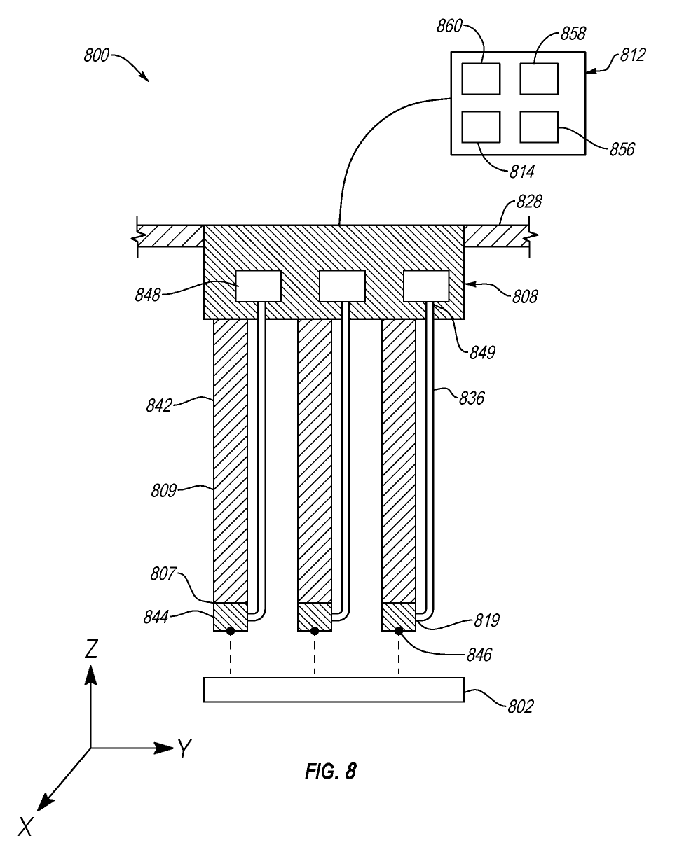

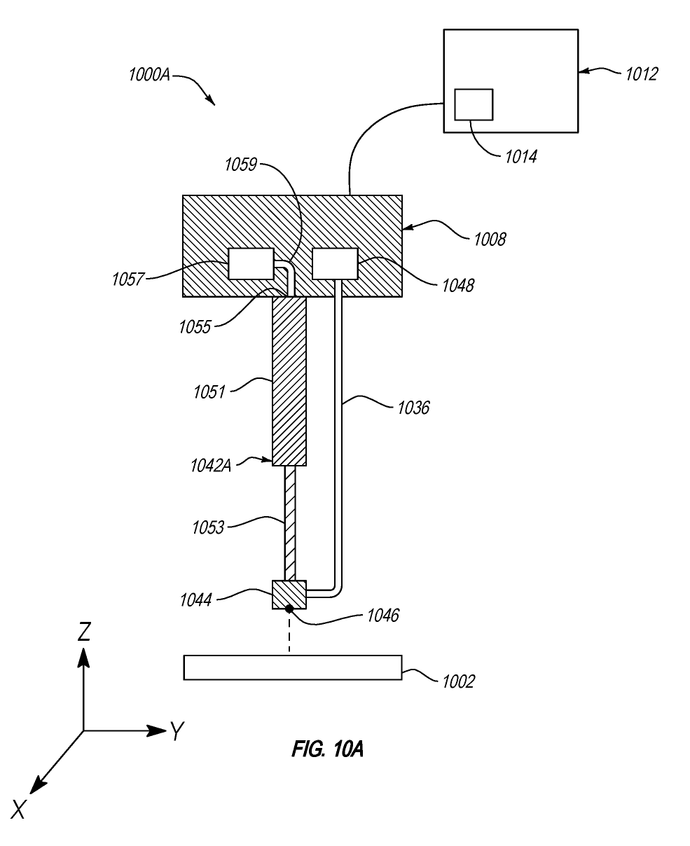

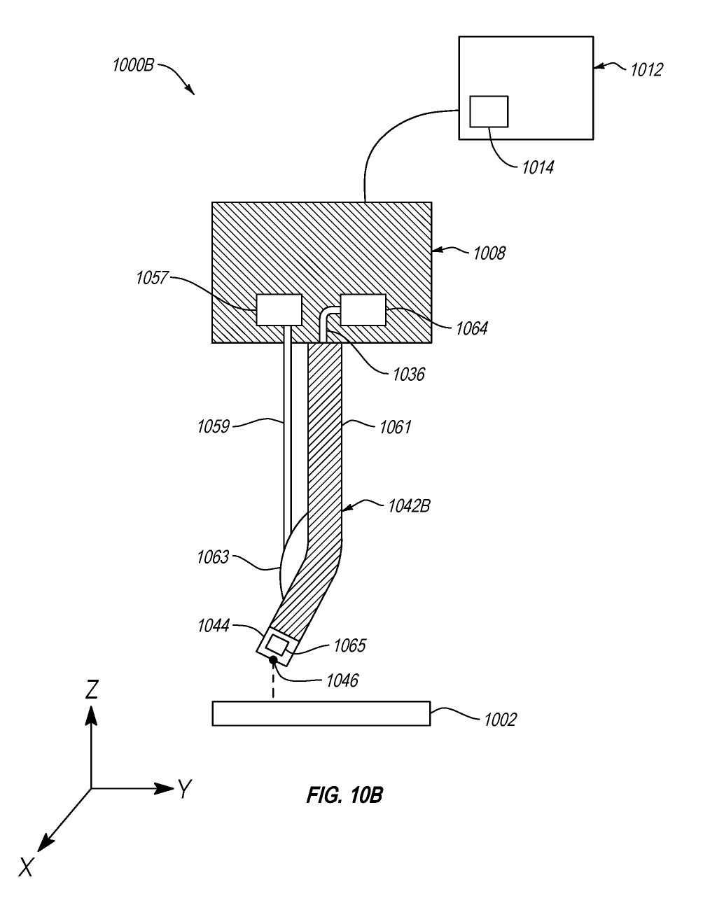

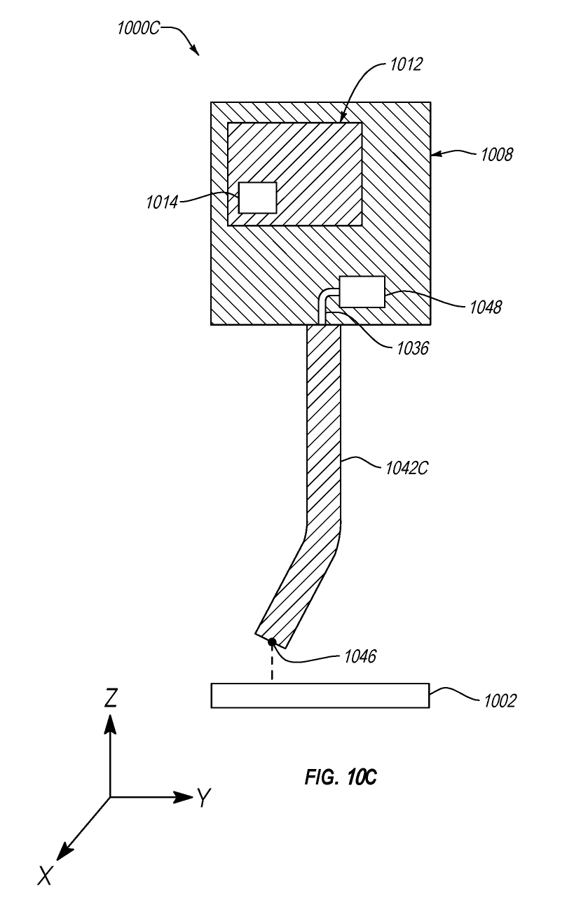

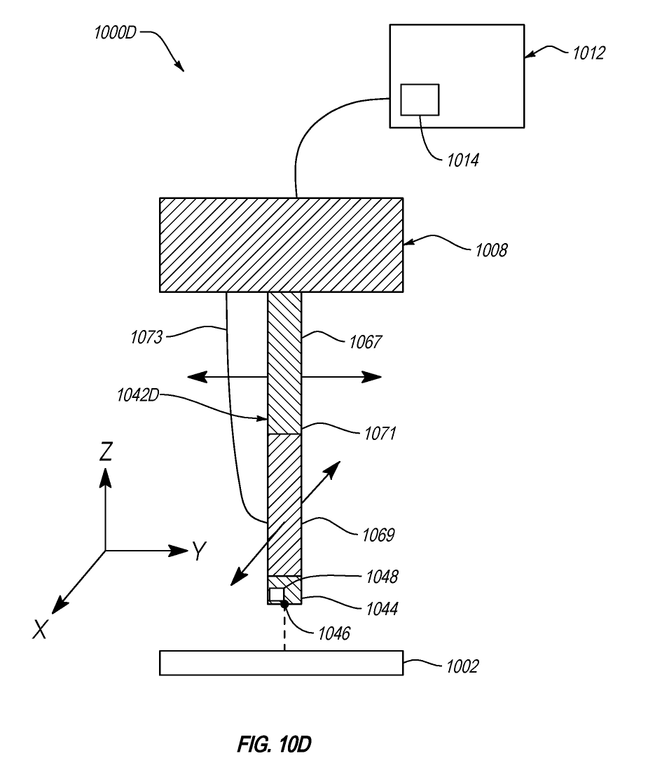

FIG. 8 is a schematic cross-sectional view of a printing system 800 according to an embodiment. Except as otherwise disclosed herein, the printing system 800 is the same as or substantially similar to any of the printing systems disclosed herein. The printing system 800 includes one or more elongated members 842 that can be configured to controllably steer one or more dispense elements 844. In the illustrated embodiment, the printing system 800 includes a printing head 808 positioned a distance above a region of interest 802. The printing head 808 includes the one or more elongated members 842 operably coupled to and extending therefrom towards the region of interest 802. The one or more dispense elements 844 are coupled to the one or more elongated members 842 such that the one or more elongated members 842 can controllably and selectively steer each of the one or more dispense elements 844. The one or more dispense elements 844 include at least one dispense aperture 846 configured to dispense one or more materials onto the region of interest 802 therethrough. The printing head 808 supports components of the printing system 800. For example, the printing head 808 supports the one or more elongated members 842 so that the printing head 808 can maintain the one or more elongated members 842 above, proximate to, or adjacent to the region of interest 802. The printing head 808 can further include additional components mounted to, supported by, or at least partially enclosed by the printing head 808. The additional components can support the operation of the printing system 800, such as devices that actuate the one or more elongated members 842 (e.g., the pump or compressor 1057 shown in FIG. 10A), hold the one or more materials (e.g., the one or more material reservoirs 848), and control the one or more elongated members 842 (e.g., the controller 812).

The printing system 800 can further include a support structure 828 configured to support the printing head 808 a selected distance from the region of interest 802. The support structure 828 can be the same as or substantially similar to any of the support structures disclosed herein (e.g., the support structure 128 of FIGS. 1A-1B). For example, the support structure 828 can include one or more beams, columns, stretchers, or other structure that are coupled to the printing head 808 and maintain the printing head 808 the selected distance from the region of interest 802. The support structure 828 can be further configured to maintain the printing head 808 substantially stably (i.e. does not uncontrollably tilt or shift) above the region of interest 802. Stably maintaining the printing head 808 adjacent to or proximate to the region of interest 802 can improve the precision of the printing system 800 and the object to be formed. For example, the support structure 828 can include two or more beams to which the printing head 808 can be attached or rest on. In an embodiment, the support structure 828 can include a single beam to which the printing head 808 can be rigidly attached. In such an embodiment, the printing head 808 can include a clamp, pin, bracket, or other suitable attachment that rigidly attaches the printing head 808 to the support structure 828.

The printing system 800 further includes a controller 812 that is communicatively coupled to the one or more elongated members 842, the one or more dispense elements 844, and optionally the printing head 808. The controller 812 includes control electrical circuitry 814 configured to controllably actuate the one or more elongated members 842 to position the one or more dispense elements 844 adjacent to or proximate a specific segment of the region of interest 802 and to controllably dispense the one or more materials through the at least one dispense aperture 846 towards the region of interest 802.

In an embodiment, the printing system 800 can be configured to enable the printing head 808 to move in at least one, at least two, or three dimensions. The support structure 828 can be configured to move from the first location to the second location without contacting the printing head 808, the one or more elongated members 842, or the one or more dispense elements 844 against an object. For example, the support structure 828 can include at least sensor that can detect an object and the control electrical circuitry 814 can use the data from the at least one sensor to move the printing head 808 around the object.

In an embodiment, the printing system 800 can be configured to maintain the printing head 808 substantially stationary while the printing system 800 is printing one or more materials onto the region of interest 802. Such an embodiment can improve the stability of the printing system 800, increase controllability of the one or more elongated members 842, and improve the precision of printing system 800. In an embodiment, the printing head 808 can be maintained substantially stationary by the controller 812 not intentionally directing the printing head 808 or the support structure 828 to move. For example, the printing head 808 can include a motor that is powered off when it is desired for the printing head 808 or the support structure 828 to be substantially stationary. In an embodiment, the printing system 800 can include a device that prevents the printing head 808 from substantially moving during the printing process. The device can include a clamp, pin, or brake that is configured to substantially prevent the printing head 808 or the support structure 828 from moving. The device can be activated by the controller 812 prior to or when the printing system 800 dispenses the one or more materials.

In an embodiment, the printing head 808 is configured to move before, during, or after the printing system 800 dispenses the one or more materials. For example, the printing head 808 can be configured to move when the printing system 800 dispenses the one or more materials when the region of interest 802 to be printed on is larger than the printing system 800 can print without moving the printing head 808. For example, the printing system 800 can be configured to print a skin graft in a long wound in a subject or the printing system 800 can be configured to print a large three-dimensional object on a workspace. However, in such embodiments, the printing system 800 can maintain the printing head 808 substantially stationary while printing on a segment of the region of interest 802. After printing on a segment of the region of interest 802, the printing head 808 can be moved to another segment of the region of interest 802 and the deposition/printing process is repeated.

In an embodiment, the printing system 800 can include a plurality of printing heads 808. Each of the plurality of printing heads 808 can include one or more elongated members 842 operably coupled to and extending from the printing head 808. At least some of the plurality of printing heads 808 can be rigidly or semi-rigidly coupled together. In an embodiment, at least some of the plurality of printing heads 808 can move independently from each other 808. For example, each of the plurality of printing heads 808 can include a corresponding motor configured to move a corresponding printing head 808. In an embodiment, different portions of the support structure 828 can be attached to each of the plurality of printing heads 808. As such, when each of the different portions of the support structure 828 shifts, twists, or otherwise moves, the attached printing head 808 correspondingly moves. At least some of the plurality of printing heads 808 can be substantially similar or substantially different from each other. Some of the one or more printing heads 808 can be configured to dispense different materials, print different objects substantially simultaneously, or print different portions of the object substantially simultaneously.

The printing head 808 can support the one or more elongated members 842 a distance from the region of interest 802. The one or more elongated members 842 can be coupled to the one or more dispense elements 844 and configured to support the one or more dispense elements 844 adjacent to or proximate to the region of interest 802. The printing system 800 can include a plurality of the one or more elongated members 842. For example, the printing system 800 can include less than 10 elongated members, such as about 1 to about 3 elongated members, about 3 to about 5 elongated members, or about 5 to about 10 elongated members. In an embodiment, the printing system 800 can include more than 10 elongated members, such as 15 or more elongated members. The number of one or more elongated members 842 included in the printing system 800 can depend on the specific printing operation. Increasing the number of elongated members can allow for the printing system 800 to print objects formed of a plurality of materials, form more complex shapes, or print the object faster.

The one or more elongated members 842 can include or be operably coupled to any actuator that is configured to controllably steer the one or more elongated members 842 (e.g., the one or more elongated members 842 are steerable actuators). In an embodiment, the one or more elongated members 842 can include a pneumatic actuator, a hydraulic actuator, a piezoelectric actuator, a shape memory material actuator, or an electroactive polymer actuator. For example, each of the one or more elongated members 842 can include a single actuator, an actuator coupled to another actuator, any combination of actuators, or any number of actuators. The one or more elongated members 842 can be steerable in one or more directions. The one or more elongated members 842 enables the printing system 800 to controllably steer the one or more dispense elements 844 to selectively position the one or more dispense elements 844 adjacent to or proximate a specific segment of the region of interest 802.

The one or more elongated members 842 can be controllably steered responsive to a direction (e.g., a signal) from the control electrical circuitry 814. In an embodiment, the control electrical circuitry 814 can directly communicate with the one or more elongated members 842. For example, the control electrical circuitry 814 can communicate a direction to a compressor that causes the compressor to extend or retract a piston rod of a pneumatic actuator. In an embodiment, the direction can cause a device, such as a capacitor, to induce a specific electric field that causes an electroactive polymer actuator to move responsive to the electric field. In an embodiment, the control electrical circuitry 814 can indirectly communicate with the one or more elongated members 842. For example, the control electrical circuitry 814 can communicate a direction to the printing head 808, which can relay the direction to the one or more elongated members 842.

The one or more elongated members 842 can be configured to be controllably steered independently of each other. For example, each of the one or more elongated members 842 can be configured to receive one or more directions from the control electrical circuitry 814 containing instructions for the specific elongated member. The specific instructions direct each of the one or more elongated members 842 to actuate differently. Additionally, each of the one or more elongated members 842 can be different. For example, the one or more elongated members 842 can include a first elongated member that moves in the z-direction and a second elongated member moves in the x-direction or y-direction. As such, each of the two elongated members can be independently steerable. However, in an embodiment, at least some of the one or more elongated members 842 cannot move independently. For example, some of the one or more elongated members 842 can be rigidly or semi-rigidly attached or can receive the same direction from the control electrical circuitry 814.

In an embodiment, the one or more elongated members 842 can be configured to operate in one or more different environments. For example, the one or more elongated members 842 can be configured to operate in an in vivo environment. In such an embodiment, at least the exterior of the one or more elongated members can be formed of a biocompatible material. Additionally, the one or more elongated members can be configured to operate in a liquid since the in vivo environment can include blood or interstitial fluid. In an embodiment, the one or more elongated members 842 can be configured to operate in an ex vivo or in vitro environment. In an embodiment, the one or more elongated members 842 can be configured to print one or more materials in an adverse environment, such as in an oxidizing atmosphere. In such an embodiment, the one or more elongated members 842 can be formed of an oxidizing-resistant material.

In an embodiment, at least one of the one or more elongated members 842 or the printing head 808 can be configured to enable the one or more elongated members 842 to be removable and interchangeable. Such a configuration enables the printing system 800 to operate in a number of environments or dispense a number of materials without replacing the printing head 808. Similarly, such a configuration can allow damaged or less effective elongated members to be replaced. For example, a shape memory material actuator can suffer from “amnesia” (e.g., begins to lose its shape memory changing effect) and may need to be replaced. In an embodiment, the printing head 808 includes an interface that allows the one or more elongated members 842 to be reversibly attached or the printing head 808 can be configured to reversibly receive a cartridge that includes at least one of the one or more elongated members 842.

As previously discussed, the printing system 800 further includes the one or more dispense elements 844 coupled to the one or more elongated members 842. For example, each of the one or more elongated members 842 can be coupled to a corresponding one of the one or more dispense elements 844. The one or more dispense elements 844 can receive one or more materials via one or more inlets 819 or store the one or more materials in a material reservoir included therein. The one or more dispense elements 844 can controllably dispense the one or more materials through the at least one dispense aperture 846 thereof onto the region of interest 802 from a position adjacent to or proximate to a specific segment of the region of interest 802. The one or more elongated members 842 can selectively position the one or more dispense elements 844 adjacent to or proximate to a specific segment of the region of interest 802. The one or more dispense elements 844 can controllably dispense the one or more materials responsive to the one or more elongated members 842 controllably steering the one or more dispense elements and direction from the control electrical circuitry 814. The one or more dispense elements 844 can be configured to be reversibly attached to the one or more elongated members 842, thereby enabling the one or more dispense elements 844 to be replaced.

As discussed above, each of the one or more dispense elements 844 includes the at least one dispense aperture 846 that is configured to dispense the one or more materials therethrough. The one or more dispense elements 844 can include one or more microconduits, one or more nozzles, or one or more tubes, each of which includes the at least one aperture 846. The one or more dispense elements 844 can dispense the one or more materials using any suitable dispensing method, such as spraying the one or more materials, forming droplets of the one or more materials, or extruding the one or more materials. In an embodiment, the one or more dispense elements 844 can include disk having at least one dispense aperture 846 therein. The size of the at least one dispense aperture 846 can be configured to dispense the one or more materials at a specific rate or dispense a material having a certain viscosity. Additionally, the shape of the at least one dispense aperture 846 can allow the one or more dispense elements 844 to, for example, extrude the one or more materials with a specific cross-sectional shape. The disk can further include a material configured to dispense the one or more materials. For example, the disk can be formed of a biocompatible material (e.g. stainless steel, titanium, porcelain, aluminum, or zirconium). In an embodiment, the disk can be formed of a material having a high operating temperature, thereby allowing the disk to dispense a heated material. The disk can further include a relatively stiff material that can form a droplet having a slower exit velocity (e.g., the velocity of the droplet after separating from the at least one aperture 846) than a relatively more flexible material. Additionally, the disk can include a relatively hard material, thereby allowing the disk to dispense an abrasive material, such as hard metals, ceramics, or nanoparticles.

The one or more dispense elements 844 can be configured to be heated during use. The one or more materials may need to be heated, for example, if the one or more materials are solid at room temperature, are relatively viscous at room temperature, or require heat to be effective (e.g., a material that is thermally stable at high temperatures). The one or more dispense elements 844 can include a heat source attached to, enclosed in, or incorporated into the one or more dispense elements 844. For example, electrical power can pass through portions of the one or more dispense elements 844 to provide joule heating to the one or materials to be dispensed. The one or more dispense elements 844 can include a thermal shield (not shown) that prevents or minimizes the amount of heat dissipated from the heat source to the region of interest 802.

In an embodiment, the one or more dispense elements 844 can receive the one or more materials from the one or more inlets 819 or one or more material reservoirs located therein. For example, the one or more dispense elements 844 can include only one inlet 819 or one material reservoir. In such an embodiment, the one or more dispense elements 844 can receive a single material (e.g., a mixed material). The at least one dispense aperture 846 of the one or more dispense elements 844 can include two or more apertures to dispense the single material. Two or more apertures can allow the one or more dispense elements 844 to dispense the single material or the plurality of mixed materials at a greater rate, at multiple locations substantially simultaneously, or using a different dispense method. In an embodiment, the one or more dispense elements 844 can receive one or more materials from a plurality of inlets 819, a plurality of material reservoirs, or at least one inlet 819 and at least one material reservoir. As such, each or some of the one or more dispense elements 844 can be configured to receive two or more different materials. The one or more dispense elements 844 can include at least one dispense aperture 846, such as a plurality of apertures 810, in which each of the plurality of apertures 810 can dispense different materials. In an embodiment, the one or more dispense elements 844 can include a single aperture that is configured to dispense the two or more materials substantially simultaneously or switch between the two or more materials such that the single aperture only dispenses one material at a time.

The one or more dispense elements 844 can be configured to operate in a number of environments. In an embodiment where the printing system 800 is configured to print a biological material, the one or more dispense elements 844 can be configured to operate in an in vivo, an ex vivo, or an in vitro environment. As such, the one or more dispense elements 844 can include a biocompatible material. The one or more dispense elements 844 can be configured to operate in a liquid. Additionally, the one or more dispense elements 844 can be configured to substantially minimize the backflow of the liquid into the one or more dispense elements 844. In an embodiment, the printing system 800 can be configured to operate in an oxidizing environment. As such, the one or more dispense elements 844 can include an oxidizing-resistant material such as around the at least one aperture 846.

The one or more dispense elements 844 can include a device that controllably dispenses the one or more materials. In an embodiment, the one or more dispense elements 844 can include a pneumatic-actuated or an electrically actuated valve that is configured to be open or closed. The valve can be opened or closed responsive to a direction received from the control electrical circuitry 814. For example, the control electrical circuitry 814 can direct the valve to limit the amount or rate that the one or more materials that are dispensed from the one or more dispense elements 844. In an embodiment, the one or more dispense elements 844 can include a pump (e.g., a micropump) that dispenses the one or more materials. In an embodiment, the one or more dispense elements 844 can include a piezoelectric material that is configured to create pressure gradients that dispense the one or more materials.

The one or more elongated members 842 can include an interfacial surface 807 that is remote from the printing head 808 and at least one lateral surface 809 extending from the printing head 808 to the interfacial surface 807. In the illustrated embodiment, the one or more dispense elements 844 are coupled to the interfacial surface 807 of the one or more elongated members 842. However, the one or more dispense elements 844 can be coupled to any location on the one or more elongated members 842. For example, at least one of one or more dispense elements 844 can be coupled to the at least one lateral surface 809 of one or more elongated members 842. In an embodiment, the one or more dispense elements 844 can be incorporated into the one or more elongated members 842 such that the one or more dispense elements 844 are not distinct from and integral with the one or more elongated members 842.

The one or more dispense elements 844 can dispense the one or more materials at a number of angles. In an embodiment, the one or more dispense elements 844 can dispense the one or more materials at an angle that is substantially perpendicular to the region of interest 802. In an embodiment, the one or more dispense elements 844 can dispense the one or more materials at any angle relative to the region of interest 802. For example, the one or more dispense elements 844 can dispense the one or more materials onto a substantially nonplanar region of interest 802. In an embodiment, the angles at which the one or more dispense elements 844 dispense the one or more materials can change as the one or more elongated members 842 are controllably actuated and the one or more dispense elements 844 are selectively steered at a selected angle. In an embodiment, the one or more dispense elements 844 can dispense the one or more materials at an angle that is substantially parallel or substantially non-parallel to a longitudinal axis of the one or more elongated members 842. In an embodiment, the one or more dispense elements 844 can include two or more apertures that are configured to dispense the one or more materials at different angles relative to each other.

The printing system 800 further includes one or more material reservoirs 848 configured to store the one or more materials. The one or more material reservoirs 848 are in fluid communication with the one or more dispense elements 844 and are configured to supply the one or more materials to the one or more dispense elements 844. For example, the one or more material reservoirs 848 can include a pump or similar device that moves or flows the one or more materials to the one or more dispense elements 844. The one or more material reservoirs 848 can be replaceable, refillable, or reusable. Additionally, the one or more material reservoirs can include one or more compartments that can be filled with the same or different materials.

The one or more material reservoirs 848 can store any of a variety of or combinations of materials. The one or more material reservoirs 848 can store non-organic materials, such as metallic materials, ceramic materials, polymeric materials, other non-organic materials. For example, the one or more material reservoirs 848 can store a functional ink, such as a conductive ink. The one or more material reservoirs 848 can store materials for use in forming biocompatible structures, microstructures, nanostructures, scaffolds, nanoscaffolds, or the like. For example, such materials include natural or synthetic polymers, polymer fibers, microfibers, nanofibers, hydrogels, thermo-responsive polymers, Matrigel™ or the like. Non-limiting examples of materials used as scaffolds in tissue engineering are described by Bajaj et al., in Annu Rev Biomed Eng. 2014 Jul. 11; 16: 247-276 (3D Biofabrication Strategies for Tissue Engineering and Regenerative Medicine), which is incorporated herein, in its entirety, by this reference. The one or more material reservoirs 848 can store organic or biological materials, such as bioinks, cells, transfected cells, peptides, proteins, carbohydrates, lipids or tissue. The biological materials can include a biomimetic. The one or more material reservoirs 848 can store materials including encapsulation materials in which materials are encapsulated, such as natural or synthetic polymers, phase change polymers, polymersomes, liposomes, or the like. The encapsulating materials can include materials stored or encapsulated therein, such as organic or nonorganic materials, compounds (e.g. medicament), or any biological material.

The biological materials used herein can include materials used to form implants, grafts, or tissues (e.g., vascularized or micro-vasculature tissue). For example, the biological material can include one or more cells including, but are not limited to, stem cells, meschenchymal cells, fibroblasts, adipocytes, pre-adipocytes, hepatocytes, osteocytes, myocytes, cardiomyocytes, smooth muscle cells, endothelial cells, epithelial cells, keratinocytes, primary cells, cultured cells, or the like. For example, the biological material can include one or more proteins including, but are not limited to, collagen, elastin, hyaluronan, fibrin, or laminin; a growth-promoting agent or any growth factor; a cytokine or chemokine; or any immune-related protein. For example, the biological material can include one or more lipids including a phospholipid, sphingolipid, or proteolipid. For example, the biological material can include one or more carbohydrates including any oligosaccharide. The one or more carbohydrates can be associated with one or more peptides, one or more proteins or one or more lipids, such as a proteoglycan, glycoprotein, glycosaminoglycan, glycolipid, or the like. For example, the one or more biomaterials can alone or together arise from, include, or form part or all of an extracellular matrix. For example, the one or more biomaterials can include a tissue, such as a tissue sphere or tissue strand, which can be included in a bioink. The one or more material reservoirs 848 can store one or more support materials that facilitate printing the one or more materials onto the region of interest 802. When the one or more materials are biological, the one or more support materials can include an inflammatory suppressant, substances that facilitate the regrowth of tissues (e.g., neurotrophin, adenosine triphosphate, vascular endothelial growth factor, or other growth factors), pain suppressant, suppressors of autoimmune factors, tissue survival promoters (e.g., anti-beta amyloid antibodies when printing neural tissue), or other similar materials. In an embodiment, the one or more support materials can include a binder, a material that supports portions of the printed object and can be removed from the object (e.g., a polymer that is burned off or vaporizes while the object densifies), an emulsifier, or a coating. For example, the one or more material reservoirs 848 can store one or more materials used to form capillaries and vascular endothelial growth factor.

In an embodiment, some of the one or more materials can be configured to operate in conjunction with each other. For example, at least one of the one or more materials can include a polymer hydrogel material configured to form a three-dimensional biocompatible scaffold when printed in the body. The biocompatible material can be stored in the one or more material reservoirs 848 and printed on the region of interest 802 by dispensing the material using the one or more dispense elements 844 that are controllably steered using the one or more elongated members 842. The printed biocompatible scaffold can include a porous structure. A bioink containing cells, proteins, or glycosaminoglycans may be printed onto the three-dimensional biocompatible scaffold, while the scaffold is being printed. Such a printed object can be tissue graft for repairing a tissue in vivo.

The one or more material reservoirs 848 can be formed of a material configured to stably store the one or more materials. In an embodiment, the one or more material reservoirs 848 containing one or more biological materials can be formed of a biocompatible material. In an embodiment, when the one or more materials include an abrasive material such as a ceramic material, the one or more material reservoirs 848 can be formed of materials relatively harder than the ceramic. Additionally, the one or more material reservoirs 848 can include a heat source configured to heat the one or more materials.

The one or more material reservoirs 848 can be fluidly coupled to the one or more dispense elements 844 via one or more conduits 836. The one or more conduit 836 can be coupled to an outlet 849 of the one or more material reservoirs 848 and the inlet 819 of the one or more dispense elements 844. In an embodiment, the one or more conduits 836 can include a tube. In an embodiment, the one or more conduit 836 can include a protective enclosure that protects the one or more materials, while the one or more materials move therethrough. For example, the one or more materials can include a ribbon containing the material to be printed on the region of interest 802 and the one or more conduit 836 can include a protective enclosure that isolates the ribbon from the environment. Additionally, the one or more conduits 836 can include one or more components to facilitate the flow of the one or more materials therethrough, such as a heat source or a pump.

The one or more conduits 836 can be remote from, attached to, enclosed by, or incorporated into the one or more elongated members 842. In an embodiment, the one or more conduit 836 can be attached to an exterior of the one or more elongated members 842 using a clamp or other suitable attachment. In an embodiment, the one or more elongated members 842 are at least partially hollow so that the one or more conduit 836 to be positioned within, defined by, or incorporated into the hollow portions of the one or more elongated members 842. For example, the one or more elongated members 842 can be formed of a hollow electroactive polymer.

The one or more material reservoirs 848 can be configured to move the one or more materials from the one or more material reservoirs 848 to the one or more dispense elements 844. For example, the one or more material reservoirs 848 can include a component, such as a pump, that moves or flows the one or more materials from the one or more material reservoirs 848. The component can operate responsive to a direction received from the control electrical circuitry 814. In an embodiment, the one or more material reservoirs 848 can be formed of a collapsible bag that exerts a compressive pressure on the one or more materials contained therein. Alternatively, the one or more material reservoirs 848 can use gravity or another component of the printing system 800 (e.g., the one or more dispense elements 844 can include a pump) to move the one or more materials. Similarly, the one or more material reservoirs 848 can include a valve that can prevent the one or more materials from leaving the one or more material reservoirs 848.

In the illustrated embodiment, the one or more material reservoirs 848 are positioned in and at least partially enclosed by the printing head 808. However, the one or more material reservoirs 848 can be positioned in other locations of the printing system 800. For example, at least some of the one or more material reservoirs 848 can be attached to an exterior of the printing head 808. In an embodiment, at least some of the one or more material reservoirs 848 can be positioned in or attached to the one or more elongated members 842 or the one or more dispense elements 844. In an embodiment, at least some of the one or more material reservoirs can include two or more material reservoirs coupled together (e.g., the primary material reservoir 1064 and the secondary material reservoir 1065 of FIG. 10B). In an embodiment, at least some of the one or more material reservoirs 848 can be remote from the printing head 808, the one or more elongated members 842, and the one or more dispense elements 844.

The controller 812 can be communicably coupled, either directly or indirectly, to at least one of the printing head 808, the support structure 828, the one or more elongated members 842, the one or more dispense elements 844, or the one or more material reservoirs 848. For example, FIG. 8 illustrates that the controller 812 is communicably coupled directly to the printing head 808. The controller 812 can then be communicably coupled indirectly to other components of the printing system 800 through the printing head 808. The controller 812 can be communicably coupled through a wired or wireless (e.g., Bluetooth, Wi-Fi) connection. The controller 812 can be remote from at least one the printing head 808, the one or more elongated members 842, or the one or more dispense elements 844. In an embodiment, the controller 812 can at least partially be positioned within the printing head 808, the one or more elongated members 842, or the one or more dispense elements 844.

The controller 812 can include a user interface 856 that enables an individual to communicate with the printing system 800. The user interface 856 can include a display, mouse, keyboard, microphone, speaker, or any other device that enables an individual to communicate with the printing system 800. The user interface 856 can also include software that enables the user to communicate with the printing system 800 such as an operating system, operator controls or a process control. In an embodiment, the user interface 856 can enable an individual to input instructions or commands into the printing system 800. The commands can include build data (e.g., a CAD file), information about the one or more materials, information about one or more components of the printing system 800, instructions to execute a program, or instructions to cancel an operation. In an embodiment, the printing system 800 can send data to the user interface 856. The data can include information about the current status of the printing operation, the current status of the printing system 800, an error, or additional information. The user interface 856 can display the data.

The controller 812 can further include memory 858 storing operational instructions for operating the printing system 800. The memory 858 can include random access memory (RAM), read only memory (ROM), a hard drive, a disc (e.g., blue-ray, DVD, or compact disc), flash memory, other types of memory electrical circuitry, or other suitable memory. The instructions stored on the memory 858 can include a CAD file, a program configured to operate the printing system, information about the printing system 800 and the components thereof, information gathered by the printing system or additional information. The controller 812 can further include a processor 860 configured to direct certain operations of the printing system 800 according to the instructions contained in the memory.

As previously discussed, the controller 812 includes the control electrical circuitry 814. The control electrical circuitry 814 can be integrally formed with the memory 858 and the processor 860 of the controller 812. Alternatively, the control electrical circuitry 814 can be separate from the memory 858 and the processor 860 of the controller 812. In such an embodiment, the control electrical circuitry 814 can include its own memory and a processor.

In an embodiment, a user can load a CAD file of an object to be printed into the memory 858 via the user interface 856. The CAD file and any additional instructions can be stored in the memory 858. The region of interest 802 or the printing system 800 can be positioned so that the printing system 800 is proximate to the region of interest 802, and the printing system 800 can move the printing head 808 to the second position. The individual can instruct the printing system 800 to execute the printing operation through the user interface 856.

Upon receiving the instructions from the user interface 856, the control electrical circuitry 814 can communicate a direction to at least one of the one or more elongated members 842. The one or more elongated members 842 can actuate responsive to the direction, thereby selectively and controllably steering the one or more dispense elements 844. The one or more elongated members 842 can position the one or more dispense elements 844 adjacent to or proximate to a specific segment of the region of interest 802. The control electrical circuitry 814 can also communicate a direction instructing at least one of the one or more dispense elements 844, the one or more material reservoirs 848, or the one or more conduit 836 to prepare to disperse the one or more materials. The control electrical circuitry 814 can also communicate a direction to disperse the one or more materials onto the specific segment of the region of interest 802. For example, the direction to disperse the one or more materials can cause one or more valves to partially open or a pressure to be applied to the one or more materials. This method can be repeated until the three-dimensional object is partially or completely printed.

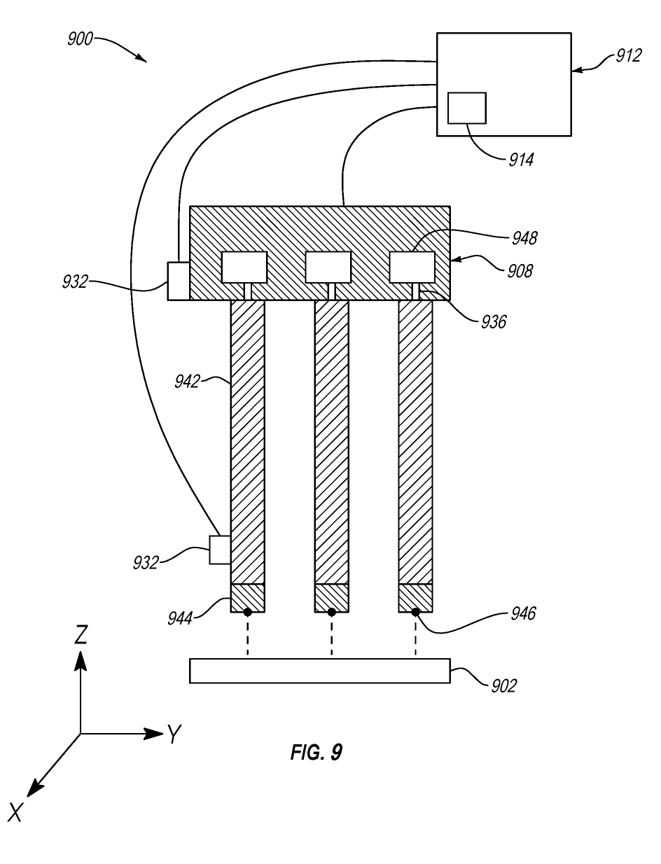

FIG. 9 is a schematic cross-sectional view of a printing system 900 including one or more sensors 932 according to an embodiment. Except as otherwise disclosed herein, the printing system 900 can be the same as or substantially similar to any of the printing systems disclosed herein. The printing system 900 can be configured to print a three-dimensional object on a region of interest 902. The printing system 900 includes a printing head 908 coupled to and configured to support one or more elongated members 942. Similarly, the one or more elongated members 942 can be coupled to one or more dispense elements 944. The one or more elongated members 942 can be controllably steered to position the one or more dispense elements 944 adjacent or proximate a specific segment of the region of interest 902. The one or more dispense elements 944 can controllably dispense one or more materials from at least one dispense aperture 946 onto the region of interest 902. Similarly, the printing system can include a controller 912. The controller 912 includes control electrical circuitry 914 configured to at least controllably steer the one or more elongated members 942 and controllably dispense the one or more materials from the one or more dispense elements 944.

In the illustrated embodiment, the printing system 900 includes one or more material reservoirs 948 positioned in the printing head 908. The one or more material reservoirs are coupled to the one or more dispense elements 944 through one or more conduits 936. The one or more conduits 936 are illustrated to be partially located within, defined by, or incorporated into the one or more elongated members 942. As such, the one or more elongated members 942 can be at least partially hollow. For example, the one or more elongated members 942 can be at least partially formed using a shape memory material actuator, an electroactive polymer actuator, or another suitable actuator.

The printing system 900 can further include one or more sensors 932 configured to detect at least one characteristic of the region of interest 902 or the printing system 900. Characteristics of the region of interest 902 sensed by the one or more sensors 932 can include the pressure, temperature, hydration, chemistry, surface contour, boundary conditions, or other features of the region of interest 902. Characteristics of the printing system 900 that can be sensed by the one or more sensors 932 can include the position of a component of the printing system 900, as a position or movement of the printing head 908 or the one or more dispense elements 944; the flow of at least one material, temperature of the printing system 900, or material to be dispensed or that has been dispensed; or other characteristics of the printing system 900. As such, the one or more sensors 932 can include a temperature sensor configured to sense temperature of the region of interest 902, a pressure sensor configured to sense pressure of the region of interest 902, a hydration sensor configured to sense moisture of the region of interest 902, a chemical sensor (e.g., an oxygen sensor or other sensor configured to sense one or more chemical elements or molecules on, in, or near the region of interest 902), a biosensor configured to sense biological matter of the region of interest 902, an optical sensor, an infrared sensor, other electromagnetic sensors (e.g., radar), a position sensor configured to sense position of the one or more dispense elements 944 or the printing head 908, an accelerometer configured to sense acceleration of the one or more dispense elements 944 or the printing head 908, a flow gauge configured to sense flow of the one or more materials dispensed from the one or more dispense elements 944, a depth sensor (e.g., depth gauge) configured to sense depth of the region of interest 902 in a subject, an acoustic sensor configured to sense amount or volume of the one or more materials dispensed onto the region of interest 902, a tilt sensor configured to sense tilting of the one or more dispense elements 944 or the printing head 908, or other suitable sensors. Some sensors can require a stimulus source that emits a stimulus the sensor detects. For example, a chemical sensor mounted to a printing system 900 can include a light source that scatters or excites chemical elements or molecules present on or near the region of interest 902 to identify the chemical elements or molecules via spectroscopy.

In an embodiment, the one or more sensors 932 can be communicably coupled to the controller 912. The controller 912 can communicate a direction directly or indirectly to at least one sensor 932 to detect a characteristic. Alternatively, the at least one sensor 932 can automatically detect the characteristic without receiving the direction. The at least one sensor 932 can detect the characteristic and send information related to the detected characteristic to the controller 912. The controller 912 can use the information to operate the printing system 900. For example, the controller 912 can request the one or more sensors 932 to detect the position and relative movement of the one or more elongated members 942 using a position sensor and an accelerometer. The control electrical circuitry 914 can use the detected information from the one or more sensors 932 to controllably steer or calibrate the one or more elongated members 942 and dispensing of the one or more materials from the one or more dispense elements 944.

In an embodiment, each of the one or more sensors 932 can communicate with each other and communicate information detected to each other. In an embodiment, two or more sensors 932 can act in tandem or in parallel. The sensing by the one or more sensors 932 can occur responsive to the information received from the other sensors 932 or responsive to direction from the control electrical circuitry 914.

In an embodiment, the one or more sensors 932 can be attached to different components of the printing system 900. For instance, a sensor can be positioned on the printing head 908, the one or more elongated members 942, or the one or more dispense elements 944 to be proximate the region of interest 902. The location of the one or more sensors 932 can be configured to not substantially interfere with or influence the operation of the one or more dispense elements 944 or the one or more elongated members 942. In an embodiment, at least one of the one or more sensors 932 can be attached to an elongated flexible member. The elongated flexible member can include a flexible dispense element such as a tube that extends from at least one of the one or more elongated members 942. Alternatively, the elongated flexible member can include a flexible actuator, such as an electroactive polymer actuator, or any flexible component that has at least one sensor attached thereto.

In an embodiment, at least one of the one or more sensors 932 can be replaced with a device configured to facilitate the printing process. Alternatively, the printing system 900 can include such a device configured to facilitate the printing process. For example, the printing system 900 can be configured to print an object using a light-activated resin. After printing the light-activated resin onto the region of interest 902, the device can illuminated the printed light-activated resin with a light source that exhibits a specific wavelength configured to quickly harden the light-activated resin. The device can be configured to print the light-activated resin in either a wet or dry environment.

FIGS. 10A-10D are schematic cross-sectional views of printing systems utilizing different elongated members, according to various embodiments. The different elongated members can be used with any of the embodiments illustrated and described in connection with the printing systems disclosed herein. Although only a single elongated member is shown in FIGS. 10A-10D, it should be understood that printing systems incorporating the elongated members shown in FIGS. 10A-10D can include a plurality of elongated members as disclosed in any of the embodiments illustrated and described herein. Further, although dispense elements are coupled to the elongated members, it should be understood that the elongated members can include flushing elements coupled thereto or form part of a removal device. The elongated members can include a pneumatic actuator, a hydraulic actuator, a piezoelectric actuator, a shape memory material actuator, or an electroactive polymer actuator. Some or all of the foregoing actuators can be macro-scale actuators, microactuators, nanoactuators. Examples of nanoactuators include, but are not limited to, magnetic bead nanoactuators, ferroelectric switching nanoactuators, biologic-driven nanoactuators, biomemetic-driven nanoactuators, or magnetic bead nanoactuators.

FIG. 10A illustrates a printing system 1000A including an elongated member 1042A that is coupled to and extending from a printing head 1008. The elongated member 1042A can be controllably steered and coupled to a dispense element 1044 that can controllably dispense one or more materials from at least one dispense aperture 1046 onto a region of interest 1002. The printing system 1000A can further include a controller 1012 configured to controllably steer the elongated member 1042A and controllably dispense the one or more materials from the dispense element 1044. As such, the printing system 1000A can be configured to print a three-dimensional object on the region of interest 1002.

In an embodiment, the elongated member 1042A includes a pneumatic or hydraulic actuator that controllably steers the dispense element 1044 in the z-direction. In particular, the elongated member 1042A can include a pneumatic cylinder or a hydraulic cylinder. As such, the elongated member 1042A can include a cylinder barrel 1051 configured to hold cylinder pressure. The cylinder barrel 1051 can include a cap (not shown) and head (not shown) that prevents the pressure from leaking from the cylinder barrel 1051. The elongated member can further include a piston rod 1053. The cylinder barrel 1051 can include a first pressurized zone that includes a pressured fluid and a second pressurized zone that does not contain a pressurized fluid. The first and second zones may be separated by a piston that is attached to the piston rod 1053. The cylinder barrel 1051 can further include an inlet 1055 configured to allow the pressurized fluid to enter the first pressurized zone of the cylinder barrel 1051. Increasing the pressure of the first pressurized zone can cause the piston rod 1053 to extend and decreasing the pressure of the first pressurized zone can cause the piston rod 1053 to retract. The elongated member 1042A can further include a pump or a compressor 1057 configured to move or displace a pressured liquid (e.g., a non-compressible fluid) or gas (e.g., a compressible fluid), respectively, into the first pressurized zone of the cylinder barrel 1051. When the pump or compressor 1057 is remote from the inlet 1055, the pump or compressor 1057 can be connected to the inlet 1055 via an actuator conduit 1036. The pump or compressor 1057 can increase and decrease the pressure in the first pressure zone responsive to a direction received from the control electrical circuitry 1014. The pump or compressor 1057 can be configured to store some of the fluid therein or the printing system 1000A may include a material reservoir configured to store some of the fluid. The dispense element 1044 can be attached to the piston rod 1053.

Although the described elongated member 1042A includes a common hydraulic or pneumatic cylinder, the elongated member 1042A can include any hydraulic or pneumatic cylinder. For example, the elongated member 1042A can include a single action cylinder, a double action cylinder, a spring return single action cylinder, or a ram type single action cylinder. Similarly, the elongated member 1042A can include a telescopic cylinder, a plunger cylinder, a differential cylinder, or a position sensing “smart” cylinder. The telescopic cylinder can be used when the size of the elongated member 1042A can be limited. For example, the elongated member 1042A can include a second elongated member attached to the end thereof configured to be steerable in the x-direction or the y-direction. Due to the size limitations, in an embodiment, the second elongated member can be a telescopic cylinder actuator. In an embodiment, the piston rod 1053 can be actuated using a piezoelectric motor using stepping actions. In an embodiment, the elongated member 1042A can be configured to rotate the dispense element 1044 using a rack and pinion.

In an embodiment, the printing system 1000A includes a material reservoir 1048 that is coupled to the dispense element 1044 through a conduit 1036. Some hydraulic or pneumatic cylinders can prevent the conduit 1036 from being at least partially enclosed in the elongated member 1042A. As such, the conduit 1036 can extend from the material reservoir 1048 to the dispense element 1044, while being remote from the elongated member 1042A. However, in an embodiment, the conduit 1036 is attached to the elongated member 1042A or the elongated member can be configured to partially receive the conduit 1036. For example, the cylinder barrel can include a component attached thereto that is configured to at least partially enclose the conduit 1036. In an embodiment, the conduit 1036 may be configured to be retractable or flexible to prevent the conduit 1036 from dangling.

FIG. 10B illustrates a printing system 1000B including an elongated member 1042B being actuated in the y-direction that is coupled to and extending from a printing head 1008. The elongated member 1042B can be controllably steered and coupled to a dispense element 1044. The dispense element 1044 can be configured to controllably dispense one or more materials from at least one dispense aperture 1046 therein onto a region of interest 1002. The printing system 1000B further includes a controller 1012 configured to controllably steer the elongated member 1042B and controllably dispense the one or more materials from the dispense element 1044. As such, the printing system 1000B can be configured to print a three-dimensional object on the region of interest 1002.

The elongated member 1042B includes a different hydraulic or pneumatic actuator than the elongated member 1042A illustrated in FIG. 10A. For example, the elongated member 1042B can be a micro-hydraulic actuator or a macro-scale hydraulic or pneumatic actuator. The elongated member 1042B can include a flexible material 1061. For example, the flexible material 1061 can include or be formed from silicone, polyethylene, or polyurethane. The elongated member 1042B further includes an inflatable bubble 1063 or other inflatable object attached to the exterior surface of the flexible material 1061. The inflatable bubble 1063 can be configured to be inflated with a pressurized fluid and should attach to the flexible material 1061 in a manner that prevents the pressurized fluid from substantially leaking therefrom. Alternatively, the inflatable bubble 1063 may be at least partially positioned in the flexible material 1061. A pressurized fluid can be used to inflate the inflatable bubble 1063 and can be provided by a pump or compressor 1057. The pump or compressor 1057 can be coupled to the inflatable bubble 1063 using an actuator conduit 1036. The actuator conduit 1059 can be located remote from the flexible material 1061 can be attached to or partially enclosed in the flexible material 1061.

The elongated member 1042B can be controllably steered by the control electrical circuitry 1014. In an embodiment, the pump or compressor 1057 can receive a direction from the control electrical circuitry 1014 that can directs the pump or compressor 1057 to provide a pressurized fluid (e.g., a liquid or gas such as environmental air) into the inflatable bubble 1063. The pressurized fluid can cause the inflatable bubble 1063 to inflate which, in turn, can cause the flexible material 1061 to bend in a region proximate the inflatable bubble 1063. Responsive to another direction received from the control electrical circuitry 1014, the pump or compressor 1057 can remove the pressurize fluid from the inflatable bubble 1063, thereby deflating the inflatable bubble 1063 and the returning the flexible material 1061 to its resting position. In an embodiment, the pressurized fluid can be removed from the inflatable bubble using a valve or other means. The fluid used to inflate the inflatable bubble 1063 can be stored is a material reservoir or in a compartment of the pump or compressor 1057.

In an embodiment, the elongated member 1042B can include a plurality of collapsible bubbles 1063 attached to an exterior surface of the flexible material 1061. In an embodiment, the plurality of collapsible bubbles 1063 allows the elongated member 1042B to exhibit more complex movement. In such an embodiment, the printing system 1000B can include one or more pumps or compressors 1057. Each of the one or more pumps or compressors 1057 can be coupled to one or more of the plurality of collapsible bubbles 1063 and can selectively supply a pressurized fluid to one or more of the plurality of collapsible bubbles 1063 using a valve or another suitable system.

In an embodiment, the flexible material 1061 can include an electroactive polymer or a shape memory material. For example, the flexible material 1061 can include Nitinol, a shape memory material. The inflatable bubble 1063 can be used move the flexible material 1061 in a direction that the flexible material's 1061 “learned” shape (e.g., the shape the flexible material 1061 forms when heated or cooled) cannot accommodate, or assist the flexible material 1061 move once the flexible material 1061 exhibits “amnesia” (e.g., the flexible material 1061 loses its memory effect after being deformed multiple times).

The printing system 1000B can also include a primary material reservoir 1064 and a secondary material reservoir 1065. The secondary material reservoir 1065 can be positioned in the dispense element 1044. The primary material reservoir 1064 can be coupled to the secondary material reservoir 1065 using a conduit 1036 that is at least partially located within, defined by, or incorporated into the hollow flexible material 1061. The secondary material reservoir 1065 can provide a source of the one or more materials that is more proximate the dispense element 1044 than the primary material reservoir 1064.

FIG. 10C illustrates a printing system 1000C including an elongated member 1042C being actuated in the y-direction that is coupled to and extending from a printing head 1008. The elongated member 1042C can be controllably steered and configured to controllably dispense one or more materials onto a region of interest 1002. The printing system 1000C can further include a controller 1012 configured to controllably steer the elongated member 1042C and controllably dispense the one or more materials. The controller 1012 can be at least partially located within the printing head 1008. As such, the printing system 1000C can be configured to print a three-dimensional object on the region of interest 1002.

In the illustrated embodiment, the elongated member 1042C includes a material that moves responsive to an applied energy. The applied energy can be provided by a direction from the control electrical circuitry 1014 or the direction can instruct another component to supply the applied energy source. In an embodiment, the elongated member 1042C includes an electroactive polymer actuator. The electroactive polymer can change shape or size when an electric field is applied thereby allowing the elongated member 1042C to be controllably steered. The electric field can be applied using any device or method capable of applying an electric field to the electroactive polymer, such as a capacitor, a magnet, a voltage source, or a coil of wires. For example, the elongated member 1042C can include an ionic polymer-metal composite. An electric field can be applied to the ionic polymer-metal composite by an electrode coating on the elongated member 1042C. The electric field causes the cations in the ionic polymer-metal composite to redistribute to balance the charge, thereby causing the negatively charged portions of the polymer to swell. Other examples of electroactive polymer actuators include dielectric electroactive polymers, ferroelectric polymers (e.g., polyvinylidene fluoride), electrostrictive graft polymers, liquid crystalline polymers, ionic electroactive polymers (e.g., electroactive polymer gels, ionic polymer-metal composites), non-ionic electroactive polymers, carbon nanotube actuators, conductive polymers (e.g., polypyrrole, polyaniline, poly(3,4-ethylenedioxythiophene), or poly(3,4-ethylenedioxypyrrole)) electrorheological fluids, electroactive polymer gels, or other electroactive polymers. A polymer can also that controllably deforms in a specific environment. For example, the elongated member 1042C can include a collagen filament that swells when exposed to an acid or alkali solution.

In an embodiment, the elongated member 1042C includes a piezoelectric actuator. For example, the piezoelectric actuator can be a microactuator. The piezoelectric actuator can controllably deform when an electric field is applied to the elongated member 1042C, thereby allowing the elongated member 1042C to be controllably steered. For example, the elongated member can include lead zirconate titanate crystals. The lead zirconate titanate crystals can deform by about 0.1% of its original dimension when an electrical field is applied thereto. As such, the elongated member 1042C including lead zirconate titanate can be used when a precision printing process is required. For example, the elongated member 1042C including lead zirconate titanate can have better that micrometer precision. Other piezoelectric materials can exhibit improved precision or larger deformations than lead zirconate titanate.

In an embodiment, the elongated member 1042C includes a shape memory material actuator. The shape memory material actuator can controllably deform when exposed to high or low temperatures. For example, the elongated member 1042C can include a shape memory material that exhibits a two way memory effect. As such, the elongated member 1042C can be configured to have “learned” a first memory effect (i.e. deformation) when exposed to high temperatures and a second memory effect when exposed to low temperatures. The elongated member 1042C can include one or more thermal devices configured to apply a high or low temperature to the elongated member 1042C. The one or more thermal devices can include a heat source or a high thermally conductive material that removes heat from the elongated member 1042C. The control electrical circuitry 1014 may use to one or more thermal devices to controllably steer the elongated member 1042C into its first memory effect or second memory effect. The movements of the elongated member 1042C can be further controlled by only exposing portions of the elongated member 1042C to the high or low temperature. Additionally, the rate of deformation of the elongated member 1042C can be controlled by the specific temperature applied to the elongated member 1042C. The shape memory material actuator can include a material exhibiting a one-way memory effect or a two-way memory effect. Also, the shape memory material can be formed of any shape memory alloy, such as copper-aluminum-nickel alloys, copper-zinc-aluminum alloys, nickel-titanium alloys, iron-manganese-silicon alloys, or other shape memory material.

In the illustrated embodiment, the elongated member 1042C includes a dispense element incorporated therein. For example, the elongated member 1042C can include at least one dispense aperture 1046 configured to dispense the one or more materials. Additionally, the elongated member 1042C can be substantially hollow. In such an embodiment, a conduit 1036 can extend between the material reservoir 1048 and aperture 1046.

FIG. 10D illustrates a printing system 1000D including an elongated member 1042D that includes two or more actuators in an embodiment. The elongated member 1042D can be coupled to and supported by the printing head 1008. Additionally, the elongated member 1042D can include a dispense element 1044 coupled thereto. The elongated member 1042D can be configured to controllably steer the dispense element 1044 responsive to direction from the controller 1012. The dispense element 1044 can be configured to controllably dispense one or more materials from at least one dispense aperture 1046 responsive from one or more directions from the controller 1012. The material reservoir 1048 can store the one or more materials and can be positioned within the dispense element 1044. Therefore, the printing system 1000D can be configured to print an object on a region of interest 1002.

In the illustrated embodiment, the elongated member 1042D includes a first actuator 1067 and a second actuator 1069. However, the elongated member 1042D can include more than two actuators. The elongated member 1042D formed using two or more actuators can increase a number of directions the elongated member can move (e.g., two or more directions or three directions (x-, y-, and z-directions), increase the complexity of the movement, improve the control of the printing system 1000D, improve the precision of the printing system 1000D (e.g., include a piezoelectric actuator), or improve the distance the elongated member 1042D can actuate.

In an embodiment, the first actuator 1067 can include an electroactive polymer actuator configured to move in the y-direction and the second actuator 1069 can include an electroactive polymer actuator configured to move in the x-direction. While the first actuator 1067 and the second actuator 1069 are described as being electroactive polymer actuators, that the first actuator 1067 and the second actuator 1069 can include any actuator. The first actuator 1067 and the second actuator 1069 can be attached together at an interface 1071. The interface 1071 can be configured to allow the second actuator 1069 to be interchangeable.

In an embodiment, electric fields can be applied to the first actuator 1067 and the second actuator 1069 responsive to direction from the control electrical circuitry 1014. A wire 1073 can supply electrical energy used to apply an electric field to the second actuator 1069 since the second actuator 1069 is remote from the printing head 1008. The first actuator 1067 and the second actuator 1069 can be controllably steered independently of each other. For example, a first direction from the control electrical circuitry 1014 can cause a first electric field to be applied to the first actuator 1067 thereby controllably steering the first actuator 1067. Similarly, a second direction from the control electrical circuitry 1014 can cause a second electric field to be applied to the second actuator 1069 thereby controllably steering the second actuator 1069. As such, the elongated member 1042D can be controllably steered in the x-direction, the y-direction, or the z-direction.

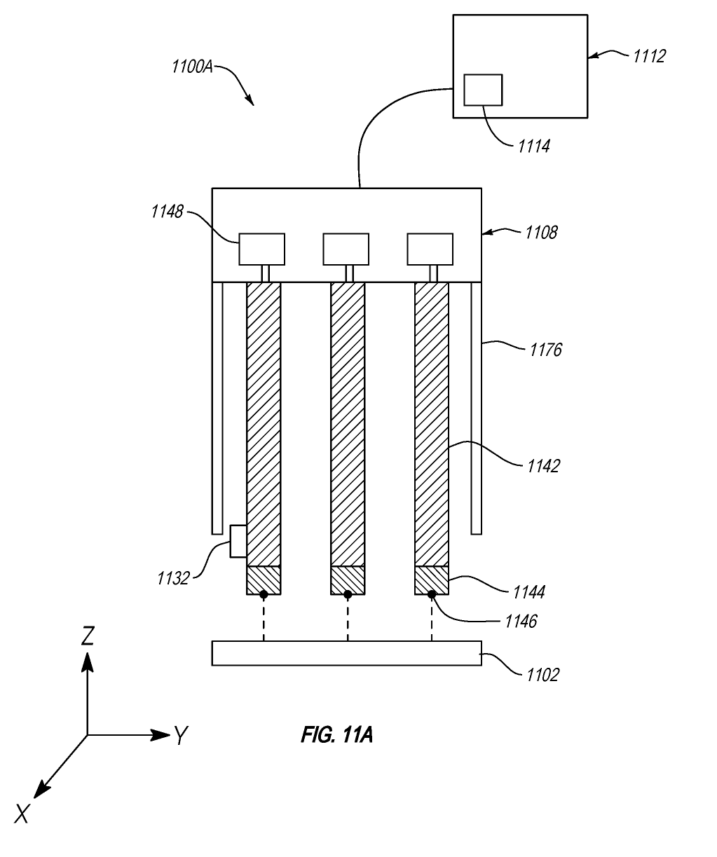

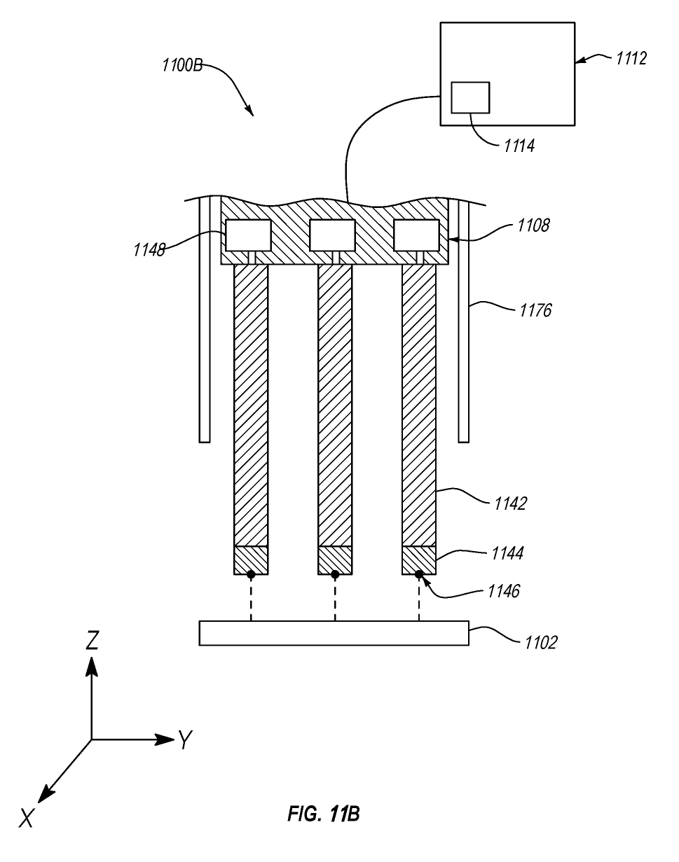

FIGS. 11A and 11B are schematic cross-sectional views of different printing systems 1100A and 1100B each of which is configured to be inserted into an internal region of a body of a subject (e.g. during laparoscopic surgery), according to an embodiment. Except as otherwise disclosed herein, the printing systems 1100A and 1100B can be the same as or substantially similar to any of the printing systems disclosed herein.

The printing systems 1100A and 1100B each include one or more elongated members 1142 coupled to and support by the printing head 1108. The one or more elongated members 1142 can be coupled to one or more dispense elements 1144. The one or more elongated members 1142 can be controllably steered and the one or more dispense elements 1144 can controllably dispense one or more materials responsive to a direction from the control electrical circuitry 1114 of the controller 1112. The controller 1112 can be located remotely from the printing head 1108.

Referring to FIG. 11A, the printing system 1100A can be configured to only be partially inserted into an internal region of a living subject (e.g. an animal, a person). In such an embodiment, the printing head 1108 can remain outside the subject while the one or more elongated members 1142 can be configured to be inserted into the internal region (e.g., an epidermal region, an endodermal region, a subdermal region, a subcutaneous region, an intraperitoneal region, an intra-abdominal region, an intra-organ region, an intracranial region, a skeletal region, a muscular region, a nervous region, a cardiac region, a visceral region, a parietal region, a lumenal region, an endolumenal region, etc.). For example, during laparoscopic surgery, the printing head 1108 can be positioned adjacent to an opening of a trocar or a cannula. The trocar or cannula can be partially inserted into the living subject. The one or more elongated members 1142 can be inserted into the subject using the trocar or cannula.

The printing system 1100A can include a body-insertable device 1176 configured to subcutaneously insert the one or more elongated members 1142 and one or more dispense elements 1144 into the subject and access the region of interest 1102. In an embodiment, the body-insertable device 1176 can include a catheter, endoscope, or other suitable devices. For example, the body-insertable device 1176 can include an endoscope that includes at least one channel configured to house the one or more elongated members 1142 or the one or more dispense elements 1144. The body-insertable device 1176 can be configured to protect or guide the one or more elongated members 1142 and one or more dispense elements 1144, while the one or more elongated members 1142 and one or more dispense elements 1144 are inserted into the subject. The body-insertable device 1176 may also support the one or more elongated members 1142 during the printing process. As such, the body-insertable device 1176 can at least partially house the one or more elongated members 1142 or the one or more dispense elements 1144. For example, the portions of the one or more elongated members 1142 and the one or more dispense elements 1144 can protrude from the body-insertable device 1176. Alternatively, the one or more elongated members 1142 and the one or more dispense elements 1144 can be configured to be completely housed in the body-insertable device 1176 while being inserted into the subject. However, when the body-insertable device 1176 is proximate the region of interest 1102, the one or more elongated members 1142 can actuate in the z-direction such that portions of the one or more elongated members 1142 and the one or more dispense elements 1144 protrude from the body-insertable device 1176. In an embodiment, the body-insertable device 1176 can be attached to the printing head 1108. Alternatively, the body-insertable device 1176 can only house a portion of the one or more elongated members 1142 and the one or more dispense elements 1144.

In an embodiment, the printing system 1100A can be configured to operate during laparoscopic surgery. For example, the body-insertable device 1176 can at least partially house the one or more elongated members 1142 and the one or more dispense elements 1144. In such an embodiment, a trocar can be inserted into the subject and the body-insertable device 1176 can be inserted into a subject via the trocar. An individual operating the printing system 1100A can guide the body-insertable device 1176 using one or more sensors 1132 attached to the body-insertable device 1176, the one or more elongated members 1142, or the one or more dispense elements 1144. The one or more sensors 1132 can include a video camera with a cold light source (e.g., halogen or xenon). When the body-insertable device 1176 reaches the region of interest 1102, the control electrical circuitry 1114 can controllably actuate the one or more elongated members 1142 thereby controllably steering the one or more dispense elements 1144. In an embodiment, the one or more dispense elements 1144 can dispense one or more materials stored in the one or more material reservoirs 1148 through at least one dispense aperture 1146 thereby printing an object on the region of interest 1102.

In an embodiment, the printing system 1100A can be used during the laparoscopic surgery. For example, the printing system 1100A can print a medical implant. Similarly, the printing system 1100A can print a scaffold including a medicament therein or thereon onto the region of interest 1102 during or after the laparoscopic surgery. After the laparoscopic surgery is complete, the printing system 1100A can be used to speed the healing process. For example, the printing system 1100A can controllably dispense biological materials into the subject such as tissue, grafts, or cells, such as printing tissue, capillaries, or similar structures within the body. Such printing operations can facilitate faster healing of the wound. In an embodiment, the printing system 1100A can only be configured to be used during or after the laparoscopic surgery.

FIG. 11B illustrates the printing system 1100B that is substantially inserted subcutaneously into the subject, according to an embodiment. The printing system 1100B can be substantially similar to the printing system 1100A illustrated in FIG. 11A. However, the printing system 1100B can include a body-insertable device 1176 that can be configured to at least partially house the printing head 1108 along with the one or more elongated members 1142 and the one or more dispense elements 1144. As such, the printing head 1108 can be inserted subcutaneously into the subject along with the one or more elongated members 1142 and the one or more dispense elements 1144. However, the printing system 1100B can be configured to be completely subcutaneously inserted without the use of the body-insertable device 1176.

In the illustrated embodiment, the controller 1112 is illustrated to be remote from the printing head 1108 and configured to not be inserted subcutaneously into the subject. However, in other embodiments, the controller 1112 can be configured to be inserted subcutaneously. For example, at least a portion of the controller 1112 can be positioned within the printing head 1108.

FIG. 12 is a schematic cross-sectional view of a printing system 1200 according to an embodiment. Except as otherwise disclosed herein, the printing system 1200 can be the same as or substantially similar to any of the printing systems disclosed herein. The printing system 1200 includes one or more flushing elements 1250 configured to dispense one or more flushing agents towards the region of interest 1202. Each of the one or more flushing elements 1250 includes at least one flushing aperture 1252 configured to dispense one or more flushing agents therethrough towards the region of interest 1202. The one or more flushing agents prepare the region of interest 1202 to have a three-dimensional object printed thereon. The one or more flushing elements 1250 can be coupled to at least one flushing agent reservoir 1254 configured to store the one or more flushing agents therein. The one or more flushing elements 1250 can also be coupled to one or more elongated members 1242. In an embodiment, the one or more elongated members 1242 can include one or more actuators that controllably move the one or more elongated members 1242. The one or more elongated members 1242 can be operably coupled to and extend from a printing head 1208. The printing system 1200 can also include a printing device. The illustrated printing device includes one or more dispense elements 1244 also coupled to one or more elongated members 1242. The one or more dispense elements 1244 controllably dispense one or more materials onto the region of interest 1202. Additionally, the printing system 1200 further includes a controller 1212 having control electrical circuitry 1214. The control electrical circuitry 1214 can controllably steer the one or more elongated members 1242 and, consequently, the one or more dispense elements 1244 to controllably dispense the one or more materials from the one or more dispense elements 1244.

As discussed above, the one or more flushing elements 1250 are configured to dispense one or more flushing agents. For example, the one or more flushing elements 1250 are configured to dispense the one or more flushing agents towards the region of interest 1202, such as towards the region of interest 1202 or an at least partially printed object printed thereon. The one or more flushing elements 1250 can receive the one or more flushing agents via one or more inlets or can store the one or more flushing agents in a flushing agent reservoir included therein. Each of the one or more flushing elements 1250 includes at least one flushing aperture 1252 configured to dispense one or more flushing agents. The one or more flushing elements 1250 are positioned to dispense the one or more flushing agents proximate to or adjacent to a specific segment of the region of interest 1202. In an embodiment, the one or more flushing elements 1250 can controllably dispense the one or more flushing agents responsive to one or more directions from the control electrical circuitry 1214. In an embodiment, the one or more flushing elements 1250 can dispense the one or more flushing agents without direction from the control electrical circuitry 1214. For example, a user can manually open one or more valves (e.g., on a compressed gas tank) that allows the one or more flushing elements 1250 to dispense one or more flushing agents (e.g., compressed gas).

The one or more flushing agents can include any physical, biological, or chemical agent that prepares the region of interest 1202 to have an object printed thereon. The region of interest 1202 can be any location that the printing system 1200 is configured to print on. In an embodiment, the region of interest 1202 can include a non-organic region of interest 1202, such as a metal, a ceramic, a polymer, a composite, a micro-material, a nano-material, a liquid, or other non-organic material. In an embodiment, the region of interest 1202 can include an organic or biological region of interest 1202, such as organic scaffolding, a bone, a wound, a vein, skin, or another organic material. In an embodiment, the region of interest 1202 can include a plant, such a leaf, a stem, a root, bark (e.g. outer bark, inner bark), phloem, vascular cambium, sapwood, or heartwood, etc.

Each of the one or more flushing elements 1250 includes the at least one flushing aperture 1252 that dispenses the one or more flushing agents therethrough. The one or more flushing elements 1250 can include one or more microconduits, one or more nozzles, or one or more tubes, each of which includes at the at least one flushing aperture 1252. The one or more flushing elements 1250 can dispense the one or more flushing agents using any suitable method, such as spraying the one or more flushing agents, forming droplets of the one or more flushing agents, or streaming the one or more flushing agents. In an embodiment, the one or more flushing elements 1250 can include a disk having at least one flushing aperture 1252 therein. The size of the at least one flushing aperture 1252 can be configured to dispense the one or more flushing agents at a specific rate or dispense the one or more flushing agents at a certain velocity. The disk can be configured to dispense the one or more flushing agents. In an embodiment, the disk can be formed of a biocompatible material, an oxidation-resistant material, a corrosive-resistant material and/or a material having a high operating temperature if the disk is heated. In an embodiment, the disk can include a relatively stiff material that can form a droplet having a slower exit velocity (e.g., the velocity of a droplet immediately after separating from the at least one flushing aperture 1252).

The one or more flushing elements 1250 can dispense the one or more flushing agents at a number of angles. In an embodiment, the one or more flushing elements 1250 can dispense the one or more flushing agents at an angle that is substantially perpendicular to the region of interest 1202. In an embodiment, the one or more flushing elements 1250 can dispense the one or more flushing agents at non-perpendicular angle relative to the region of interest 1202. For example, the one or more flushing elements 1250 can dispense the one or more flushing agents onto a substantially nonplanar region of interest 1202. In an embodiment, the angle at which the one or more flushing elements 1250 dispense the one or more flushing agents can change if the one or more flushing elements 1250 are moved or steered, for example by control electrical circuitry. In an embodiment, the one or more flushing elements 1250 can include a plurality of flushing apertures 1252, each of which are configured to dispense the one or more flushing agents at different angles.

The one or more flushing elements 1250 can be heated during use. In an embodiment, the one or more flushing elements 1250 can be heated if a selected property of the flushing agent requires elevated temperatures (e.g., boiling water, lower viscosity). In an embodiment, the one or more flushing elements 1250 can be heated if a desired phase of a flushing agent is not stable at operating temperatures (e.g., vaporized hydrogen peroxide, steam). As such, the one or more flushing elements 1250 can include a heat source attached thereto or incorporated therein. The one or more flushing elements 1250 can include a thermal shield (not shown) that prevents or minimizes heat dissipated from the heat source to the region of interest 1202.

In an embodiment the one or more flushing elements 1250 can include an electrical source (not shown) attached thereto or incorporated therein. For example, the one or more flushing elements 1250 can include an electrical source configured to, just prior to or at the time of dispensing, alter a state of the flushing agent (e.g., to electrolyze saline to create a disinfectant such as superoxidized water for use in disinfecting a biological region of interest 1202).

In an embodiment, at least one of the one or more flushing elements 1250 can receive the one or more flushing agents via one or more inlets, at least one flushing agent reservoir 1254 located therein, or combinations thereof. For example, at least one flushing element 1250 can include a single inlet or a single flushing agent reservoir 1254. As such, the at least one flushing element 1250 can receive only a single flushing agent (e.g., a mixture of flushing agents) at any time. The at least one flushing element 1250 can include at least one flushing aperture 1252, such as two or more flushing apertures 1252, configured to dispense the single flushing agent. The two or more flushing apertures 1252 can enable the one or more flushing elements 1250 to dispense the single flushing agent at a greater rate, towards multiple locations simultaneously, or using a different method (e.g., spraying and forming droplets). In an embodiment, one or more flushing elements 1250 can receive one or more flushing agents via one or more inlets or at least one flushing agent reservoir 1254 holding the one or more flushing agents therein that is fluidly coupled to the at least one flushing element 1250. The at least one flushing element 1250 can include a plurality of flushing apertures 1252, with each of the plurality of flushing apertures 1252 dispensing different flushing agents or the same flushing agent substantially simultaneously.

The one or more flushing elements 1250 can be configured to operate in a number of environments. In an embodiment the printing system 1200 prints a biological material in an ex vivo, an in vivo, or an in vitro environment. As such, the one or more flushing elements 1250 can include a biocompatible material or be configured to operate in a fluid (e.g., blood, interstitial fluids). In an embodiment the printing system 1200 prints a material in an oxidizing environment. As such, the one or more flushing elements 1250 can include an oxidation-resistant material. In an embodiment, the printing system 1200 can be configured to operate in a dry or moist environment. Additionally, the one or more flushing elements 1250 can be formed of a material suitable for dispensing the one or more flushing agents. For example, the one or more flushing elements 1250 can be formed of an abrasive-resistant material if the flushing agent includes abrasive particles. In another example, the one or more flushing elements 1250 can be formed of a corrosive-resistant material if the flushing agent includes a corrosive agent.

The one or more flushing elements 1250 can include a device that controllably dispenses the one or more flushing agents. In an embodiment, the one or more flushing elements 1250 can include a valve, such as a pneumatic-actuated valve, an electrically actuated valve, a solenoid valve, or a mechanically actuated valve. In an embodiment, the one or more flushing elements 1250 may include a pump, a compressor, or a piezoelectric configured to create pressure gradients that dispense the one or more flushing agents from the one or more flushing elements 1250. In an embodiment, the control electrical circuitry 1214 can direct the value, pump, compressor, or piezoelectric to control the amount or rate at which the one or more flushing agents are dispensed from the one or more flushing elements 1250.

The one or more flushing elements 1250 can dispense one or more flushing agents stored in the at least one flushing agent reservoir 1254. The at least one flushing agent reservoir 1254 can be coupled (e.g., fluidly coupled) to the one or more flushing elements 1250. The at least one flushing agent reservoir 1254 can be configured to supply the one or more flushing agents to the one or more flushing elements 1250. For example, the at least one flushing agent reservoir 1254 can include a pump or compressor that moves the one or more flushing agents from the at least one flushing agent reservoir 1254 to the one or more flushing elements 1250. The at least one flushing agent reservoir 1254 can be reusable, refillable, or replaceable. Additionally, the at least one flushing agent reservoir 1254 can include one or more compartments therein. Each of the compartments can store substantially similar flushing agents or substantially different flushing agents.

The at least one flushing agent reservoir 1254 can store a variety of flushing agents. In an embodiment, the at least one flushing agent reservoir 1254 can store one or more cleaning agents. The one or more cleaning agents can be any flushing agents that are configured to remove one or more substances from the region of interest 1202. For example, the one or more cleaning agents can include a surfactant cleaning compound (e.g., soap). In an embodiment, the one or more cleaning agents can include pressurized air that blows one or more substances from the region of interest 1202. In an embodiment, the one or more cleaning agents can include air or other gas that removes moisture from and dries the region of interest 1202. In an embodiment, the one or more cleaning agents can include a vacuum that is configured to suck-up one or more substances from the region of interest 1202. In an embodiment, the one or more cleaning agents can include particles, such as abrasive particles, configured to blast the one or more substances away from the region of interest 1202.

In an embodiment, the one or more flushing agents can include one or more antimicrobial agents. The one or more antimicrobial agents can be configured to partially or completely destroy or inhibit microorganisms that are living on the region of interest 1202. In an embodiment, the one or more antimicrobial agents can include one or more disinfectant agents that are configured to destroy microorganisms living on a non-living object. For example, the one or more disinfectant agents can include air disinfectants (e.g., glycols), alcohols, aldehydes, oxidizing agents, phenolics, quaternary ammonium compounds (quats), ethylene oxide, or other suitable disinfectants. In an embodiment, the one or more antimicrobial agents can include one or more antibiotic agents that are configured to inhibit or kill microorganisms within a living organism. The one or more antibiotic agents can include bactericidal agents, bacterial inhibitors, bacteriostatic agents, narrow-spectrum antibiotics, broad-spectrum antibiotics, cyclic lipopeptides, glycylcyclines, oxazolidinones, or lipiarmycins. In an embodiment, the one or more antimicrobial agents can include one or more antiseptic agents configured to destroy microorganisms on living tissue. Examples of antiseptic agents include alcohols, iodine, cationic surfactants, phenol, hydrogen peroxide, superoxidized water, saline solutions, polyhexanide, or another suitable antiseptic agent.

In an embodiment, the one or more flushing agents can include one or more sterilizing agents configured to destroy microorganisms in all stages, including bacteria, viruses, fungi, yeast, spores and the like. In an embodiment, the one or more sterilizing agents can include a physical process. For example, the one or more sterilizing agents can irradiate the region of interest 1202. The one or more sterilizing agents can irradiate the region of interest 1202 using heat or light. Alternatively, the one or more sterilizing agents can sterilize the region of interest 1202 using a heated liquid, such as steam or vaporized hydrogen peroxide. The one or more sterilizing agents can sterilize the region of interest 1202 using sound waves, for example ultrasound waves. In an embodiment, the one or more sterilizing agents can include a chemical or biological agent configured to destroy microorganisms. For example, the one or more sterilizing agents can include ethyl oxide, nitrogen dioxide, ozone, bleach, hydrogen peroxide, alcohols (e.g., ethanol), iodine, peracetic acid, sodium hydroxide, sodium hypochlorite, hydrogen sulfite, glutaraldehyde, or other suitable sterilizing agents.

In an embodiment, the one or more flushing agents can include one or more biocidal agents. The one or more biocidal agents can be configured to destroy substantially all living matter on the region of interest 1202. In an embodiment, the one or more biocidal agents can include a physical process such as those described above, for example, at a higher intensity, a different frequency, or a longer duration than can be used for sterilization. In an embodiment, the one or more biocidal agents can include a chemical or biological agent configured to destroy the living matter. For example, the one or more biocidal agents can include ethyl oxide, nitrogen dioxide, ozone, bleach, hydrogen peroxide, alcohols (e.g., ethanol), iodine, peracetic acid, sodium hydroxide, sodium hypochlorite, hydrogen sulfite, or other suitable biocidal agents. For example, the one or more biocidal agents can include sterilizing agents prepared at higher concentrations or dispensed for longer duration.

In an embodiment, the one or more flushing agents can include one or more agents that degrade or destroy organic matter on the region of interest 1202. For example, organic matter can include living tissue, living organisms, contaminants, cellular compositions, cellular products, prions, peptides, protein, lipid, glycoside, or nucleic acid. In an embodiment, the one or more agents can include a chemical or biological agent configured to destroy organic matter. For example, the one or more flushing agents can include an enzyme, a strong base, a strong acid, an oxidizing compound, or an ablative compound. In an embodiment, the one or more agents for destroying organic matter can include a physical process. For example, the one or more agents can act as a plasma treatment, an electrical treatment, or a thermal treatment.

In an embodiment, the one or more flushing agents can include one or more corrosive agents that damage or destroy one or more substances on the region of interest 1202. For example, the one or more corrosive agents can include one or more oxidizing agents such as air, oxygen, hydrogen peroxide, super-oxidized water, nitrogen dioxide or another suitable oxidizing agent. The one or more oxidizing agents can provide an oxidizing environment during the printing process. The one or more corrosive agents can also include acidic solutions, basic solutions, or other corrosive agents. In an embodiment, the region of interest 1202 can include a silicon substrate. The one or more flushing element 1250 can dispense hydrofluoric acid onto the silicon substance to remove any silicon oxide therefrom. Alternatively, the one or more flushing elements 1250 can dispense an oxidizing agent onto the silicon substrate to form a silicon oxide layer. The one or more corrosive agents can also be used to destroy microorganisms or living material.

In an embodiment, the one or more flushing agents can include one or more inert agents configured to provide an inert atmosphere. The one or more inert agents can include argon, other noble gas, carbon dioxide, nitrogen, or other inert gas. Alternatively, the one or more inert agents can include a partial vacuum proximate to the region of interest 1202. The vacuum can also minimize the amount of flushing agents, such as toxic flushing agents, that dissipate from the region of interest 1202. In an embodiment, the flushing agent can include a liquid absorption material, medicament, a non-stick material (e.g., oil), a binder (e.g., an adhesive), a saccharide solution, a lipid solution, a detergent or other materials that can prepare the region of interest 1202.

In an embodiment, the one or more flushing agents can prevent an object printed on the region of interest 1202 from being contaminated. For example, the one or more flushing agents can remove or destroy potential contaminates. In an embodiment, the one or more flushing agents can facilitate bonding of the object to the region of interest 1202. For example, the one or more flushing agents can remove or destroy substances that prevent bonding of the object to the region of interest 1202. Alternatively, the one or more flushing agents (e.g., a non-stick material) can prevent the object from bonding to the region of interest 1202. In an embodiment, the one or more flushing agents can change the region of interest 1202 (e.g., oxidize) to facilitate bonding of the object to the region of interest 1202. In an embodiment, the one or more flushing agents can prevent infection, sepsis, or putrefaction. In an embodiment, the one or more flushing agents can improve the precision of the printing system 1200 by removing substances that can affect the precision of the printing system 1200 (e.g., bumps). In an embodiment, the one or more flushing agents can be configured to cause (e.g., oxidizing environment) or prevent (e.g., inert environment) a chemical reaction from occurring when the object is printed.

In some embodiments, the one or more flushing agents can be used in a living organism. As such, the one or more flushing agents can be biocompatible and non-toxic. In an embodiment, the one or more flushing agents can be used on a non-organic material. Flushing agents used on non-organic materials do not have to be biocompatible or non-toxic.

In an embodiment, the one or more flushing agents are flushing liquids, flushing gases, or flushing solids. Flushing liquids can include water (e.g., super-oxidized water), saline solutions, saccharide solutions, peroxide solutions, superoxidized solutions, glutaraldehyde, alcohol solutions, bleach solutions, basic solutions, acidic solutions, medicament, or other liquid flushing agents. Flushing gases can include air, oxygen, nitrogen, argon, carbon dioxide, vaporized hydrogen peroxide, ozone, nitrogen dioxide, ethylene oxide, or other gaseous flushing agent. Flushing solids can include liquid absorption materials, binders, or other solid flushing agents.

In an embodiment, the one or more flushing agents can include two or more flushing agents that work in conjunction with each other. For example, the one or more flushing elements 1250 dispense one or more liquid absorption materials onto the region of interest 1202. Afterwards, the one or more flushing elements 1250 dispense one or more cleaning agents, such as compressed air, that removes the one or more liquid absorption materials from the region of interest 1202. In an embodiment, the one or more flushing elements 1250 dispense one or more toxic flushing agents (e.g., hydrofluoric acid) onto the region of interest 1202. Afterwards, the one or more flushing element 1250 can dispense a cleaning agent onto the region of interest 1202 to remove the one or more toxic flushing agents.

The at least one flushing reservoir 1254 can be formed of a material configured to stably store the one or more flushing agents. In an embodiment, the one or more flushing agents can include one or more corrosive agents. As such, the at least one flushing agent reservoir 1254 can include a non-corrosive material. For example, a flushing agent reservoir 1254 configured to store hydrofluoric acid can include a plastic material or a suitable stainless steel. In an embodiment, the one or more flushing agents can include abrasive particles. As such, the flushing agent reservoir 1254 can include a wear-resistant material, such as a suitable stainless steel or a ceramic. In an embodiment, the flushing agent can include a compressed fluid. In such an embodiment, the flushing agent reservoir 1254 can include a pressure vessel.

The at least one flushing agent reservoir 1254 can be coupled to the one or more flushing elements 1250 via one or more conduits 1236. The one or more conduits 1236 can be coupled to an outlet (not shown) of the at least one flushing agent reservoir 1254 and an inlet (not shown) of the one or more flushing elements 1250. In an embodiment, the one or more conduits 1236 can include a tube. Additionally, the one or more conduits 1236 can include one or more components to facilitate the flow of the one or more flushing agents therethrough, such as a pump. For example, the one or more conduits 1236 can extend through the one or more elongated members 1242.

The at least one flushing agent reservoir 1254 can be configured to move the one or more flushing agents from the at least one flushing agent reservoir 1254 to the one or more flushing elements 1250. In an embodiment, the at least one flushing agent reservoir 1254 can include or be associated with a component, such as a pump, that moves the one or more flushing agents from the at least one flushing agent reservoir 1254. The component can operate responsive to a direction received from the control electrical circuitry 1214. In an embodiment, the at least one flushing agent reservoir 1254 can include a collapsible bag that exerts a compressive pressure on the one or more flushing agents therein. Alternatively, the at least one flushing agent reservoir 1254 can use gravity or another component of the printing system 1200 (e.g., the one or more flushing elements 1250 can include a pump) to move the one or more flushing agents. Similarly, the at least one flushing agent reservoir 1254 can include a valve that prevents the one or more flushing agents from leaving the at least one flushing agent reservoir 1254.

In the illustrated embodiment, the at least one flushing agent reservoir 1254 is positioned in and at least partially enclosed by the printing head 1208. However, in an embodiment, the at least one flushing agent reservoir 1254 can be positioned at other locations of the printing system 1200. For example, at least one flushing agent reservoir 1254 can be attached to an exterior of the printing head 1208. In an embodiment, the at least one flushing agent reservoir 1254 can be positioned in or attached to the one or more elongated members 1242 or the one or more flushing elements 1250. In an embodiment, the at least one flushing agent reservoir 1254 can include two or more flushing agent reservoirs coupled together and spaced from each other (e.g., a primary flushing agent reservoir and a secondary flushing agent reservoir). In an embodiment, the at least one flushing agent reservoir 1254 can be located remote from the printing system 1200. For example, the flushing agent reservoir 1254 can include a compressed gas tank that is remote from the printing system 1200. The compressed gas tank can be connected to the printing system 1200 using a tube.

In the illustrated embodiment, the one or more flushing elements 1250 are coupled to one or more elongated members 1242. The one or more elongated members 1242 can be configured to support the one or more flushing elements 1250 adjacent to or proximate to the region of interest 1202. Each of the one or more elongated members 1242 can include a single flushing element 1250 or a plurality of flushing elements 1250 coupled thereto. In an embodiment, the printing system 1200 can include about 1 to about 10 elongated members 1242, each of which are coupled to a corresponding one of the one or more flushing elements 1250. In some complex printing operations, the printing system 1200 can include more than 10 elongated members 1242. The number of elongated members 1242 included in the printing system 1200 can depend on the specific printing operation. For example, increasing the number of elongated members 1242 can enable the printing system 1200 to prepare the region of interest 1202 for more complex printing operations.

In an embodiment, the one or more elongated members 1242 can merely support the one or more flushing elements 1250 proximate or adjacent the region of interest 1202. For example, the one or more elongated members 1242 can include a rigid, semi-rigid, or flexible material. In an embodiment, the one or more elongated members 1242 can include one or more actuators that move the one or more elongated members 1242. For example, the one or more elongated members 1242 can include a rigid material and an actuator attached to the rigid material. The one or more actuators can include a pneumatic actuator, a hydraulic actuator, a piezoelectric actuator, a shape memory material actuator, or an electroactive polymer actuator. For example each of the elongated members 1242 can include a single actuator, an actuator couple to another actuator, any combinations of actuators, any number of actuators, or an actuator coupled to a portion of the elongated member 1242 that is not configured to move (e.g., a rigid material). The elongated members 1242 can be steerable in one or more directions. The one or more actuators enables the printing system 1200 to controllably steer the one or more flushing elements 1250 to selectively position the one or more flushing elements 1250. For example, the one or more elongated members 1242 can move the one or more flushing elements 1250 adjacent to a specific segment of the region of interest 1202 such that the one or more flushing elements 1250 can prepare the specific segment of the region of interest 1202 to have an object printed thereon. In an embodiment, the one or more elongated members 1242 can steer the one or more flushing elements 1250 adjacent to an at least partially printed object such that the one or more flushing elements 1250 can dispense one or more flushing agents towards the at least partially printed object. In an embodiment, the one or more actuators can controllably steer the one or more flushing elements 1250 responsive to direction from the control electrical circuitry 1214.

In an embodiment, the one or more elongated members 1242 can be configured to not controllably steer the one or more flushing elements 1250, while the printing system 1200 is printing an object on the region of interest 1202. Such an embodiment can minimize the likelihood that the one or more elongated members 1242 shake the printing system 1200 during the printing operation, thereby increasing precision of the printing system 1200. Alternatively, the one or more elongated members 1242 can controllably steer the one or more flushing elements 1250, while the printing system 1200 prints the object. For example, the one or more elongated members 1242 can controllably steer the one or more flushing elements 1250 to dispense one or more flushing agents towards the at least partially printed object.

The one or more elongated members 1242 may controllably steer the one or more flushing elements 1250 responsive to direction from the control electrical circuitry 1214. For example, the one or more elongated members 1242 can include an electroactive polymer actuator. The electroactive polymer can include at least one capacitor applied to a surface thereof. Direction from the control electrical circuitry 1214 can cause the capacitor to apply an electric field to the electroactive polymer, thereby causing the electroactive polymer to be controllably steered. In an embodiment, the one or more elongated members 1242 can include a shape memory material actuator. The printing system 1200 can include a device configured to apply heat to the shape memory actuator. The device can heat the shape memory material actuator responsive to direction from the control electrical circuitry 1214.

The one or more elongated members 1242 can be configured to be controllably steered independently of each other. As such, each of the elongated members 1242 can move independently of another elongated member 1242. For example, each of the one or more elongated members 1242 can be configured to receive one or more directions from the control electrical circuitry 1214 containing instructions. The specific instructions can direct each of the one or more elongated members 1242 to actuate differently. In an embodiment, the one or more elongated members 1242 can include a first actuator that moves in the z-direction and a second actuator that moves in the x-direction or y-direction. As such, each of the two actuators can be independently steerable. However, in an embodiment, at least some of the one or more elongated members 1242 cannot move independently. For example, two or more elongated members 1242 can be rigidly or semi-rigidly attached together or each elongated member 1242 can receive the same direction from the control electrical circuitry 1214.

Similar to the one or more flushing elements 1250, the one or more elongated members 1242 can be configured to operate in one or more different environments. In an embodiment, the one or more elongated members 1242 can operate in a biological environment (e.g., an ex vivo, an in vivo, or an in vitro environment). As such, at least the exterior of the one or more elongated members 1242 can include biocompatible materials. Biocompatible materials can include stainless steel, titanium, cobalt alloys, titanium alloys, ceramics, silicones, polyethylene, polyvinylchloride, or polyurethane. Additionally, the one or more elongated members 1242 can be configured to operate in a liquid, such as blood or an interstitial fluid. In an embodiment, the one or more elongated members 1242 can operate in an oxidizing or corrosive environment. As such, at least the exterior of the one or more elongated members 1242 can include an oxidation-resistant material or a corrosive-resistant material. For example, the oxidation resistant material or the corrosive resistant material can include stainless steel, titanium, or cobalt alloys. In an embodiment, the one or more elongated members 1242 can have a coating applied thereto that enables the one or more elongated members 1242 to operate in the different environments.

The one or more elongated members 1242 can support the one or more conduits 1236. In an embodiment, the one or more conduits 1236 can be attached to an exterior of the one or more elongated members 1242 using, for example, a clamp. In an embodiment, the one or more elongated members 1242 are at least partially hollow such that the one or more conduits 1236 can be positioned within, defined by, partially enclosed in, or incorporated into the hollow portions of the one or more elongated members 1242. For example, the one or more elongated members 1242 can be formed of a hollow electroactive polymer. Alternatively, the one or more conduits 1236 can be remote from the one or more elongated members 1242.

As discussed above, the printing system 1200 can further include the printing head 1208 that is configured to support the components of the printing system 1200. For example, the one or more elongated members 1242 can be coupled to and extend from the printing head 1208. The printing head 1208 can also support the one or more elongated members 1242 and the one or more flushing elements 1250 above, proximate to, or adjacent to the region of interest 1202. The printing head 1208 can further include additional components mounted to, supported by, or at least partially enclosed by the printing head 1208. For example, the at least one flushing agent reservoir 1254 can be at least partially enclosed by the printing head 1208. Additionally, the printing head 1208 can include devices that actuate the one or more elongated members 1242 (e.g., a compressor that actuates a pneumatic actuator).

The printing system 1200 can further include a support structure 1228 configured to support the printing head 1208 a selected distance from the region of interest 1202. In an embodiment, the printing system 1200 can be configured to enable the printing head 1208 to move in at least one, at least two, or three dimensions. For example, portions of the support structure 1228 can include means for movement, while additional portions of the support structure 1228 can include a track on which the portions of the support structure 1228 move. Means for movement can include, for example, a motor, gears, gravity, one or more pneumatic actuators, one or more hydraulic actuators, or other means for movement. The means for movement can move the printing head 1208 from a first location remote from the region of interest 1202 to a second location proximate to the region of interest 1202. Additionally, in the second location, the one or more flushing elements 1250 can be positioned adjacent to or proximate to the region of interest 1202. The support structure 1228 can move the printing head 1208 from the first position to the second position responsive to a signal or direction from the control electrical circuitry 1214. The support structure 1228 can be configured to move from the first location to the second location without contacting the printing head 1208, the one or more flushing elements 1250, or another component of the printing system 1200 against an object. For example, the support structure 1228 can include at least sensor that can detect an object and the control electrical circuitry 1214 can use the data from the at least one sensor to move the printing head 1208 around the object.

In an embodiment, the printing system 1200 can be configured to maintain the printing head 1208 substantially stationary while the one or more flushing elements 1250 dispense the one or more flushing agents. Such an embodiment can improve the stability of the printing system 1200 and increase controllability of the one or more elongated members 1242.

The printing system 1200 can include one or more components that form a printing device configured to print an object on the region of interest 1202. The printing device can be configured to print the object in situ. The printing device can be incorporated into the printing head 1208, coupled to the printing head 1208, or can operate in conjunction with the printing head 1208. In an embodiment the printing device can be a specialized device as described herein or other suitable 3-D printing device.

In the illustrated embodiment, the printing device includes one or more elongated members 1242 coupled to and extending from the printing head 1208 towards the region of interest 1202. The printing device further includes one or more dispense elements 1244 coupled to the one or more elongated members 1242. The one or more elongated members 1242 can include one or more actuators that controllably steer the one or more dispense elements 1244. The one or more dispense elements 1244 can include at least one dispense aperture 1246 configured to dispense one or more materials onto the region of interest 1202. The one or more elongated members 1242 can be controllably steered and the one or more dispense elements 1244 can controllable dispense responsive to direction from the control electrical circuitry 1214.

The one or more dispense elements 1244 can be coupled to at least one material reservoir 1248. The at least one material reservoir 1248 can be configured to store the one or more materials that are used to print an object on the region of interest 1202. The at least one material reservoir 1248 can be located in the one or more dispense elements 1244 or located remotely from the one or more dispense element 1244. For example, the at least one material reservoir 1248 can be at least partially enclosed by the printing head 1208. The at least one material reservoir 1248 can be coupled to the one or more dispense elements 1244 using one or more conduits 1236. The at least one material reservoir 1248 can store any of a variety of or combinations of materials, such as any of the materials disclosed herein.

The printing system 1200 can further include one or more sensors 1232 configured to detect at least one characteristic of the region of interest 1202 or the printing system 1200. The at least one characteristic of the printing system 1200 that can be sensed by the one or more sensors 1232 can include the position of a component of the printing system 1200, such as a position or movement of the one or more flushing elements 1250; the flow of the one or more flushing agents, the flow of one or more materials, temperature of the printing system 1200, flushing agent to be dispensed or that has been dispensed, or material to be dispensed or that has been dispensed; or other characteristics of the printing system 1200. As such, the one or more sensors 1232 can include a position sensor configured to sense position of the one or more flushing elements 1250, the printing head 1208, or the printing device; an accelerometer configured to sense acceleration of the one or more flushing elements 1250, the printing head 1208, or the printing device; a flow gauge configured to sense flow of the one or more flushing agents or one or more materials dispensed from the one or more flushing elements 1250 or the printing device, respectively; an acoustic sensor configured to sense amount or volume of the one or more flushing agents or the one or more materials dispensed onto the region of interest 1202, or other suitable sensors.

In an embodiment, the one or more sensors 1232 can be communicably coupled to the controller 1212. The controller 1212 can use the information to operate at least a portion of the printing system 1200. For example, the controller 1212 can request the one or more sensors 1232 to detect the position and relative movement of the one or more elongated members 1242 using a position sensor and an accelerometer. The control electrical circuitry 1214 can use the detected information from the one or more sensors 1232 to controllably steer or calibrate the one or more actuators of the one or more elongated members 1242 and dispensing of the one or more flushing agents from the one or more flushing elements 1250.

In an embodiment, the one or more sensors 1232 can be attached to different components of the printing system 1200. For instance, a sensor 1232 can be positioned on the printing head 1208, the one or more elongated members 1242, the one or more flushing elements 1250, or the printing device. The location of the one or more sensors 1232 can be configured to not substantially interfere with or influence the operation of the one or more flushing elements 1250, the one or more elongated members 1242, or the printing device.

The controller 1212 can be communicably coupled, either directly or indirectly, to at least one of the printing head 1208, the support structure 1228, the one or more elongated members 1242, the one or more flushing elements 1250, the at least one flushing agent reservoir 1254, and the printing device (e.g., the one or more elongated members 1242, the one or more dispense elements 1244, and the at least one material reservoir 1248). For example, FIG. 12 illustrates that the controller 1212 is communicably coupled directly to the printing head 1208. The controller 1212 can then be communicably coupled indirectly to other components of the printing system 1200 through the printing head 1208. The controller 1212 can be communicably coupled through a wired or wireless (e.g., Bluetooth, Wi-Fi) connection. The controller 1212 can be remote from at least one the printing head 1208, the one or more elongated members 1242, the one or more flushing elements 1250, or the printing device. In an embodiment, the controller 1212 can be at least partially positioned within the printing head 1208, the one or more elongated members 1242, or the one or more flushing elements 1250.

The controller 1212 can include a user interface 1256 that enables an individual to communicate with the printing system 1200. The user interface 1256 can include a display, mouse, keyboard, microphone, speaker, or any other device that enables an individual to communicate with the printing system 1200. The user interface 1256 can also include software that enables the user to communicate with the printing system 1200 such as an operating system, operator controls or a process control. In an embodiment, the user interface 1256 can enable an individual to input instructions or commands into the printing system 1200. The commands can include instructions to prepare the region of interest 1202, information about the one or more flushing agents, build data (e.g., a CAD file), information about the one or more flushing agents, information about one or more components of the printing system 1200, instructions to execute a program, instructions to cancel an operation, etc. In an embodiment, the printing system 1200 can be configured to receive and accept the instructions or commands inputted into the user interface 1256. In an embodiment, the printing system 1200 can send data to the user interface 1256. The data can include information about the current status of the operation to prepare the region of interest 1202, the current status of the printing operation, the current status of the printing system 1200, an error, or additional information. The user interface 1256 can display the data.

The controller 1212 can further include memory 1258 storing operational instructions for operating the printing system 1200. The memory 1258 can include random access memory (RAM), read only memory (ROM), a hard drive, a disc (e.g., blue-ray, DVD, or compact disc), flash memory, other types of memory electrical circuitry, or other suitable memory. The instructions stored on the memory 1258 can include a CAD file, a program configured to operate the printing system 1200, information about the printing system 1200 and the components thereof, information gathered by the printing system 1200, or additional information. The controller 1212 can further include a processor 1260 configured to direct certain operations of the printing system 1200 according to the instructions contained in the memory.

As previously discussed, the controller 1212 includes the control electrical circuitry 1214. In an embodiment, the control electrical circuitry 1214 controls one or more components of the printing system 1200 responsive to programming and instructions stored on the memory 1258 or received from the user interface 1256. In an embodiment, the control electrical circuitry 1214 controls one or more components of the printing system 1200 responsive to direction from one or more components of the controller 1212 (e.g., processor 1260). In an embodiment, the control electrical circuitry 1214 controls one or more components of the printing system 1200 responsive to instructions or programming contained within the control electrical circuitry 1214. The control electrical circuitry 1214 can be integrally formed with the memory 1258 and the processor 1260 of the controller 1212. Alternatively, the control electrical circuitry 1214 can be separate from the memory 1258 and the processor 1260 of the controller 1212. In such an embodiment, the control electrical circuitry 1214 can include its own memory and a processor.

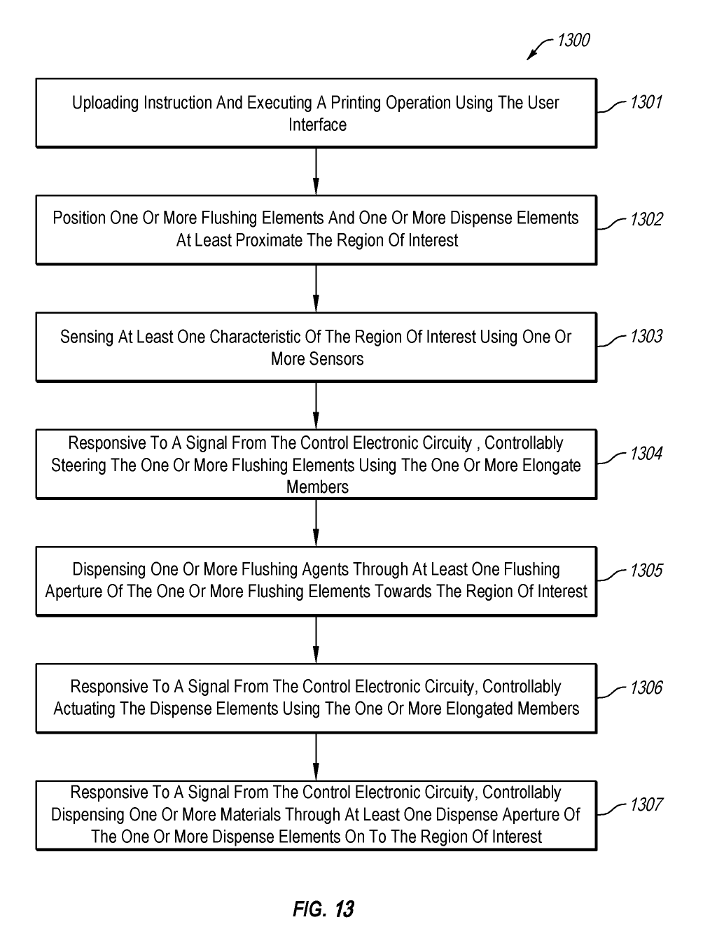

FIG. 13 is a flow diagram of a method 1300 of using any of the printing systems disclosed herein, according to an embodiment. For simplicity, the method 1300 is described in relationship with the printing system 1200 of FIG. 12. However, it should be understood that the method 1300 can be used with any of the printing systems disclosed herein. Except as otherwise disclosed herein, the method 1300 can be the same as or substantially similar to any of the method disclosed herein.**

In act 1301, a user can upload instructions and execute a printing operation using the user interface 1256. For example, the user can load instructions into the memory 1258 for preparing the region of interest 1202 to have an object printed thereon. The user can also load, for example, a CAD file of the object to be printed on the region of interest 1202. The instructions can be stored in the memory 1258. Additionally, the user can instruct to printing system 1200 to execute a printing operation. The printing operation can include at least preparing the region of interest 1202 to have the object printed thereon. Upon receiving the instructions from the user interface 1256, the control electrical circuitry 1214 can communicate directions to the different components of the printing system 1200.

In act 1302, the printing system 1200 can position the one or more flushing elements 1250 and the one or more dispense elements 1244 at least proximate to the region of interest 1202. In an embodiment, the printing system 1200 (e.g., a portable printing system 1200) can be positioned near the region of interest 1202 and the printing system 1200 can position the one or more flushing elements 1250 or the one or more dispense elements 1244 are proximate the region of interest 1202. In an embodiment, the printing system 1200 can move the printing head 1208 to the second position.

In act 1303, the printing system 1200 can sense at least one characteristic of the region of interest 1202 using one or more sensors 1232. For example, the one or more sensors 1232 can include at least one position sensor configured to detect the portion of the one or more flushing elements 1250 relative to the region of interest 1202. In another example, the one or more sensors 1232 can include at least one flow gauge configured to detect the flow of the one or more flushing agents from the one or more flushing elements 1250. In an embodiment, the one or more sensors 1232 can transmit the detected characteristics of the region of interest 1202 to the controller 1212.

In act 1304, responsive to a signal from the control electrical circuitry 1214, the printing system 1200 can controllably steer the one or more flushing elements 1250 using the one or more elongated members 1242. For example, the one or more elongated members 1242 can position the one or more flushing elements 1250 adjacent to or proximate to a specific segment of the region of interest 1202 responsive to the signal or direction from the control electrical circuitry 1214. In act 1305, the printing system 1200 can dispense one or more flushing agents through at least one flushing aperture 1252 of the one or more flushing elements 1250 towards the region of interest 1202. For example, the control electrical circuitry 1214 can communicate a direction instructing at least one of the one or more flushing elements 1250, the at least one flushing agent reservoir 1254, or the one or more conduits 1236 to dispense the one or more flushing agents. The control electrical circuitry 1214 can communicate a direction to disperse the one or more flushing agents towards the specific segment of the region of interest 1202. For example, the direction to disperse the one or more flushing agents can cause one or more valves to partially open or a pressure to be applied to the one or more flushing agents.

In act 1306, responsive to a signal from the control electrical circuitry, the printing system 1200 can controllably actuate the dispense elements 1244 using the one or more elongated members 1242. The one or more elongated members 1242 can position the one or more dispense elements 1244 adjacent to or proximate to a specific segment of the region of interest 1202. In act 1307, responsive to a signal from the control electrical circuitry, the printing system 1200 can controllably dispense one or more materials through at least one dispense aperture 1246 of the one or more dispense elements 1244 onto the region of interest 1202. For example, the control electrical circuitry 1214 can communicate the signal or direction instructing at least one of the one or more dispense elements 1244, the at least one material reservoir 1248, or the one or more conduits 1236 to dispense the one or more materials. The control electrical circuitry 1214 can communicate a direction to disperse the one or more materials onto the specific segment of the region of interest 1202. This method can be repeated until the three-dimensional object is partially or completely printed, as desired.

In an embodiment, the one or more flushing elements 1250 can dispense the one or more flushing agents towards the region of interest 1202 after the object is completely printed on the region of interest 1202. In an embodiment, the one or more flushing elements 1250 can dispense one or more flushing agents to remove contaminants present on the object after printing. In an embodiment, the one or more flushing elements 1250 can dispense one or more corrosive agents onto the object after printing. For example, it can be beneficial to form an oxide layer on at least one surface of the object. In another example, the one or more corrosive agents can remove material from the object, such as a support material, that is no longer needed.

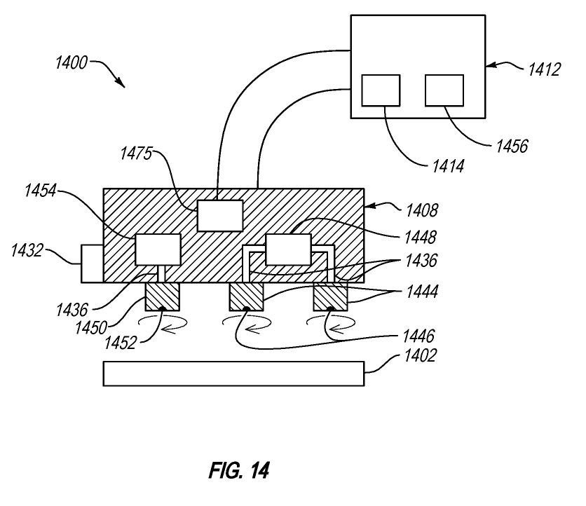

FIG. 14 is a schematic cross-sectional view of a printing system 1400 according to an embodiment. The printing system 1400 can include one or more flushing elements 1450. Except as otherwise disclosed herein, the printing system 1400 can be the same as or substantially similar to any of the printing systems disclosed herein. For example, each of the one or more flushing elements 1450 can include at least one flushing aperture 1452 configured to dispense one or more flushing agents towards the region of interest 1402. The one or more flushing elements 1450 are coupled to at least one flushing agent reservoir 1454 via one or more conduits 1436. The printing system 1400 can further include a printing head 1408. The printing system 1400 can also include any of the printing devices disclosed herein. For example, the printing device can include one or more dispense elements 1444 including one or more dispense apertures 1446. The one or more dispense elements 1444 can be coupled to at least one material reservoir 1448 via one or more conduits 1436. The printing system 1400 further includes a controller 1412 that includes control electrical circuitry 1414 and a user interface 1456. The control electrical circuitry 1414 can direct the operation of the components of the printing system 1400 after a user inputs instructions or commands into the user interface 1456.

In an embodiment, the one or more flushing elements 1450 or one or more dispense elements 1444 can be directly coupled to and supported by the printing head 1408. For example, the one or more flushing elements 1450 or the one or more dispense elements 1444 can be rigidly or semi-rigidly coupled to the printing head 1408. In an embodiment, the one or more flushing elements 1450 or the one or more dispense elements 1444 can rotate or tilt relative to the printing head 1408. For example, the one or more flushing elements 1450 or the one or more dispense elements 1444 can include a first portion that is fixed to the printing head 1408 and a second portion that rotates relative the printing head 1408. The first portion can be rigidly or semi-rigidly attached to the printing head 1408. The one or more flushing elements 1450 or the one or more dispense elements 1444 can include a motor 1475 or other actuator that rotates the second portion. For example, the motor 1475 can rotate the second portion of the one or more flushing elements 1450 or the one or more dispense elements 1444 responsive to direction from the control electrical circuitry 1414. In the illustrated embodiment, the motor 1475 may be indirectly or directly communicably coupled to the control electrical circuitry 1414.

The one or more flushing elements 1450 or the one or more dispense elements 1444 coupled to the printing head 1408 can be used in any of the printing systems disclosed herein. For example, any of the printing systems disclosed herein can include one or more flushing elements 1450 that are coupled to and rotate relative to the printing head 1408.

The printing system 1400 can further include one or more sensors 1432 configured to detect at least one characteristic of the region of interest 1402 or the printing system 1400. The one or more sensors 1432 can be substantially similar to any of the sensors disclosed herein. For example, the one or more sensors 1432 can detect the relative rotation of the second portion of the one or more flushing elements 1450 relative the printing head 1408. The one or more sensors 1432 can transmit the detected characteristics to a controller 1412. The controller 1412 can include a user interface 1456 and control electrical circuitry 1414.

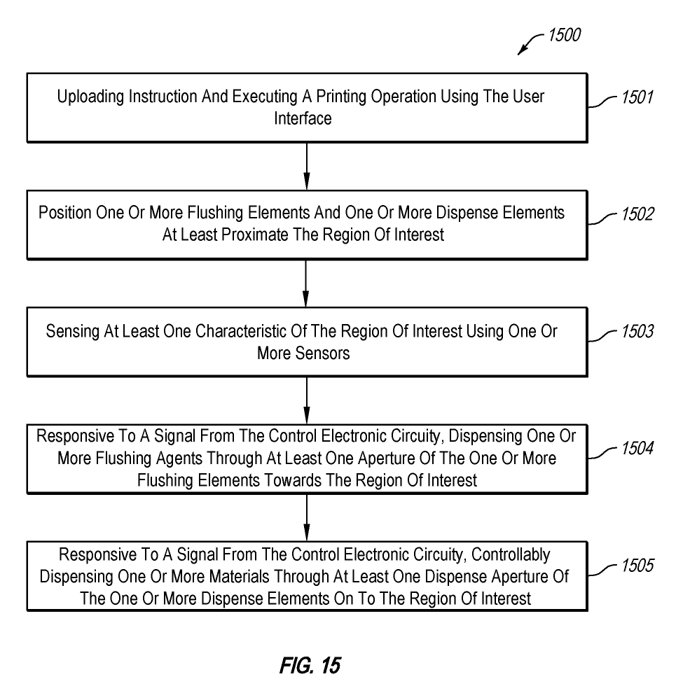

FIG. 15 is a flow diagram of a method 1500 of using any of the printing systems disclosed herein, according to an embodiment. For clarity, the method 1500 is disclosed in relationship with the printing system 1400 of FIG. 14. Except as otherwise disclosed herein, the method 1500 can be the same as or substantially similar to any of the methods disclosed herein.

In act 1501, the user can upload instructions and execute a printing operation using the user interface 1456. The instruction can include instructions to prepare the region of interest 1402 to have an object printed thereon. The user can also execute a printing operation using the user interface 1456. Upon executing the printing operation, the control electrical circuitry 1414 can direct one or more components of the printing system 1400.

In act 1502, the printing system 1400 can position one or more flushing elements 1450 and one or more dispense elements 1444 at least proximate the region of interest 1402. In act 1503, the printing system 1400 senses at least one characteristic of the region of interest 1402 using one or more sensors 1432. In act 1504, responsive to a signal from the control electrical circuitry 1414, the printing system 1400 can dispense one or more flushing agents through at least one flushing aperture 1452 of the one or more flushing elements 1450 towards the region of interest 1402. In an embodiment, the one or more flushing elements 1450 can rotate or tilt while dispensing the one or more flushing agents. For example, the control electrical circuitry 1414 can direct the motor 1475 to rotate or tilt the one or more flushing elements 1450 while dispensing the one or more flushing agents. In act 1505, responsive to a signal from the control electrical circuitry 1414, the printing system 1400 can controllably dispense one or more materials through at least one dispense aperture 1446 of the one or more dispense elements 1444 onto the region of interest 1402. In an embodiment, the one or more dispense elements 1444 can rotate or tilt while dispensing the one or more materials. For example, the control electrical circuitry 1414 can direct a motor 1475 to rotate or tilt the one or more dispense elements 1444 while dispensing the one or more materials.

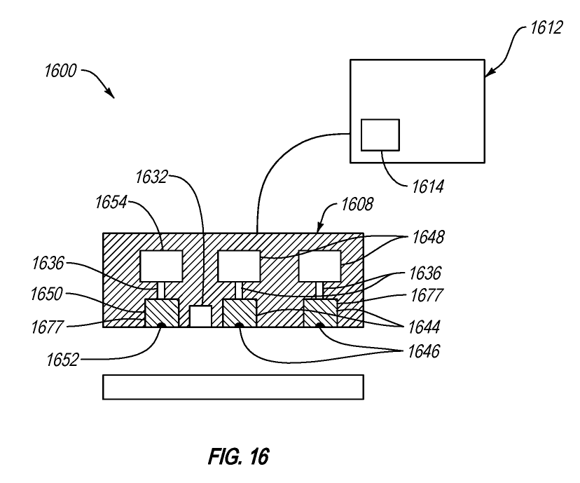

FIG. 16 is a schematic cross-sectional view of a printing system 1600 according to an embodiment. Except as otherwise disclosed herein, the printing system 1600 is the same as or substantially similar to any of the printing systems disclosed herein. The printing system 1600 can include a printing head 1608 that has one or more flushing elements 1650 at least partially enclosed in or incorporated into the printing head 1608. Similarly, the one or more dispense elements 1644 can be at least partially enclosed in or incorporated into the printing head 1608. The printing head 1608 that at least partially encloses or incorporates the one or more flushing elements 1650 or the one or more dispense elements 1644 can be used in any of the printing systems disclosed herein. Additionally, the printing system 1600 can also include one or more sensors 1632 at least partially enclosed by or incorporated into the printing head 1608. In an embodiment, the one or more flushing elements 1650 or the one or more dispense elements 1644 may controllably dispense one or more flushing agents or one or more materials, respective, responsive to direction from the control electrical circuitry 1614 of the controller 1612.

In an embodiment, the printing head 1608 can at least partially enclose the one or more flushing elements 1650 or the one or more dispense elements 1644. The printing head 1608 can include one or more recesses 1677 formed therein that at least partially receive the one or more flushing elements 1650 or the one or more dispense elements 1644. The one or more flushing elements 1650 or the one or more dispense elements 1644 can be secured in the one or more recesses 1677 using an adhesive, a threaded attachment, or another suitable attachment technique. When inserted into the one or more recesses 1677, the one or more flushing elements 1650 or the one or more dispense elements 1644 can be coupled to the at least one flushing agent reservoir 1654 or the at least one material reservoir 1648, respectively, via one or more conduits 1636.

In an embodiment, the printing head 1608 can incorporate the one or more flushing elements 1650 or the one or more dispense elements 1644 therein. For example, the printing head 1608 can include at least one flushing aperture 1652 or at least one dispense aperture 1646 formed therein. The at least one flushing aperture 1652 can be coupled to one or more flushing agents reservoirs 1654 and the at least one dispense aperture 1646 can be coupled to the at least one material reservoir 1648 via one or more conduits 1636. The printing head 1608 can further include any of the components discussed herein that can be used by the one or more flushing elements or the one or more dispense elements. For example, the printing head 1608 can include a heat source. Similarly, the printing head 1608 can include a device that dispenses the one or more flushing agents or the one or more dispense agents, such as a pump or compressor.

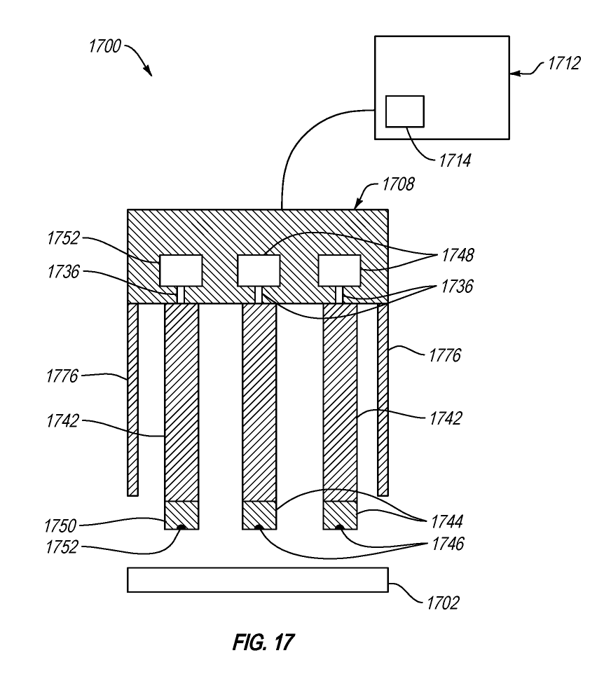

FIG. 17 is a schematic cross-sectional view of a printing system 1700 configured to be inserted into an internal region of a body of a subject (e.g. during laparoscopic surgery), according to an embodiment. Except as otherwise disclosed herein, the printing system 1700 can be the same as or substantially similar to any of the printing systems disclosed herein.

In the illustrated embodiment, the printing system 1700 is substantially similar to the printing system 100 shown in FIG. 1. For example, the printing system 1700 includes one or more flushing elements 1750 coupled to one or more elongated members 1742. The one or more flushing elements 1750 can be also coupled to at least one flushing agent reservoir 1754 via one or more conduits 1736. The printing system 1700 also includes a printing device including one or more dispense elements 1744. The one or more dispense elements 1744 can be coupled to one or more elongated members 1742 and include at least one dispense aperture 1746. The one or more dispense elements 1744 can be coupled to at least one material reservoir 1748 via one or more conduits 1736. The one or more elongated members 1742 can be coupled to and support by the printing head 1708. The one or more elongated members 1742 can be controllably steered responsive to direction from the control electrical circuitry 1714 of the controller 1712. The one or more flushing element 1750 and the one or more dispense elements 1744 can also controllably dispense the one or more flushing agents and the one or more materials, respectively, responsive to direction from the control electrical circuitry 1714.

Referring to FIG. 17, the printing system 1700 can be configured to be partially inserted into an internal region of interest 1702 of a living subject (e.g. an animal, a person). The internal region of interest 1702 of a living subject can include any region that is integral to a biological body. For example, the internal region of interest 1702 of a human body can include a region that is epidermal, endodermal, subdermal, subcutaneous, intraperitoneal, intra-abdominal, intra-organ, intracranial, skeletal, muscular, nervous, cardiac, luminal, endoluminal, etc. In such an embodiment, the printing head 1708 can remain outside the subject while the one or more elongated members 1742 can be configured to be inserted into the internal region of interest 1702 (e.g., an epidermal region, an endodermal region, a subdermal region, a subcutaneous region, an intraperitoneal region, an intra-abdominal region, an intra-organ region, an intracranial region, a skeletal region, a muscular region, a nervous region, a cardiac region, a visceral region, a parietal region, a lumenal region, an endolumenal region, etc.). For example, during laparoscopic surgery, the printing head 1708 can be positioned adjacent to an opening of a trocar or a cannula. The trocar or cannula can be partially inserted into the living subject. The one or more elongated members 1742 can be inserted into the subject using the trocar or cannula.

The printing system 1700 can include a body-insertable device 1776 configured to insert the one or more elongated members 1742, the one or more flushing elements 1750, and the one or more dispense elements 1744 into the subject and access the internal region of interest 1702. In an embodiment, the body-insertable device 1776 can include a catheter, endoscope, or other suitable device. For example, the body-insertable device 1776 can include an endoscope that includes at least one channel configured to house the one or more elongated members 1742, the one or more flushing elements 1750, or the one or more dispense elements 1744. The body-insertable device 1776 can be configured to protect or guide the one or more elongated members 1742, the one or more flushing elements 1750, or the one or more dispense elements 1744, while the one or more elongated members 1742, the one or more flushing elements 1750, or the one or more dispense elements 1744 are inserted into the subject. The body-insertable device 1776 can also support the one or more elongated members 1742 during the printing process. As such, the body-insertable device 1776 can at least partially house the one or more elongated members 1742, the one or more flushing elements, or the one or more dispense elements 1744. For example, portions of the one or more elongated members 1742, the one or more flushing elements 1750, or the one or more dispense elements 1744 can protrude from the body-insertable device 1776. Alternatively, the one or more elongated members 1742, the one or more flushing elements 1750, or the one or more dispense elements 1744 can be configured to be completely housed in the body-insertable device 1776 while being inserted into the subject. However, when the body-insertable device 1776 is proximate to the internal region of interest 1702, the one or more elongated members 1742 can actuate such that portions of the one or more elongated members 1742, the one or more flushing elements 1750, or the one or more dispense elements 1744 protrude from the body-insertable device 1776. In an embodiment, the body-insertable device 1776 can be attached to the printing head 1708. Alternatively, the body-insertable device 1776 can only house a portion of the one or more elongated members 1742, the one or more flushing elements 1750, or the one or more dispense elements 1744.

In an embodiment, the printing system 1700 can be configured to operate during laparoscopic surgery. For example, the body-insertable device 1776 can at least partially house the one or more elongated members 1742, the one or more flushing elements 1750, or the one or more dispense elements 1744. In such an embodiment, a trocar can be inserted into the subject and the body-insertable device 1776 can be inserted into a subject via the trocar. An individual operating the printing system 1700 can guide the body-insertable device 1776 using one or more sensors 1732 attached to the body-insertable device 1776, the one or more elongated members 1742, the one or more flushing elements 1750, or the one or more dispense elements 1744. The one or more sensors 1732 can include a video camera with a cold light source (e.g., halogen or xenon). When the body-insertable device 1776 reaches the internal region of interest 1702, the control electrical circuitry 1714 can steer the one or more elongated members 1742, thereby controllably steering the one or more flushing elements 1750 or the one or more dispense elements 1744. In an embodiment, the one or more flushing elements 1750 can dispense one or more flushing agents stored in the at least one flushing agent reservoir 1754 through at least one flushing aperture 1752, thereby preparing the internal region of interest 1702 to have an object printed thereon by the one or more dispense elements 1744.

In an embodiment, the printing system 1700 can be used during the laparoscopic surgery. For example, the one or more flushing elements 1750 can prepare the internal region of interest 1702 to have an object printed thereon. The one or more flushing elements 1750 can prepare the internal region of interest 1702 by dispensing one or more cleaning agents onto the internal region of interest 1702 to remove one or more substances therefrom. Similarly, the one or more flushing elements 1750 can dispense one or more sterilizing agents or one or more antimicrobial agents. After the laparoscopic surgery is complete, the printing system 1700 can be used to speed the healing process. For example, the one or more dispense elements 1744 of the printing system 1700 can controllably dispense biological materials into the subject such as tissue, grafts, or cells, such as printing tissue, capillaries, or similar structures within the body. Such printing operations can use the one or more flushing elements 1750 to dispense one or more flushing agents to prepare the body to receive the tissue, grafts, or cells. In an embodiment, the printing system 1700 can only be configured to be used during or after the laparoscopic surgery.

In an embodiment, the printing system 1700 can be configured to be substantially inserted into the subject. For example, the printing system 1700 can include a body-insertable device 1776 that can be configured to at least partially house the printing head 1708 along with the one or more elongated members 1742, the one or more flushing elements 1750, or the one or more dispense elements 1744. As such, the printing head 1708 can be inserted into the subject along with the one or more elongated members 1742, the one or more flushing elements 1750, or the one or more dispense elements 1744. However, the printing system 1700 can be configured to be inserted into the subject without the use of the body-insertable device 1776.

In the illustrated embodiment, the controller 1712 is illustrated to be remote from the printing head 1708 and configured to not be inserted into the subject. However, in other embodiments, the controller 1712 can be configured to be inserted subcutaneously. For example, at least a portion of the controller 1712 can be positioned within the printing head 1708.

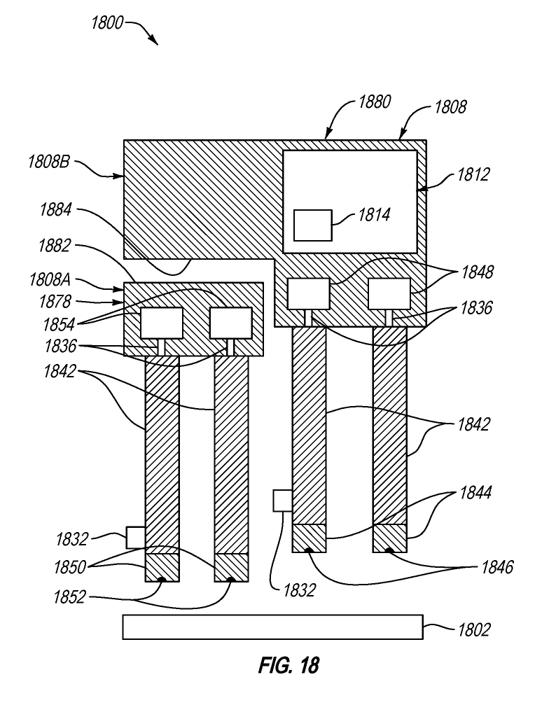

FIG. 18 is schematic cross-sectional view of a printing system 1800 that includes at least one reversibly attachable cartridge 1878, according to an embodiment. Except as otherwise disclosed herein, the printing system 1800 can be the same as or substantially similar to any of the printing systems disclosed herein except that the printing system 1800 includes a reversibly attachable cartridge 1878. It should be noted that the reversibly attachable cartridge 1878 can be used in any of the printing systems disclosed herein.

The printing system 1800 can include one or more flushing elements 1850 that dispense one or more flushing agents towards a region of interest 1802. The one or more flushing elements 1850 can be coupled to one or more elongated members 1842 and include at least one flushing aperture 1852. The one or more flushing elements 1850 can be coupled to at least one flushing agent reservoir 1854 via one or more conduits 1836. The printing system 1800 can further include a printing device that includes one or more dispense elements 1844 configured to dispense one or more materials onto the region of interest 1802. For example, the one or more dispense elements 1844 can be coupled to one or more elongated members 1842 and include at least one dispense aperture 1846. The one or more dispense elements 1844 can be coupled to at least one material reservoir 1848 using one or more conduits 1836. The one or more elongated members 1842 can controllably steer the one or more flushing elements 1850 or the one or more dispense elements 1844. The one or more elongated members 1842 can be coupled to and extend from a printing head 1808. The printing system 1800 can further include one or more sensors 1832 configured to sense one or more characteristics of the region of interest 1802. The printing system 1800 also includes a controller 1812 at least partially enclosed in or incorporated into the printing head 1808. The controller 1812 can include control electrical circuitry 1814.

The printing system 1800 further includes a reversibly attachable cartridge 1878. The reversibly attachable cartridge 1878 is a portion of the printing system 1800 that is configured to be reversibly attached to another portion 1880 of the printing system 1800. In an embodiment, the reversibly attachable cartridge 1878 can include at least one component of the printing system 1800. For example, the reversibly attachable cartridge 1878 can include at least one of the one or more flushing elements 1850, the one or more dispense elements 1844, the one or more elongated members 1842, the at least one flushing agent reservoir 1854, the at least one material reservoir 1848, the one or more sensors 1832, the printing head 1808, the controller 1812, or other components of the printing system 1800. In an embodiment, the reversibly attachable cartridge 1878 can include just a single flushing element 1850. In an embodiment, the reversibly attachable cartridge 1878 can include the printing head 1808 and every component coupled thereto (e.g., the another portion 1880 of the printing system 1800 includes the support structure, not shown). In an embodiment, the reversibly attachable cartridge 1878 can include the printing device. In such an embodiment, the reversibly attachable cartridge 1878 enables the another portion 1880 to be used with any known printing device. In an embodiment, the reversibly attachable cartridge 1878 can include just a portion of a single component of the printing system 1800. For example, the cartridge can include a disk including a hole therein configured to be reversibly attached to the rest of a flushing element 1850. In an embodiment, the printing system 1800 can include a plurality of reversibly attachable cartridges 1878. The plurality of reversibly attachable cartridges 1878 can be reversibly attached to each other. For example, the printing system 1800 can be completely formed of a plurality of reversibly attachable cartridges 1878.

The reversibly attachable cartridge 1878, the another portion 1880 of the printing system 1800, or both can include means to reversibly attach the reversibly attachable cartridge 1878. Means to reversibly attach include any method of attachment that enables the reversibly attachable cartridge 1878 to attach to and to be detached from the another portion 1880 of the printing system 1800 without substantially damaging either the reversibly attachable cartridge 1878 or the another portion 1880 of the printing system 1800. The means to reversibly attach the reversibly attachable cartridge 1878 to the another portion 1880 can include an adhesive, one or more threaded fasteners (e.g., one or more screws), a threaded connection, an adapter, a barbed connection, a luer lock, one or more magnets, a clamp, a snap fit, or a pin.

The reversibly attachable cartridge 1878, the another portion 1880 of the printing system 1800, or both can also include one or more features configured to position or support the reversibly attachable cartridge 1878 against the another portion 1880 of the printing system 1800. For example, at least one of the reversibly attachable cartridge 1878 or the another portion 1880 of the printing system 1800 can include a recess, ridge, groove, raised feature, surface shape, surface topography, or other feature that positions or supports the reversibly attachable cartridge 1878 against the another portion 1880 of the printing system 1800.

The reversibly attachable cartridge 1878 can include housing configured to support the one or more components of the reversibly attachable cartridge 1878. For example, the housing can include a portion of the printing head 1808. In another example, the housing can include a rigid or semi-rigid material between one or more components of the reversibly attachable cartridge 1878. The rigid or semi-rigid material may be broken after the reversibly attachable cartridge 1878 is attached to the another portion 1880 of the printing system 1800 and before the printing system 1800 is used.

Referring to FIG. 18, the reversibly attachable cartridge 1878 can include one or more flushing elements 1850 coupled to one or more elongated members 1842. The one or more flushing elements 1850 can also be coupled to at least one flushing agent reservoir 1854 via one or more conduits 1836. The reversibly attachable cartridge 1878 can also include a housing configured to support the one or more components of the reversibly attachable cartridge 1878. In an embodiment, the printing system 1800 may include a printing head 1808 having a first portion of the printing head 1808A and a second portion of the printing head 1808B. The housing may include the first portion of the printing head 1808A. The first portion of the printing head 1808A can include the one or more elongated members 1842 coupled thereto and extending therefrom. Also, the first portion of the printing head 1808A can include the at least one flushing agent reservoir 1854 and one or more conduits 1836 therein. The reversibly attachable cartridge 1878 can further include one or more sensors 1832 configured as any of the sensors disclosed herein.

The another portion 1880 of the printing system 1800 can receive the reversibly attachable cartridge 1878. In an embodiment, the another portion 1880 of the printing system 1800 includes a second portion of the printing head 1808B. The second portion of the printing head 1808B can support the components of the another portion 1880 of the printing system 1800. The second portion of the printing head 1808B can be configured to receive the first portion of the printing head 1808A. For example, in the illustrated embodiment, the second portion of the printing head 1808B includes a generally rectangular cutout configured to receive the first portion of the printing head 1808A.

The first portion of the printing head 1808A and the second portion of the printing head 1808B can include can include a first surface 1882 and second surface 1884, respectively. In an embodiment, at least one of the first surface 1882 or the second surface 1884 can include means to reversibly attach the reversibly attachable cartridge 1878 to the another portion of the printing system 1800. For example, at least one of the first surface 1882 or the second surface 1884 can include an adhesive thereon. In an embodiment, the first surface 1882 can include one or more recesses configured to mate with one or more raised features on the second surface 1884. The one or more recesses and the one or more raised features can be used to position, support, or attach the reversibly attachable cartridge 1878 to the another portion 1880 of the printing system 1800. In an embodiment, the first portion of the printing head 1808A or the second portion of the printing head 1808B can include an attachment means therein. For example, the first portion of the printing head 1808B can include a magnet therein. The another portion 1880 of the printing system 1800 can include a ferromagnetic material (e.g., the second surface 1884) or a magnet therein oriented to attach first portion of the printing head 1808A to the second portion of the printing head 1808B.

The reversibly attachable cartridge 1878 can enable the printing system 1800 to be modified to perform different printing operations. In an embodiment, the printing system 1800 can be initially configured to print in a biological environment. However, the printing system 1800 can be modified to operate in an oxidizing environment. For example, components of the printing system 1800 formed of a biocompatible materials can be replaced with components formed of oxidation resistant materials, if necessary. Also, the at least one flushing agent reservoir 1854 or the at least one material reservoir 1848 can be replaced with different flushing agents or materials, if needed. In an embodiment, the reversibly attachable cartridge 1878 can include different types of printing devices. Switching between the different types of printing devices enables the printing system 1800 to a printing device that is best suited for the printing operation. As such, multiple printing operations can be performed by a single printing system 1800.

Similarly, the reversibly attachable cartridge 1878 can enable the printing system 1800 to replace spent or damaged components. In an embodiment, the reversibly attachable cartridge 1878 can enable a flushing agent reservoir 1854 to be replaced when the flushing agent reservoir 1854 is spent. In an embodiment, the one or more elongated members 1842 can include a shape memory material actuator. After a plurality of actuations, the shape memory material actuator can experience “amnesia,” that is, deform differently (e.g., less) than the original shape memory material actuator when exposed to a temperature. As such, the reversibly attachable cartridge 1878 can enable the replacement of the shape memory material actuator.

In an embodiment, the reversibly attachable cartridge 1878 can even be adapted for use with a printing system that the reversibly attachable cartridge 1878 was not specifically configured to be used with. For example, the reversibly attachable cartridge 1878 can be modified to be operably coupled to a controller of an existing printing system when the reversibly attachable cartridge 1878 is computer controlled so that the reversibly attachable cartridge 1878 is controlled by such a controller. In other embodiments, the reversibly attachable cartridge 1878 can be manually operated in conjunction with an existing printing system that it was not specifically configured to be used with in order to prepare a region of interest for printing.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; alternatively, if flexibility is paramount, the implementer can opt for a mainly software implementation; or, yet again alternatively, the implementer can opt for some combination of hardware, software, and/or firmware. Hence, there are several possible vehicles by which the processes and/or devices and/or other technologies described herein can be effected, none of which is inherently superior to the other in that any vehicle to be utilized is a choice dependent upon the context in which the vehicle will be deployed and the specific concerns (e.g., speed, flexibility, or predictability) of the implementer, any of which can vary. The reader will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In an embodiment, several portions of the subject matter described herein can be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, the various embodiments described herein can be implemented, individually and/or collectively, by various types of electro-mechanical systems having a wide range of electrical components such as hardware, software, firmware, or virtually any combination thereof; and a wide range of components that can impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electrical systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context can dictate otherwise.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein can be implemented in an analog or digital fashion or some combination thereof.

This disclosure has been made with reference to various example embodiments. However, those skilled in the art will recognize that changes and modifications can be made to the embodiments without departing from the scope of the present disclosure. For example, various operational steps, as well as components for carrying out operational steps, can be implemented in alternate ways depending upon the particular application or in consideration of any number of cost functions associated with the operation of the system; e.g., one or more of the steps can be deleted, modified, or combined with other steps.

Additionally, as will be appreciated by one of ordinary skill in the art, principles of the present disclosure, including components, can be reflected in a computer program product on a computer-readable storage medium having computer-readable program code means embodied in the storage medium. Any tangible, non-transitory computer-readable storage medium can be utilized, including magnetic storage devices (hard disks, floppy disks, and the like), optical storage devices (CD-ROMs, DVDs, Blu-ray discs, and the like), flash memory, and/or the like. These computer program instructions can be loaded onto a general purpose computer, special purpose computer, or other programmable data processing apparatus to produce a machine, such that the instructions that execute on the computer or other programmable data processing apparatus create a means for implementing the functions specified. These computer program instructions can also be stored in a computer-readable memory that can direct a computer or other programmable data processing apparatus to function in a particular manner, such that the instructions stored in the computer-readable memory produce an article of manufacture, including implementing means that implement the function specified. The computer program instructions can also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

In an embodiment, the printing systems disclosed herein can be integrated in such a manner that the printing systems operate as a unique system configured specifically for function of printing (e.g., three-dimensional printing), and any associated computing devices of the printing systems operate as specific use computers for purposes of the claimed system, and not general use computers. In an embodiment, at least one associated computing device of the printing systems operate as specific use computers for purposes of the claimed system, and not general use computers. In an embodiment, at least one of the associated computing devices of the printing systems are hardwired with a specific ROM to instruct the at least one computing device. In an embodiment, one of skill in the art recognizes that the printing devices and printing systems effects an improvement at least in the technological field of three-dimensional printing.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components can be referred to herein as “configured to.” The reader will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications can be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, the recited operations therein can generally be performed in any order. Examples of such alternate orderings can include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

What is claimed is:

1. A printing system, comprising:
a printing head;
one or more dispense elements each of which includes at least one dispense aperture;
one or more first elongated members extending from the printing head, wherein the one or more dispense elements are coupled to the one or more first elongated members;
at least one material reservoir that is fluidly coupled to the one or more dispense elements, the at least one material reservoir including one or more materials disposed therein;
a barrier including an inner wall at least partially defining an internal region, an outer wall at least partially defining an external region, and a base contact surface extending between the inner wall and the outer wall, the barrier positioned or positionable so that the one or more dispense elements are positioned in or adjacent to the internal region of the barrier, wherein the base contact surface defines an opening;
wherein the one or more dispense elements are positioned and configured to controllably dispense at least the one or more at materials through the at least one dispense aperture and toward the opening defined by the base contact surface to form a three-dimensional structure on a region of interest; and
a controller including control electrical circuitry that is operably coupled to the one or more dispense elements, the control electrical circuitry configured to direct dispensing of at least the one or more at least partially solid materials from the one or more dispense elements.

2. The printing system of claim 1, wherein the barrier completely laterally encloses a lateral periphery of the internal region.

3. The printing system of claim 1, wherein the barrier only partially laterally encloses a lateral periphery of the internal region.

4. The printing system of claim 1, wherein the base contact surface extends past the at least one dispense aperture of the one or more dispense elements.

5. The printing system of claim 1, wherein the barrier is a cofferdam that at least partially laterally encloses the internal region.

6. The printing system of claim 1, wherein the barrier is formed from a plurality of pieces, the plurality of pieces including:
at least one first piece spaced from the base contact surface and extending between a portion of the inner wall and the outer wall; and
a seal that is coupled to the at least one first piece, the seal defining the base contact surface, the seal configured to contact a surface including at least one of:
a portion of the region of interest;
a region proximate to the region of interest; or
a region that at least partially encloses the region of interest.

7. The printing system of claim 1, further including a vacuum device at least partially disposed in the barrier, the vacuum device configured to vacuum seal the base contact surface against a surface, the surface including at least one of:
a portion of the region of interest;
a region proximate to the region of interest; or
a region that at least partially encloses the region of interest; and
wherein the barrier is distinct from and spaced from the one or more dispense elements.

8. The printing system of claim 1, further including one or more flushing elements each of which includes at least one flushing aperture, the one or more flushing elements configured to controllably dispense one or more flushing agents towards the region of interest, at least one of the one or more flushing elements positioned in or near the internal region.

9. The printing system of claim 8, wherein the one or more flushing elements are directly attached to, incorporated into, or at least partially housed in the barrier, wherein the barrier is distinct from and spaced from the one or more dispense elements.

10. The printing system of claim 1, further including one or more removal devices positioned and configured to remove at least one contaminant or substance from within or near the internal region.

11. The printing system of claim 10, wherein the one or more removal devices are directly attached to, at least partially housed in, or integral with the barrier, wherein the barrier is distinct from and spaced from the one or more dispense elements.

12. The printing system claim 10, further including one or more second elongated members that are distinct from the one or more first elongated members, the one or more removal devices are coupled to or integrally formed with the one or more second elongated members.

13. The printing system of claim 1, wherein the one or more first elongated members are configured to controllably steer the one or more dispense elements responsive to direction from the controller.

14. The printing system of claim 1, wherein the barrier is coupled to and extends from the printing head.

15. The printing system of claim 1, further comprising a body-insertable device configured to be inserted into a subject.

16. The printing system of claim 15, wherein the body-insertable device houses the one or more dispense elements.

17. The printing system of claim 15, wherein the body-insertable device houses the barrier.

18. The printing system of claim 1, wherein the one or more materials includes one or more at least partially solid materials.

19. A method of three-dimensional printing, the method comprising:
positioning one or more dispense elements at least proximate to a region of interest, the one or more dispense elements coupled to one or more elongated members;
at least partially laterally surrounding an internal region with a barrier, the internal region including at least a portion of the region of interest therein, the barrier including an inner wall at least partially defining the internal region, an outer wall at least partially defining an external region, and a base contact surface extending between the inner wall and the outer wall, wherein the base contact surface defines an opening;
with the barrier positioned to at least partially laterally surround the internal region, responsive to direction from control electrical circuitry, controllably dispensing at least one or more materials from the one or more dispense elements toward the opening defined by the base contact surface onto the region of interest to form a biocompatible three-dimensional structure.

20. The method of claim 19, further including at least partially contacting a seal of the barrier against a surface, the surface including at least one of:
a portion of the region of interest;
a region proximate to the region of interest; or
a region that at least partially encloses the region of interest.

21. The method of claim 20, wherein at least partially contacting the seal of the barrier against a surface includes vacuum sealing the barrier against the surface.

22. The method of claim 20, wherein at least partially contacting the seal of the barrier against a surface includes pressure sealing the barrier against the surface.

23. The method of claim 19, further including controllably dispensing one or more flushing agents from one or more flushing elements toward the region of interest, at least one of the one or more flushing elements at least partially positioned in the internal region.

24. The method of claim 19, further including removing at least one substance from the internal region at least partially defined by the barrier using the one or more removal devices.

25. The method of claim 19, wherein dispensing at least the one or more materials from the one or more dispense elements onto the region of interest includes dispensing at least the one or more materials from the one or more dispense elements onto an internal anatomical site of a living subject.

26. The method of claim 19, further comprising controllably and selectively steering the one or more elongated members.

27. The method of claim 19, wherein dispensing at least the one or more materials from the one or more dispense elements onto the region of interest includes printing a three-dimensional object on the region of interest; and
further comprising controllably moving the one or more dispense elements without contacting the dispense elements with the three-dimensional object.

28. A printing system, comprising:
one or more dispense elements each of which includes at least one dispense aperture;
one or more elongated members extending into an internal region, the one or more dispense elements are coupled to the one or more first elongated members;
at least one material reservoir that is fluidly coupled to the one or more dispense elements, the at least one material reservoir including one or more biological materials disposed therein;
a barrier including an inner wall at least partially defining the internal region, an outer wall at least partially defining an external region, and a base contact surface extending between the inner wall and the outer wall, the barrier positioned or positionable so that the one or more dispense elements are positioned in or adjacent to the internal region of the barrier, wherein the base contact surface defines an opening;
wherein the one or more dispense elements are positioned and configured to controllably dispense at least the one or more biological materials through the at least one dispense aperture and toward the opening defined by the base contact surface to form at least one biological three-dimensional structure on a region of interest, the at least one biological three-dimensional structuring including at least one of an implant, a graft, or tissue; and
a controller including control electrical circuitry that is operably coupled to the one or more dispense elements, the control electrical circuitry configured to direct dispensing of at least the one or more biological materials from the one or more dispense elements.

29. The printing system of claim 28, further including one or more flushing elements each of which includes at least one flushing aperture.

30. The printing system of claim 28, further including one or more removal devices configured to remove at least one contaminant from the internal region at least partially defined by the barrier.
